(19) United States
(12) Patent Application Publication
(10) Pub. No.: US 2024/0430052 A1
(43) Pub. Date: Dec. 26, 2024

(54) TECHNIQUES FOR 480 AND 640 MEGAHERTZ (MHZ) TRANSMISSION IN WI-FI

(71) Applicant: QUALCOMM Incorporated, San Diego, CA (US)

(72) Inventors: Jialing Li CHEN, San Diego, CA (US); Lin YANG, San Diego, CA (US); Bin TIAN, San Diego, CA (US)

(21) Appl. No.: 18/740,815

(22) Filed: Jun. 12, 2024

Related U.S. Application Data
(60) Provisional application No. 63/510,275, filed on Jun. 26, 2023.
(60) Provisional application No. 63/514,256, filed on Jul. 18, 2023.

(51) Int. Cl. H04L 5/00; H04L 1/00; H04W 74/0816

(52) U.S. Cl. CPC H04L 5/0039; H04L 1/0069; H04L 5/0092; H04L 5/0094; H04W 74/0816

(57) ABSTRACT

This disclosure provides methods, components, devices and systems for 480 and 640 megahertz (MHz) transmission in Wi-Fi. Some aspects more specifically relate to inclusion of a bandwidth field and a bandwidth extension field in a preamble of a physical layer protocol data unit (PPDU) that jointly indicate that the channel bandwidth of the PPDU is a contiguous 480 MHz channel bandwidth or a 640 MHz channel bandwidth. In some aspects, parameters of the PPDU may be defined based on the PPDU occupying a 480 MHz or 640 MHz bandwidth. For example, the parameters may include tone plans, allowed puncturing patterns, signaling of the puncturing plans, signaling of the resource unit allocation, a short training field, a long training field, pilot signal sequences, phase shifts, a segment parser, and/or a spectral mask.

### CROSS REFERENCE

The present application for patent claims the benefit of U.S. Provisional Patent Application No. 63/514,256 by CHEN et al., entitled “TECHNIQUES FOR 480 AND 640 MEGAHERTZ (MHz) TRANSMISSION IN WI-FI,” filed Jul. 18, 2023, and the benefit of U.S. Provisional Patent Application No. 63/510,275 by CHEN et al., entitled “TECHNIQUES FOR 480 AND 640 MEGAHERTZ (MHz) TRANSMISSION IN WI-FI,” filed Jun. 26, 2023, each of which is assigned to the assignee hereof, and each of which is expressly incorporated by reference herein.

### TECHNICAL FIELD

This disclosure relates to wireless communication and, more specifically, to techniques for 480 and 640 megahertz (MHz) transmission in Wi-Fi.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, wireless communications devices such as STAs and APs transmit and receive wireless communications to and from one another in the form of physical layer (PHY) protocol data units (PPDUs). PPDUs conforming to the IEEE 802.11n, 802.11ac, 802.11ax and 802.11be standard amendments may be transmitted over the 2.4 gigahertz (GHz), 5 GHz, or 6 GHz bands. Each band may include multiple channels. 20 megahertz (MHz), 40 MHz, 80 MHz, 160 MHz, or 320 MHz channels may be used, and a channel may be defined by a center frequency index and an operating bandwidth (for example, 20 MHz, 40 MHz, 80 MHz, 160 MHz, and 320 MHz). PPDUs may include a preamble that provides control information for the PPDU and a payload that carries data. A bandwidth field in the universal signal field (U-SIG) in the preamble may indicate whether the operating bandwidth is 20 MHz, 40 MHz, 80 MHz, 160 MHz, or 320 MHz.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a wireless communications device. The wireless communications device may include one or more memories storing processor-executable code; and one or more processors coupled with the one or more memories and individually or collectively configured to, in association with executing the code, cause the wireless communications device to: transmit a preamble of a PPDU, where the preamble includes a U-SIG field, where the U-SIG field includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth and transmit a payload of the PPDU using the indicated channel bandwidth.

Another innovative aspect of the subject matter described in this disclosure can be implemented in a method for wireless communications by a wireless communications device. The method may include transmitting a preamble of a physical layer protocol data unit (PPDU), where the preamble includes a universal signal (U-SIG) field, where the U-SIG field includes a bandwidth field and a bandwidth extension field that jointly indicate a channel bandwidth for the PPDU, the indicated channel bandwidth being one of a 480 megahertz (MHz) contiguous channel bandwidth or a 640 MHz contiguous channel bandwidth and transmitting a payload of the PPDU using the indicated channel bandwidth.

Another innovative aspect of the subject matter described in this disclosure can be implemented in a wireless communications device. The wireless communications device may include means for transmitting a preamble of a PPDU, where the preamble includes a U-SIG field, where the U-SIG field includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth and means for transmitting a payload of the PPDU using the indicated channel bandwidth.

Another innovative aspect of the subject matter described in this disclosure can be implemented in a non-transitory computer-readable medium storing code for wireless communications. The code may include instructions executable by a processor to transmit a preamble of a PPDU, where the preamble includes a U-SIG field, where the U-SIG field includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth and transmit a payload of the PPDU using the indicated channel bandwidth.

In some examples of the method, wireless communications devices, and non-transitory computer-readable medium described herein, a first set of values of the bandwidth field indicate a corresponding set of channel bandwidths other than 480 MHz or 640 MHz, a second set of values of the bandwidth field indicates 480 MHz bandwidth operation or 640 MHz bandwidth operation, and the second set of values in combination with the bandwidth extension field indicates the 480 MHz contiguous channel bandwidth or the 640 MHz contiguous channel bandwidth.

In some examples of the method, wireless communications devices, and non-transitory computer-readable medium described herein, the corresponding set of channel bandwidths include a 160 MHz bandwidth extending to 7225 MHz, a 320 MHz bandwidth extending to 7225 MHz, a 480 MHz bandwidth extending to 7225 MHz, and a 640 MHz bandwidth extending to 7225 MHz.

In some examples of the method, wireless communications devices, and non-transitory computer-readable medium described herein, within a first subband of the 480 MHz contiguous channel bandwidth or the 640 MHz contiguous channel bandwidth, the bandwidth field indicates a first value and the bandwidth extension field indicates a second value, within a second subband of the 480 MHz contiguous channel bandwidth or the 640 MHz contiguous channel bandwidth, the bandwidth field indicates a third value and the bandwidth extension field indicates a fourth value, and the first value may be different from the third value and the second value may be different from the fourth value.

In some examples of the method, wireless communications devices, and non-transitory computer-readable medium described herein, transmitting the preamble and the payload may include operations, features, means, or instructions for transmitting the preamble and the payload according to a tone plan, the tone plan including one or more of: a set of multiple Extremely High Throughput (EHT) 80 MHz tone plans across the 480 MHz contiguous channel bandwidth or the 640 MHz contiguous channel bandwidth; a 6×996 tone resource unit (RU) for the 480 MHz contiguous channel bandwidth; 4×996 tone multiple RUs (MRUs) for the 480 MHz contiguous channel bandwidth; 4×996+484 tone MRUs for the 480 MHz contiguous channel bandwidth; 4×996+484+242 tone MRUs for the 480 MHz contiguous channel bandwidth; 5×996 tone MRUs for the 480 MHz contiguous channel bandwidth; 5×996+484 tone MRUs for the 480 MHz contiguous channel bandwidth; 5×996+484+242 tone MRUs for the 480 MHz contiguous channel bandwidth; a 8×996 tone RU for the 640 MHz contiguous channel bandwidth; 4×996 tone RUs for the 640 MHz contiguous channel bandwidth; 4×996+484 tone MRUs for the 640 MHz contiguous channel bandwidth; 5×996 tone MRUs for the 640 MHz contiguous channel bandwidth; 5×996+484 tone MRUs for the 640 MHz contiguous channel bandwidth; 6×996 tone MRUs for the 640 MHz contiguous channel bandwidth; a6×996+484 tone MRUs for the 640 MHz contiguous channel bandwidth; 7×996 tone MRUs for the 640 MHz contiguous channel bandwidth; or 7×996+484 tone MRUs for the 640 MHz contiguous channel bandwidth.

Some examples of the method, wireless communications devices, and non-transitory computer-readable medium described herein may further include operations, features, means, or instructions for transmitting a set of multiple pilot signals, where resources used to transmit the set of multiple pilot signals may be based on the tone plan.

Some examples of the method, wireless communications devices, and non-transitory computer-readable medium described herein may further include operations, features, means, or instructions for generating the PPDU in accordance with a segment parser, where the segment parser may be based on the tone plan.

Some examples of the method, wireless communications devices, and non-transitory computer-readable medium described herein may further include operations, features, means, or instructions for transmitting, in the preamble, an indication of a puncturing pattern for the PPDU.

In some examples of the method, wireless communications devices, and non-transitory computer-readable medium described herein, the PPDU includes a non-orthogonal frequency-division multiple access PPDU and the indication of the puncturing pattern indicates one or more of no puncturing, a punctured 40 MHz bandwidth within the 480 MHz contiguous channel bandwidth or the 640 MHz contiguous channel bandwidth, a punctured 80 MHz bandwidth within the 480 MHz contiguous channel bandwidth or the 640 MHz contiguous channel bandwidth, two concurrent punctured 80 MHz bandwidths within the 480 MHz contiguous channel bandwidth or the 640 MHz contiguous channel bandwidth, or a concurrent 40 MHz bandwidth and 80 MHz bandwidth within the 480 MHz contiguous channel bandwidth or the 640 MHz contiguous channel bandwidth.

In some examples of the method, wireless communications devices, and non-transitory computer-readable medium described herein, the PPDU includes an orthogonal frequency-division multiple access PPDU and the indication of the puncturing pattern indicates zero or one or two punctured 20 MHz bandwidths for each 80 MHz bandwidth within the 480 MHz contiguous channel bandwidth or the 640 MHz contiguous channel bandwidth.

In some examples of the method, wireless communications devices, and non-transitory computer-readable medium described herein, the U-SIG field of a trigger based PPDU includes a set of multiple spatial reuse fields indicating spatial reuse information for each of a set of multiple 20 MHz portions of the 480 MHz contiguous channel bandwidth or the 640 MHz contiguous channel bandwidth.

In some examples of the method, wireless communications devices, and non-transitory computer-readable medium described herein, the preamble includes an EHT signal field including a RU allocation subfield and a quantity of entries in the RU allocation subfield may be based on the indicated channel bandwidth being one of the 480 MHz contiguous channel bandwidth or the 640 MHz contiguous channel bandwidth.

In some examples of the method, wireless communications devices, and non-transitory computer-readable medium described herein, the preamble includes an UHR short training field (STF), the UHR STF includes a set of multiple sequences within 80 MHz segments or 160 MHz segments of the 480 MHz contiguous channel bandwidth or the 640 MHz contiguous channel bandwidth, and each of the set of multiple sequences may be multiplied by a different coefficient.

In some examples of the method, wireless communications devices, and non-transitory computer-readable medium described herein, the preamble includes an UHR long training field (LTF), the UHR LTF includes a set of multiple sequences within 80 MHz segments of the 480 MHz contiguous channel bandwidth or the 640 MHz contiguous channel bandwidth, each sequence of the set of multiple sequences includes multiple parts, and each part of the multiple parts may be multiplied by a different coefficient.

In some examples of the method, wireless communications devices, and non-transitory computer-readable medium described herein, transmitting a legacy portion of the preamble may include operations, features, means, or instructions for applying a phase rotation pattern on a 80 MHz subblock basis within the 480 MHz contiguous channel bandwidth or the 640 MHz contiguous channel bandwidth.

Some examples of the method, wireless communications devices, and non-transitory computer-readable medium described herein may further include operations, features, means, or instructions for generating the PPDU via encoding a lower frequency tone 3×996 RU of the 480 MHz contiguous channel bandwidth or 4×996 RU of the 640 MHz contiguous channel bandwidth using binary phase shift keying dual subcarrier modulation, duplicating the lower frequency tone 3×996 RU of the 480 MHz contiguous channel bandwidth or 4×996 RU of the 640 MHz contiguous channel bandwidth onto a higher frequency tone 3×996 RU of the 480 MHz contiguous channel bandwidth or 4×996 RU of the 640 MHz contiguous channel bandwidth, and applying a phase shift to the higher frequency tone 3×966 RU of the 480 MHz contiguous channel bandwidth or 4×996 RU of the 640 MHz contiguous channel bandwidth.

In some examples of the method, wireless communications devices, and non-transitory computer-readable medium described herein, transmitting the preamble and the payload may include operations, features, means, or instructions for applying a spectral mask to transmission of the preamble and the payload, where the spectral mask may have one of: a 0 dBr bandwidth of 479 MHz, −20 dBr at 240.5 MHz frequency offset, −28 dBr at 480 MHz frequency offset, and −40 dBr at 720 MHz frequency offset for a 480 MHz PPDU, where the spectral mask for frequency offsets in between 239.5 MHz and 240.5 MHz, 240.5 MHz and 480 MHz, and 480 MHz and 720 MHz may be linearly interpolated in decibels domain from requirements for 239.5 MHz, 240.5 MHz, 480 MHz, and 720 MHz frequency offsets; a 0 dBr bandwidth of 478 MHz, −20 dBr at 241 MHz frequency offset, −28 dBr at 480 MHz frequency offset, and −40 dBr at 720 MHz frequency offset for a 480 MHz non-high throughput duplicate PPDU, where the spectral mask for frequency offsets in between 239 MHz and 241 MHz, 241 MHz and 480 MHz, and 480 MHz and 720 MHz may be linearly interpolated in decibels domain from requirements for 239 MHz, 241 MHz, 480 MHz, and 720 MHz frequency offsets; a 0 dBr bandwidth of 639 MHz, −20 dBr at 320.5 MHz frequency offset, −28 dBr at 640 MHz frequency offset, and −40 dBr at 960 MHz frequency offset for a 640 MHz PPDU, where the spectral mask for frequency offsets in between 319.5 MHz and 320.5 MHz, 320.5 MHz and 640 MHz, and 640 MHz and 760 MHz may be linearly interpolated in decibels domain from the requirements for 319.5 MHz, 320.5 MHz, 640 MHz, and 960 MHz frequency offsets; a 0 dBr bandwidth of 638 MHz, −20 dBr at 320 MHz frequency offset, −28 dBr at 640 MHz frequency offset, and −40 dBr at 960 MHz frequency offset for a 640 MHz non-high throughput duplicate PPDU, where the spectral mask for frequency offsets in between 319 MHz and 320 MHz, 320 MHz and 640 MHz, and 640 MHz and 760 MHz may be linearly interpolated in decibels domain from the requirements for 319 MHz, 320 MHz, 640 MHz, and 960 MHz frequency offsets, and where a transmit spectrum may not exceed a maximum of the spectral mask and −39 dBm/MHz at any frequency offset.

In some examples of the method, wireless communications devices, and non-transitory computer-readable medium described herein, the indicated channel bandwidth is the 480 MHz contiguous channel bandwidth; within a lowest 160 MHz subband of the 480 MHz contiguous channel bandwidth the bandwidth field indicates a first 320 MHz channelization and the bandwidth extension field indicates an additional upper 160 MHz subband; within a middle 160 MHz subband of the 480 MHz contiguous channel bandwidth the bandwidth field indicates one of the first 320 MHz channelization and the additional upper 160 MHz subband or a second 320 MHz channelization and an additional lower 160 MHz subband; and within a highest 160 MHz subband of the 480 MHz contiguous channel bandwidth the bandwidth field indicates the second 320 MHz channelization and the bandwidth extension field indicates the additional lower 160 MHz subband.

In some examples of the method, wireless communications devices, and non-transitory computer-readable medium described herein, within the lowest 160 MHz subband, a first spatial reuse field of the universal signal field is associated with the lowest 160 MHz subband, a second spatial reuse field of the universal signal field is associated with the middle 160 MHz subband, and a third spatial reuse field is associated with the additional upper 160 MHz subband; and within the highest 160 MHz subband, the first spatial reuse field is associated with the middle 160 MHz subband, the second spatial reuse field is associated with the highest 160 MHz subband, and the third spatial reuse field is associated with the lowest 160 MHz subband.

In some examples of the method, wireless communications devices, and non-transitory computer-readable medium described herein, the indicated channel bandwidth is the 480 MHz contiguous channel bandwidth; within a first 160 MHz subband of the 480 MHz contiguous channel bandwidth the bandwidth field indicates a first 160 MHz channelization and the bandwidth extension field indicates the first 160 MHz subband is a lowest 160 MHz subband of the 480 MHz contiguous channel bandwidth; within a second 160 MHz subband of the 480 MHz contiguous channel bandwidth the bandwidth field indicates a second 160 MHz channelization and the bandwidth extension field indicates the second 160 MHz subband is a middle 160 MHz subband of the 480 MHz contiguous channel bandwidth; and within a third 160 MHz subband of the 480 MHz contiguous channel bandwidth the bandwidth field indicates a third 160 MHz channelization and the bandwidth extension field indicates the third 160 MHz subband is a highest 160 MHz subband of the 480 MHz contiguous channel bandwidth.

In some examples of the method, wireless communications devices, and non-transitory computer-readable medium described herein, within the first 160 MHz subband, a first spatial reuse field of the universal signal field is associated with a lowest 80 MHz of the first 160 MHz subband, a second spatial reuse field of the universal signal field is associated with a highest 80 MHz of the first 160 MHz subband, a third spatial reuse field of the universal signal field is associated with the second 160 MHz subband, and a fourth spatial reuse field of the universal signal field is associated with the third 160 MHz subband; within the second 160 MHz subband, the first spatial reuse field is associated with a lowest 80 MHz of the second 160 MHz subband, the second spatial reuse field is associated with a highest 80 MHz of the second 160 MHz subband, the third spatial reuse field is associated with the first 160 MHz subband, and the fourth spatial reuse field is associated with the third 160 MHz subband; and within the third 160 MHz subband, the first spatial reuse field is associated with a lowest 80 MHz of the third 160 MHz subband, the second spatial reuse field is associated with a highest 80 MHz of the third 160 MHz subband, the third spatial reuse field is associated with the first 160 MHz subband, and the fourth spatial reuse field is associated with the second 160 MHz subband.

In some examples of the method, wireless communications devices, and non-transitory computer-readable medium described herein, the indicated channel bandwidth is the 480 MHz contiguous channel bandwidth; the 480 MHz contiguous channel bandwidth includes a 160 MHz primary channel portion and a remaining 320 MHz portion; and the preamble includes an ultra high reliability signal field including a RU allocation subfield, where the RU allocation subfield includes a respective 9 bit RU allocation table for each 20 MHz portion of the 160 MHz primary channel portion, and where the RU allocation subfield includes a respective 8 bit RU allocation table for each 80 MHz portion of the remaining 320 MHz portion.

In some examples of the method, wireless communications devices, and non-transitory computer-readable medium described herein, the indicated channel bandwidth is the 480 MHz contiguous channel bandwidth; and the preamble includes an ultra high reliability signal field including a first common field and a first user specific field associated with a 320 MHz subband of the 480 MHz contiguous channel bandwidth and a second common field and a second user specific field associated with a 160 MHz subband of the 480 MHz contiguous channel bandwidth.

In some examples of the method, wireless communications devices, and non-transitory computer-readable medium described herein, the indicated channel bandwidth is the 480 MHz contiguous channel bandwidth, where the 480 MHz contiguous channel bandwidth includes a primary 160 MHz subchannel, a first secondary 160 MHz subchannel, and one of a second secondary 160 MHz subchannel or a tertiary 160 MHz subband.

In some examples of the method, wireless communications devices, and non-transitory computer-readable medium described herein, the primary 160 MHz subchannel includes a middle 160 MHz subchannel of the 480 MHz channel bandwidth, and the method, wireless communications devices, and non-transitory computer-readable medium described herein may further include operations, features, means, or instructions for: communicating with a second wireless communications device via a first 320 MHz subchannel of the 480 MHz channel bandwidth, where the first 320 MHz subchannel includes the primary 160 MHz subchannel and a lower 160 MHz subchannel of the 480 MHz channel bandwidth; and communicating with a third wireless communications device via a second 320 MHz subchannel of the 480 MHz channel bandwidth, where the second 320 MHz subchannel includes the primary 160 MHz subchannel and an upper 160 MHz subchannel of the 480 MHz channel bandwidth, and where the second wireless communications device and the third wireless communications device are 320 MHz limited devices.

In some examples of the method, wireless communications devices, and non-transitory computer-readable medium described herein, the wireless communications device is an AP, and the method, wireless communications devices, and non-transitory computer-readable medium described herein may further include operations, features, means, or instructions for: transmitting an indication of a first 320 MHz operating channel for the second wireless communications device to the second wireless communications device and a second 320 MHz operating channel for the third wireless communications device to the third wireless communications device, where the first 320 MHz operating channel is the first 320 MHz subchannel and the second 320 MHz operating channel is the second 320 MHz subchannel; or receiving an indication of the first 320 MHz operating channel for the second wireless communications device from the second wireless communications device and the second 320 MHz operating channel for the third wireless communications device from the third wireless communications device.

One innovative aspect of the subject matter described in this disclosure can be implemented in a wireless communications device. The wireless communications device may include one or more memories storing processor-executable code; and one or more processors coupled with the one or more memories and individually or collectively configured to, in association with executing the code, cause the wireless communications device to: receive a preamble of a PPDU, where the preamble includes a U-SIG field, where the U-SIG field includes a bandwidth field and a bandwidth extension field that jointly indicate a channel bandwidth for the PPDU, the indicated channel bandwidth being one of a 480 MHz contiguous channel bandwidth, a 640 MHz contiguous channel bandwidth, or a 480 MHz punctured bandwidth within the 640 MHz contiguous channel bandwidth and receive a payload of the PPDU using the indicated channel bandwidth.

Another innovative aspect of the subject matter described in this disclosure can be implemented in a method for wireless communications by a wireless communications device. The method may include receiving a preamble of a PPDU, where the preamble includes a U-SIG field, where the U-SIG field includes a bandwidth field and a bandwidth extension field that jointly indicate a channel bandwidth for the PPDU, the indicated channel bandwidth being one of a 480 MHz contiguous channel bandwidth, a 640 MHz contiguous channel bandwidth, or a 480 MHz punctured bandwidth within the 640 MHz contiguous channel bandwidth and receiving a payload of the PPDU using the indicated channel bandwidth.

Another innovative aspect of the subject matter described in this disclosure can be implemented in a wireless communications device. The wireless communications device may include means for receiving a preamble of a PPDU, where the preamble includes a U-SIG field, where the U-SIG field includes a bandwidth field and a bandwidth extension field that jointly indicate a channel bandwidth for the PPDU, the indicated channel bandwidth being one of a 480 MHz contiguous channel bandwidth, a 640 MHz contiguous channel bandwidth, or a 480 MHz punctured bandwidth within the 640 MHz contiguous channel bandwidth and means for receiving a payload of the PPDU using the indicated channel bandwidth.

Another innovative aspect of the subject matter described in this disclosure can be implemented in a non-transitory computer-readable medium storing code for wireless communications. The code may include instructions executable by a processor to receive a preamble of a PPDU, where the preamble includes a U-SIG field, where the U-SIG field includes a bandwidth field and a bandwidth extension field that jointly indicate a channel bandwidth for the PPDU, the indicated channel bandwidth being one of a 480 MHz contiguous channel bandwidth, a 640 MHz contiguous channel bandwidth, or a 480 MHz punctured bandwidth within the 640 MHz contiguous channel bandwidth and receive a payload of the PPDU using the indicated channel bandwidth.

In some examples of the method, wireless communications devices, and non-transitory computer-readable medium described herein, a first set of values of the bandwidth field indicate a corresponding set of channel bandwidths other than 480 MHz or 640 MHz, a second set of values of the bandwidth field indicates 480 MHz bandwidth operation or 640 MHz bandwidth operation, and the second set of values in combination with the bandwidth extension field indicates the 480 MHz contiguous channel bandwidth or the 640 MHz contiguous channel bandwidth.

In some examples of the method, wireless communications devices, and non-transitory computer-readable medium described herein, the corresponding set of channel bandwidths include a 160 MHz bandwidth extending to 7225 MHz, a 320 MHz bandwidth extending to 7225 MHz, a 480 MHz bandwidth extending to 7225 MHz, and a 640 MHz bandwidth extending to 7225 MHz.

In some examples of the method, wireless communications devices, and non-transitory computer-readable medium described herein, within a first subband of the 480 MHz contiguous channel bandwidth or the 640 MHz contiguous channel bandwidth the bandwidth field indicates a first value and the bandwidth extension field indicates a second value, within a second subband of the 480 MHz contiguous channel bandwidth or the 640 MHz contiguous channel bandwidth the bandwidth field indicates a third value and the bandwidth extension field indicates a fourth value, and the first value may be different from the third value and the second value may be different from the fourth value.

In some examples of the method, wireless communications devices, and non-transitory computer-readable medium described herein, receiving the preamble may include operations, features, means, or instructions for receiving the preamble and the payload according to a tone plan, the tone plan including one or more of: a set of multiple EHT 80 MHz tone plans across the 480 MHz contiguous channel bandwidth or the 640 MHz contiguous channel bandwidth; a 6×996 tone RU for the 480 MHz contiguous channel bandwidth; 4×996 tone MRUs for the 480 MHz contiguous channel bandwidth; 4×996+484 tone MRUs for the 480 MHz contiguous channel bandwidth; 4×996+484+242 tone MRUs for the 480 MHz contiguous channel bandwidth; 5×996 tone MRUs for the 480 MHz contiguous channel bandwidth; 5×996+484 tone MRUs for the 480 MHz contiguous channel bandwidth; 5×996+484+242 tone MRUs for the 480 MHz contiguous channel bandwidth; a 8×996 tone RU for the 640 MHz contiguous channel bandwidth; 4×996 tone RUs for the 640 MHz contiguous channel bandwidth; 4×996+484 tone MRUs for the 640 MHz contiguous channel bandwidth; 5×996 tone MRUs for the 640 MHz contiguous channel bandwidth; 5×996+484 tone MRUs for the 640 MHz contiguous channel bandwidth; 6×996 tone MRUs for the 640 MHz contiguous channel bandwidth; a6×996+484 tone MRUs for the 640 MHz contiguous channel bandwidth; 7×996 tone MRUs for the 640 MHz contiguous channel bandwidth; or 7×996+484 tone MRUs for the 640 MHz contiguous channel bandwidth.

Some examples of the method, wireless communications devices, and non-transitory computer-readable medium described herein may further include operations, features, means, or instructions for receiving a set of multiple pilot signals, where resources used to transmit the set of multiple pilot signals may be based on the tone plan.

Some examples of the method, wireless communications devices, and non-transitory computer-readable medium described herein may further include operations, features, means, or instructions for deparsing the PPDU in accordance with a segment deparser, where the segment deparser may be based on the tone plan.

Some examples of the method, wireless communications devices, and non-transitory computer-readable medium described herein may further include operations, features, means, or instructions for receiving, in the preamble, an indication of a puncturing pattern for the PPDU.

In some examples of the method, wireless communications devices, and non-transitory computer-readable medium described herein, the PPDU includes a non-orthogonal frequency-division multiple access PPDU and the indication of the puncturing pattern indicates one or more of no puncturing, a punctured 40 MHz bandwidth within the 480 MHz contiguous channel bandwidth or the 640 MHz contiguous channel bandwidth, a punctured 80 MHz bandwidth within the 480 MHz contiguous channel bandwidth or the 640 MHz contiguous channel bandwidth, two concurrent punctured 80 MHz bandwidths within the 480 MHz contiguous channel bandwidth or the 640 MHz contiguous channel bandwidth, or a concurrent 40 MHz bandwidth and 80 MHz bandwidth within the 480 MHz contiguous channel bandwidth or the 640 MHz contiguous channel bandwidth.

In some examples of the method, wireless communications devices, and non-transitory computer-readable medium described herein, the PPDU includes an orthogonal frequency-division multiple access PPDU and the indication of the puncturing pattern indicates zero or one or two punctured 20 MHz bandwidths for each 80 MHz bandwidth within the 480 MHz contiguous channel bandwidth or the 640 MHz contiguous channel bandwidth.

In some examples of the method, wireless communications devices, and non-transitory computer-readable medium described herein, the U-SIG field of a TB PPDU includes a set of multiple spatial reuse fields indicating spatial reuse information for each of a set of multiple 20 MHz portions of the 480 MHz contiguous channel bandwidth or the 640 MHz contiguous channel bandwidth.

In some examples of the method, wireless communications devices, and non-transitory computer-readable medium described herein, the preamble includes an EHT signal field including a RU allocation subfield and a quantity of entries in the RU allocation subfield may be based on the indicated channel bandwidth being one of the 480 MHz contiguous channel bandwidth or the 640 MHz contiguous channel bandwidth.

In some examples of the method, wireless communications devices, and non-transitory computer-readable medium described herein, the preamble includes an UHR STF, the UHR STF includes a set of multiple sequences within 80 MHz segments or 160 MHz segments of the 480 MHz contiguous channel bandwidth or the 640 MHz contiguous channel bandwidth, and each of the set of multiple sequences may be multiplied by a different coefficient.

In some examples of the method, wireless communications devices, and non-transitory computer-readable medium described herein, the preamble includes an UHR LTF, the UHR LTF includes a set of multiple sequences within 80 MHz segments of the 480 MHz contiguous channel bandwidth or the 640 MHz contiguous channel bandwidth, each sequence of the set of multiple sequences includes multiple parts, and each part of the multiple parts may be multiplied by a different coefficient.

In some examples of the method, wireless communications devices, and non-transitory computer-readable medium described herein, a phase rotation pattern on a 80 MHz subblock basis within the 480 MHz contiguous channel bandwidth or the 640 MHz contiguous channel bandwidth may be applied to a legacy portion of the preamble.

In some examples of the method, wireless communications devices, and non-transitory computer-readable medium described herein, a lower frequency tone 3×996 RU of the 480 MHz contiguous channel bandwidth or 4×996 RU of the 640 MHz contiguous channel bandwidth of the PPDU may be encoded using binary phase shift keying dual subcarrier modulation, and the lower frequency tone 3×996 RU of the 480 MHz contiguous channel bandwidth or 4×996 RU of the 640 MHz contiguous channel bandwidth may be duplicated and phase shifted onto a higher frequency tone 3×996 RU of the 480 MHz contiguous channel bandwidth or 4×996 RU of the 640 MHz contiguous channel bandwidth of the PPDU.

In some examples of the method, wireless communications devices, and non-transitory computer-readable medium described herein, a spectral mask may be applied to the preamble and the payload and the spectral mask may have one of: a 0 dBr bandwidth of 479 MHz, −20 dBr at 240.5 MHz frequency offset, −28 dBr at 480 MHz frequency offset, and −40 dBr at 720 MHz frequency offset for a 480 MHz PPDU, where the spectral mask for frequency offsets in between 239.5 MHz and 240.5 MHz, 240.5 MHz and 480 MHz, and 480 MHz and 720 MHz may be linearly interpolated in decibels domain from requirements for 239.5 MHz, 240.5 MHz, 480 MHz, and 720 MHz frequency offsets; a 0 dBr bandwidth of 478 MHz, −20 dBr at 241 MHz frequency offset, −28 dBr at 480 MHz frequency offset, and −40 dBr at 720 MHz frequency offset for a 480 MHz non-high throughput duplicate PPDU, where the spectral mask for frequency offsets in between 239 MHz and 241 MHz, 241 MHz and 480 MHz, and 480 MHz and 720 MHz may be linearly interpolated in decibels domain from requirements for 239 MHz, 241 MHz, 480 MHz, and 720 MHz frequency offsets; a 0 dBr bandwidth of 639 MHz, −20 dBr at 320.5 MHz frequency offset, −28 dBr at 640 MHz frequency offset, and −40 dBr at 960 MHz frequency offset for a 640 MHz PPDU, where the spectral mask for frequency offsets in between 319.5 MHz and 320.5 MHz, 320.5 MHz and 640 MHz, and 640 MHz and 760 MHz may be linearly interpolated in decibels domain from the requirements for 319.5 MHz, 320.5 MHz, 640 MHz, and 960 MHz frequency offsets; a 0 dBr bandwidth of 638 MHz, −20 dBr at 320 MHz frequency offset, −28 dBr at 640 MHz frequency offset, and −40 dBr at 960 MHz frequency offset for a 640 MHz non-high throughput duplicate PPDU, where the spectral mask for frequency offsets in between 319 MHz and 320 MHz, 320 MHz and 640 MHz, and 640 MHz and 760 MHz may be linearly interpolated in decibels domain from the requirements for 319 MHz, 320 MHz, 640 MHz, and 960 MHz frequency offsets, and where a transmit spectrum may not exceed a maximum of the spectral mask and −39 dBm/MHz at any frequency offset.

Details of one or more aspects of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations.

FIG. 3a shows an example extremely high throughput (EHT) physical layer (PHY) PDU (PPDU) usable for communications between a wireless AP and one or more wireless stations (STAs).

FIG. 3b shows an example ultra high reliability (UHR) multi-user PPDU usable for communications between a wireless AP or non-AP STA and one or more wireless STAs.

FIG. 3c shows an example UHR Trigger based (TB) PPDU usable for communications between a wireless AP and one or more wireless STAs.

FIG. 4 shows a hierarchical format of an example PPDU usable for communications between a wireless AP and one or more wireless STAs.

FIG. 5 shows an example of channelization diagrams that supports techniques for 480 and 640 MHz transmission in Wi-Fi.

FIG. 6 shows an example of a signaling diagram that supports techniques for 480 and 640 MHz transmission in Wi-Fi.

FIG. 7 shows an example of a channelization diagram that supports techniques for 480 MHz transmission in Wi-Fi.

FIG. 8 shows example of a resource unit allocation diagram that supports techniques for 480 MHz transmission in Wi-Fi.

FIG. 9 shows an example of a process flow that supports techniques for 480 and 640 MHz transmission in Wi-Fi.

FIG. 10 shows an example of a transmit spectrum mask that supports techniques for 480 and 640 MHz transmission in Wi-Fi.

FIGS. 11 and 12 show block diagrams of devices that support techniques for 480 and 640 MHz transmission in Wi-Fi.

FIG. 13 shows a block diagram of an example wireless communication device that supports techniques for 480 and 640 MHz transmission in Wi-Fi.

FIGS. 14 and 15 show flowcharts illustrating example processes that support techniques for 480 and 640 MHz transmission in Wi-Fi.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to supporting 480 and 640 megahertz (MHz) physical layer (PHY) protocol data units (PPDUs) in wireless communications. Some aspects more specifically relate to the introduction of a bandwidth extension field in the universal signal field (U-SIG) of the preamble of the PPDU that jointly indicates, with the bandwidth field in U-SIG, that the channel bandwidth for the PPDU is a 480 MHz contiguous channel bandwidth or a 640 MHz contiguous channel bandwidth. In many systems, the bandwidth field in U-SIG is not large enough to indicate a particular 480 MHz channel bandwidth or 640 MHz channel bandwidth in addition to possible 20 MHz, 40 MHz, 80 MHz, 160 MHz, and 320 MHz channel bandwidths, while leaving at least one reserved value. Introduction of the bandwidth extension field thus enables the transmitting wireless communications device to indicate that the PPDU is a 480 MHz channel bandwidth or 640 MHz channel bandwidth PPDU. For example, the bandwidth extension field in combination with the bandwidth field may indicate whether the operating bandwidth is 20 MHz, 40 MHz, 80 MHz, 160 MHz, 320 MHz-1, 320 MHz-2, 480 MHz-1, 480 MHz-2, 480 Mhz-3, 640 MHz-1, 640 MHz-2, 640 MHz-3, or 640 MH2-4, where MHz-1, MHz-2, etc., refer to different channelizations. A channelization refers to a set of (for example, one or more) possible channels (center frequency and channel bandwidth). In some examples, indicating a channel bandwidth may include indicating a channelization for a particular channel bandwidth. For example, a 320 MHz channel may include any two adjacent 160 MHz channels in the 6 GHz band, where two types of channelizations for 320 MHz may be defined: 320 MHz-1 and 320 MHz-2. In such examples, 320 MHz-1 may be defined as a 320 MHz channel with channel center frequency numbered 31, 95, and 159, and 320 MHz-2 may be defined as a 320 MHz channel with channel center frequency numbered 63, 127, and 191. In some aspects, a 480 MHz contiguous channel bandwidth may be indicated as a 320 MHz channel bandwidth with an additional 160 MHz channel bandwidth. The receiving wireless communications device can identify the operating channel for the PPDU based on the identified channel bandwidth and the frequency at which the receiving device receives the preamble.

In some aspects, parameters of the 480 MHz or 640 MHz PPDUs may be defined to account for the larger channel bandwidth of the 480 MHz or 640 MHz PPDUs as compared to 20 MHz, 40 MHz, 80 MHz, 160 MHz, and 320 MHz PPDUs. For example, parameters such as the tone plan, resource unit (RU) allocation indication, spatial reuse field(s), short training field, long training field, pilot signal location, phase shifts, and spectral masks may be adjusted based on a 480 MHz or 640 MHz channel bandwidth being used for a PPDU. In some aspects, some resources within a contiguous 480 MHz channel bandwidth or 640 MHz channel bandwidth may be punctured (for example, not used). For example, a 640 MHz contiguous channel bandwidth may be punctured to support 480 MHz PPDU transmissions (by puncturing 160 MHz of resources). Allowed puncturing patterns may be defined for 480 MHz and 640 MHz PPDUs, and the transmitting wireless communications device may signal the puncturing pattern for a 480 MHz or 640 MHz PPDU in the preamble of the PPDU.

Particular aspects of the subject matter described in this disclosure can be implemented to realize one or more of the following potential advantages. In some aspects, by increasing the channel bandwidth of a PPDU to 480 MHz or 640 MHz, more data may be transmitted in a PPDU as more RUs are available based on the larger bandwidth as compared to 20 MHz, 40 MHz, 80 MHz, 160 MHz, and 320 MHz PPDUs, and accordingly higher peak throughput may be achieved. The described techniques can be used to indicate whether a PPDU is a 480 MHz or 640 MHz PPDU. By using a bandwidth extension field in addition to a bandwidth field in U-SIG that in combination jointly indicates that the channel bandwidth for the PPDU is a 480 MHz contiguous channel bandwidth or a 640 MHz contiguous channel bandwidth, the bandwidth field in U-SIG may be backward compatible to indicate 20 MHz, 40 MHz, 80 MHz, 160 MHz, 320 MHz-1, 320 MHz-2, 480 MHz-1 channelizations for devices that cannot operate using a 480 MHz or 640 MHz channel bandwidth. Additionally, or alternatively, the parameters of the 480 MHz and 640 MHz PPDUs may be adjusted to account for the increased bandwidth and corresponding RUs as compared to 20 MHz, 40 MHz, 80 MHz, 160 MHz, and 320 MHz PPDUs. For example, tone plans may be defined to account for the additional RUs and multiple RUs (MRUs) in the 480 MHz or 640 MHz PPDUs. Use of spatial reuse field(s) may allow for multiple basis service sets (BSSs) to operate in the same channel for the 480 MHz or 640 MHz PPDUs. Definition of the short training field and long training fields may enable accurate channel estimation for 480 MHz or 640 MHz PPDUs. Definition of pilot signal locations may enable the receiving wireless communications device to accurately perform phase tracking for 480 MHz or 640 MHz PPDUs. Phase rotations and phase shifts may be defined for 480 MHz or 640 MHz PPDUs to reduce peak to average power ratio (PAPR), and transmission masks may be defined for 480 MHz or 640 MHz PPDUs to increase spectral efficiency. Use of puncturing may enable non-contiguous channels (for example, a non-contiguous 480 MHz channel bandwidth within a 640 MHz contiguous channel bandwidth) or may support 480 MHz transmission within a 640 MHz PPDU. Definition of allowed puncturing patterns may enable the transmitting wireless communications device to indicate the puncturing pattern for a PPDU to the receiving wireless communications device. Indication of a 480 MHz channel bandwidth as a 320 MHz channel bandwidth with an additional 160 MHz channel bandwidth may allow for backwards compatibility and/or interoperability with legacy wireless communications devices (for example, Extremely High Throughput (EHT) devices) that do not understand 480 MHz channelization but are able to understand 320 MHz channelization. For example, such legacy devices may transmit or receive within the primary channel configured for the legacy devices (for example, the 320 MHz primary channel).

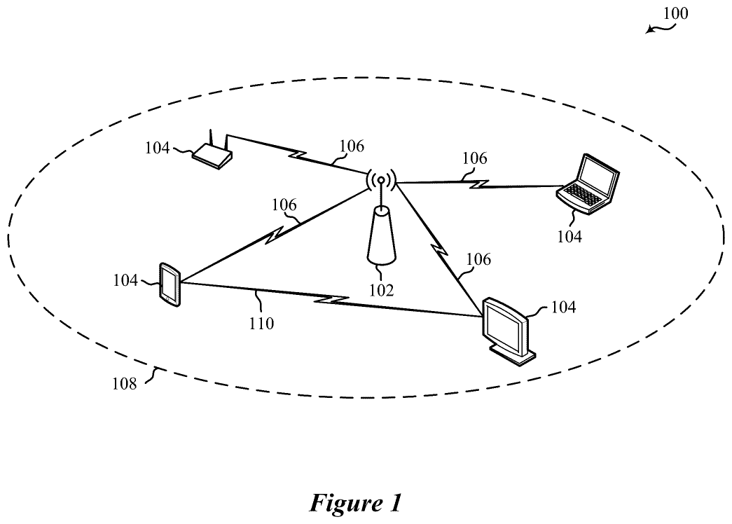

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11bc, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (cNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR, VR, MR, or XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHZ-71 GHZ), FR4 (52.6 GHz-114.25 GHZ), and FR5 (114.25 GHZ-300 GHZ).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bandwidth bonding. For example, PPDUs may be transmitted over physical channels having bandwidths of 40 MHz, 80 MHz, 160 MHz, 240 MHz, 320 MHz, 480 MHz, or 640 MHz by bonding together bandwidth from multiple 20 MHz channels (for example, adjacent 20 MHz channels).

Puncturing is a wireless communication technique that enables a wireless communication device (such as an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as AP 102 or STA 104) may puncture the subchannels on which there is interference and in essence spread the data of the PPDU to cover the remaining portion of the channel bandwidth. For example, if a transmitting device determines (for example, detects, identifies, ascertains, or calculates), in association with a contention operation, that one or more 20 MHz subchannels of a wider channel bandwidth are busy or otherwise not available, the transmitting device implement puncturing to avoid communicating over the unavailable subchannels while still utilizing the remaining portions of the channel bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHZ and 6 GHz bands.

In some examples, the AP 102 or the STAs 104 of the wireless communication network 100 may implement EHT or other features compliant with current and future generations of the IEEE 802.11 family of wireless communication protocol standards (such as the IEEE 802.11be and 802.11bn standard amendments) to provide additional capabilities over other previous systems (for example, High Efficiency (HE) systems or other legacy systems). For example, the IEEE 802.11be standard amendment introduced 320 MHz channel bandwidths, which are twice as wide as those possible with the IEEE 802.11ax standard amendment. Accordingly, the AP 102 or the STAs 104 may use 320 MHz channel bandwidths enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MH2, 40 MH2, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz channel bandwidth mode or a 160+160 MHz channel bandwidth mode, signals for transmission may be generated by two different transmit chains of the wireless communication device each having or associated with a channel bandwidth of 160 MHz (and each coupled to a different power amplifier). In some other examples, two transmit chains can be used to support a 240 MHz/160+80 MHz channel bandwidth mode by puncturing 320 MHz/160+160 MHz channel bandwidth modes with one or more 80 MHz subchannels. For example, signals for transmission may be generated by two different transmit chains of the wireless communication device each having a channel bandwidth of 160 MHz with one of the transmit chains outputting a signal having an 80 MHz subchannel punctured therein. In some other examples in which the wireless communication device may operate in a contiguous 240 MHz channel bandwidth mode, or a noncontiguous 160+80 MHz channel bandwidth mode, the signals for transmission may be generated by three different transmit chains of the wireless communication device, each having a channel bandwidth of 80 MHz. In some other examples, signals for transmission may be generated by four or more different transmit chains of the wireless communication device, each having a channel bandwidth of 80 MHz.

In noncontiguous examples, the operating bandwidth may span one or more disparate sub-channel sets. For example, the 320 MHz channel bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

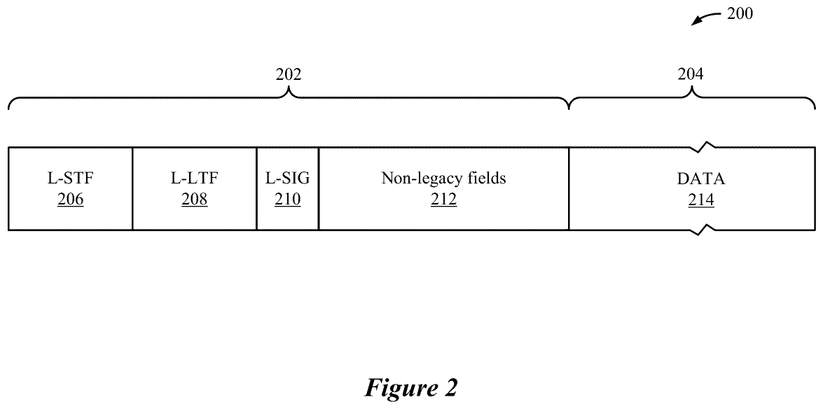

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as AP 102 or STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

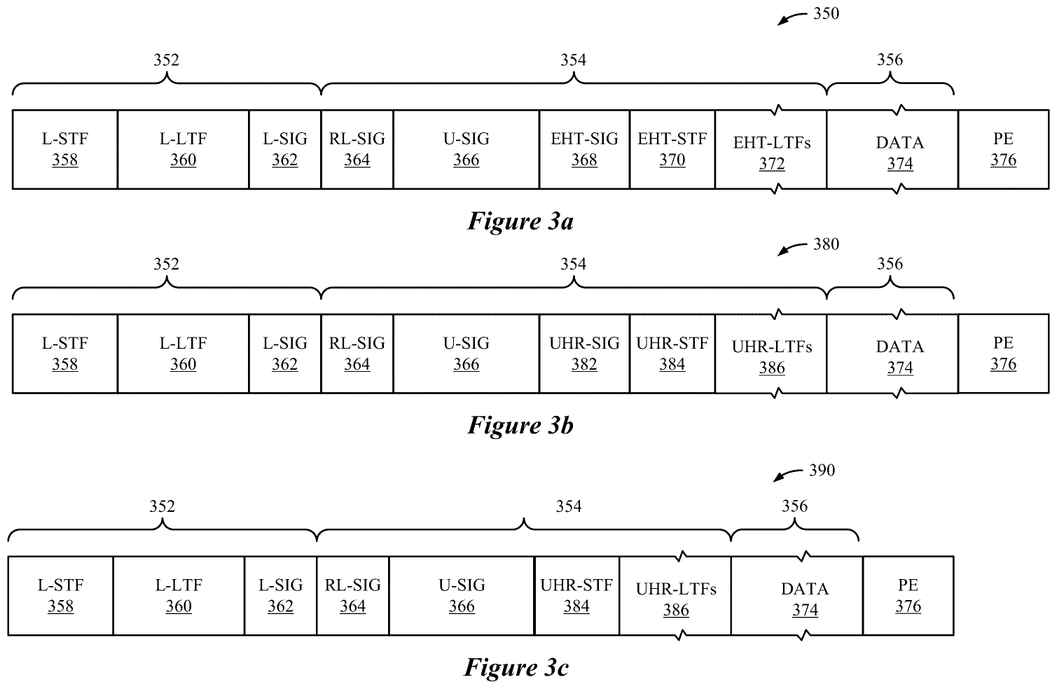

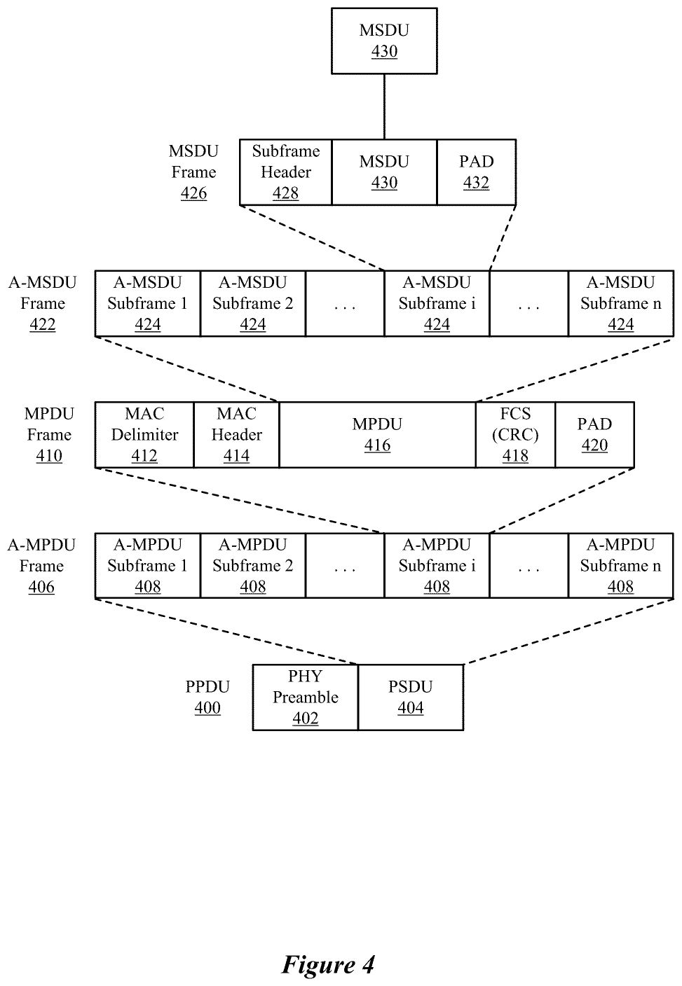

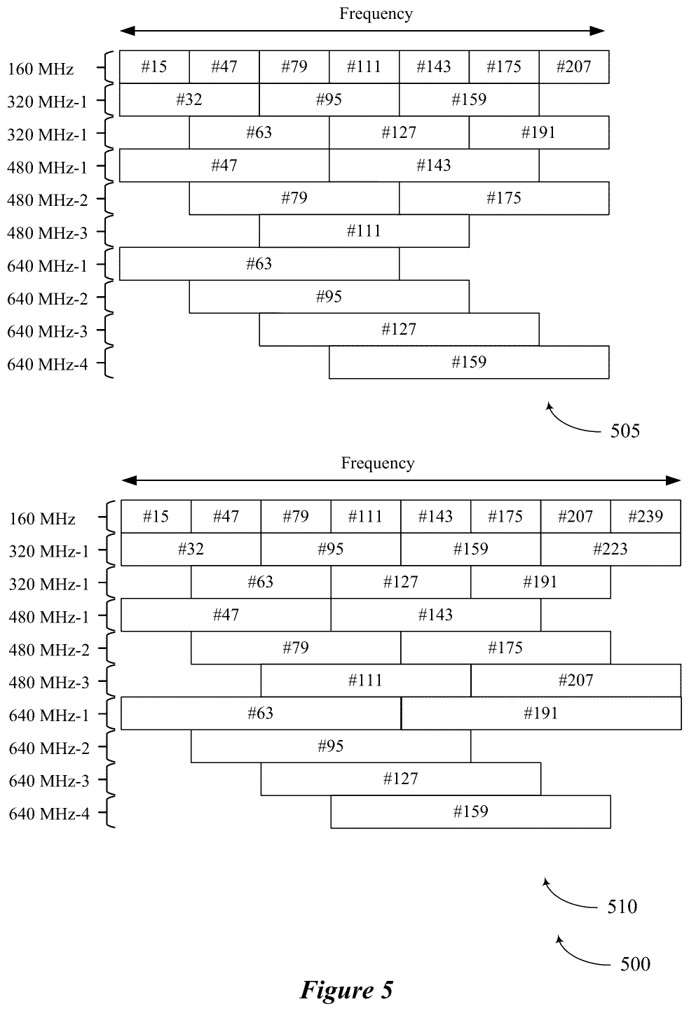

FIG. 3a shows an example EHT physical layer PPDU 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, a payload 356 that includes a data field 374, and a packet extension 376. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-independent and version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. In a 20, 40, or 80 MHz PPDU, the information in U-SIG 366 may be duplicated in every unpunctured 20 MHz subchannels. In 160, 320, 480, or 640 MHz PPDU, the information in U-SIG 366 may be duplicated within the entire 80 MHz frequency subblock, and there may be content variation of U-SIG 366 in different 80 MHz frequency subblocks.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include RU allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

FIG. 3b shows an example ultra high reliability (UHR) multi-user PPDU 380 usable for communications between a wireless AP or non-AP STA and one or more wireless STAs. The UHR multi-user PPDU 380 may be the same as the EHT PPDU 350 of FIG. 3a, except in the UHR multi-user PPDU 380, the EHT-SIG 368 is replaced with a UHR signal field 382 (referred to herein as “UHR-SIG 382”), the EHT-STF 370 is replaced with a UHR-STF 384, and the EHT-LTF 372 is replaced with a UHR-LTF 386 in the non-legacy portion 354. In the UHR multi-user PPDU 380, one or both of U-SIG 366 and the UHR-SIG 382 may be structured as, and carry version-independent and version-dependent information for, other wireless communication protocol versions associated with amendments to the IEEE family of standards beyond EHT and UHR. For example, U-SIG 366 may be used by a receiving device (such as the AP 102 or the STA 104) to interpret bits in one or more of UHR-SIG 382 or the data field 374. In a 20, 40, or 80 MHz PPDU, the information in U-SIG 366 may be duplicated in every unpunctured 20 MHz subchannels. In 160, 320, 480, or 640 MHz PPDUs, the information in U-SIG 366 may be duplicated within the entire 80 MHz frequency subblock, and there may be content variation of U-SIG 366 in different 80 MHz frequency subblocks. UHR-STF 384 may be used for timing and frequency tracking and AGC, and UHR-LTF 386 may be used for more refined channel estimation.

UHR-SIG 382 may be used by an AP 102 to identify and inform one or multiple STAs 104 that the AP 102 has scheduled uplink or downlink resources for them. UHR-SIG 382 may be decoded by each compatible STA 104 served by the AP 102. UHR-SIG 382 may generally be used by the receiving device to interpret bits in the data field 374. For example, UHR-SIG 382 may include RU allocation information, spatial stream configuration information, and per-user (for example, STA-specific) signaling information. Each UHR-SIG 382 may include a common field and at least one user-specific field. In the context of OFDMA, the common field can indicate RU allocations to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

FIG. 3c shows an example UHR trigger based (TB) PPDU 390 usable for communications between a wireless AP and one or more wireless STAs. The UHR TB PPDU 390 may be the same as the UHR multi-user PPDU 380, except that the UHR TB PPDU 390 may not include a UHR-SIG 382 within the non-legacy portion 354.

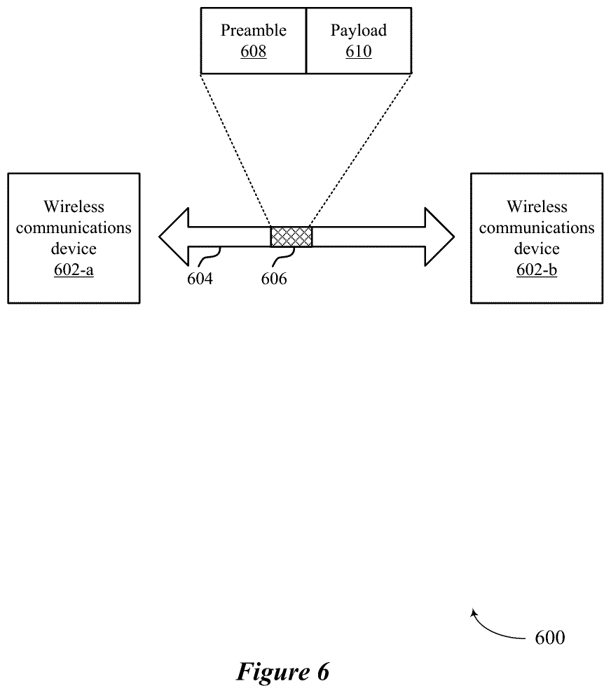

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a physical layer convergence protocol (PLCP) service data unit (PSDU) 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include cyclic redundancy check (CRC)) and padding bits 420. The MPDU 416 may carry one or more MAC service data units (MSDUs). For example, the MPDU 416 may carry an aggregated MSDU (A-MSDU) 422 including multiple A-MSDU subframes 424. Each A-MSDU subframe 424 (for example, MSDU frame 426) contains a corresponding MSDU 430 preceded by a subframe header 428 and in some aspects followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body of the MPDU 416. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body of the MPDU 416. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or RUs associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple RUs each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MH2), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

As described herein, some wireless communications systems may support 480 MHz and/or 640 MHz PPDUs. U-SIG in a PPDU may include a bandwidth field and a bandwidth extension field where the bandwidth extension field in combination with the bandwidth field may indicate whether the operating bandwidth is 20 MHz, 40 MHz, 80 MHz, 160 MHz, 320 MHz-1, 320 MHz-2, 480 MHz-1, 480 MHz-2, 480 Mhz-3, 640 MHz-1, 640 MHz-2, 640 MH2-3, or 640 MHz-4. According to some aspects described herein, a bandwidth extension field may be included in the PPDU in addition to the bandwidth field, such as in scenarios where the bandwidth field alone in U-SIG is not large enough to indicate a particular 480 MHz channel bandwidth or 640 MHz channel bandwidth in addition to possible 20 MHz, 40 MHz, 80 MHz, 160 MHz, and 320 MHz channel bandwidths, leaving at least one reserved value. Additionally, as described herein, parameters of the 480 MHz or 640 MHz PPDUs may be defined to account for the larger bandwidth of the 480 MHz or 640 MHz PPDUs as compared to 20 MH2, 40 MHz, 80 MHz, 160 MHz, and 320 MHz PPDUs.

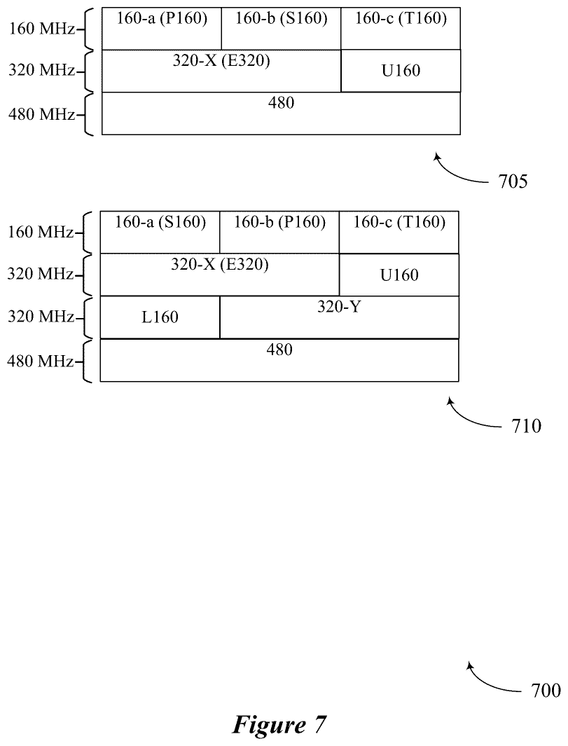

FIG. 5 shows an example of channelization diagrams 500 that supports techniques for 480 and 640 MHz transmission in Wi-Fi. The channelization diagrams 500 may implement or may be implemented by aspects of the wireless communication network 100.

For example, a first example channelization diagram 505 shows possible 160 MHz, 320 MHz, 480 MHz, and 640 MHz channels that may be used for communication of PPDUs between an AP 102 and a STA 104.

In some aspects, 480 MHz PPDUs may be defined for supporting 480 MHz channel bandwidth transmission. Some aspects may define contiguous 480 MHz channel bandwidths. Some aspects may define 640 MHz PPDUs for supporting 640 MHz channel bandwidth transmissions. Within a 640 MHz PPDU, for example, either contiguous 480 MHz channel bandwidth transmission or non-contiguous 480 channel bandwidth MHz transmission may be supported when employing a puncturing mode. Contiguous 480 MHz channel bandwidth transmission within a 640 MHz PPDU may render 480 MHz a redundant channel bandwidth mode, but use of a defined 480 MHz channel bandwidth may save signaling overhead as compared to contiguous 480 MHz channel bandwidth transmission within a 640 MHz PPDU. In some aspects, 640 MHz PPDUs may support both 480 MHz channel bandwidth and 640 MHz channel bandwidth transmissions. For example, both contiguous and non-contiguous 480 MHz channel bandwidth transmissions may be supported as puncturing modes when employing 640 MHz PPDUs.

As shown, up to five 480 MHz channels and up to four 640 MHz channels may be defined with overlaps. The 480 MHz channels and/or the 640 MHz channels may be defined in sub 7 GHz. For example, one reserved entry, for example, the reserved entry 138, in the operating class field in the 802.11be specification Annex E, may be used to define the five 480 MHz channels as shown in Table 1. The 480 MHz channels may include any three adjacent 160 MHz channels in the 6 GHz band. As shown in FIG. 5, up to three types of channelizations for a 480 MHz channel may be defined: 480 MHz-1, 480 MHz-2, and 480 MHz-3. The 480 MHz-1 channelization may include the 480 MHz channels with channel center frequency numbered 47 and 143. The 480 MHz-2 channelization may include the 480 MHz channels with channel center frequency numbered 79 and 175. The 480 MHz-3 channelization may include the 480 MHz channel with channel center frequency numbered 111.

TABLE 1

| | Channel Starting | Channel | |
|---|---|---|---|
| Operating | Frequency | spacing | Channel Center |
| Class | (GHz) | (MHz) | Frequency Index |
| 138 | 5.950 | 480 | 47, 79, 111, 143, 175 |

As another example, one reserved entry, for example, the reserved entry 138, in the operating class in the 802.11be specification Annex E may be used to define the four 640 MHz channels as shown in Table 2. The 640 MHz channels may include any four adjacent 160 MHz channels in the 6 GHz band. As shown in FIG. 5, up to four types of channelizations for a 640 MHz channel may be defined: 640 MHz-1, 640 MHz-2, 640 MHz-3, and 640 MHz-4. The 640 MHz-1, 640 MHz-2, 640 MHz-3, and 640 MHz-4 channelizations may include the 640 MHz channels with channel center frequency numbered 63, 95, 127, and 159, respectively.

TABLE 2

| | Channel Starting | Channel | |
|---|---|---|---|
| Operating | Frequency | spacing | Channel Center |
| Class | (GHz) | (MHz) | Frequency Index |
| 138 | 5.950 | 640 | 63, 95, 127, 159 |

A second example channelization diagram 510 shows a scenario where channels may be extended to 7.225 GHz. Expansion to 7.225 GHz allows for a new 160 MHz channel (channel center frequency index #239) to be defined. In comparison, 6 GHz channels may extend to channel center frequency index #207 in the 160 MHz channelization. Definition of a channel with channel center frequency index #239 with 160 MHz channel bandwidth may enable definition of a fourth channel, with channel center frequency index #223, in the 320 MHz-1 channelization, definition of a second channel, with channel center frequency index #207, in the 480 MHz-3 channelization, and/or definition of a fifth 640 MHz channel, with channel center frequency index #191 in the first 640 MHz channelization 640 MHz-1.

In some examples, where channels extend to 6 GHz, five 480 MHz channels may be defined in three 480 MHz channelizations (channel center frequency indices #47 and #143 in 480 MHz-1, channel center frequency indices #79 and #175 in 480 MHz-2, and channel center frequency index #111 in 480 MHz-3). In some examples, where channels extend to 7.225 GHz, six 480 MHz channels may be defined in three 480 MHz channelizations (channel center frequency indices #47 and #143 in 480 MHz-1, channel center frequency indices #79 and #175 in 480 MHz-2, and channel center frequency indices #111 and #207 in 480 MHz-3). In some examples, two 480 MHz channelizations may be defined, and accordingly four 480 MHz channels may be defined (channel center frequency indices #47 and #143 in 480 MHz-1 and channel center frequency indices #79 and #175 in 480 MHz-2).

In some examples, for example, in UHR, two 480 MHz channelizations may be defined. As shown in Table 3, a reserved entry, such as the reserved entry 138, may be used to define four 480 MHz channelizations. In some examples, for example, in future communications generations, another entry may be used to define additional 480 MHz channels. For example, if channels are extended to 7.225 GHz, a second reserved entry (139) in the operating class in 802.11be specification Annex E may be used to define two more 480 MHz channels in the 480 MHz-3 channelization (for example, channel #111 and #207 in the second example channelization diagram 510), as shown in Table 4.

TABLE 3

| | Channel Starting | Channel | |
|---|---|---|---|
| Operating | Frequency | spacing | Channel Center |
| Class | (GHz) | (MHz) | Frequency Index |
| 138 | 5.950 | 480 | 47, 79, 143, 175 |

TABLE 4

| | Channel Starting | Channel | |
|---|---|---|---|
| Operating | Frequency | spacing | Channel Center |
| Class | (GHz) | (MHz) | Frequency Index |
| 138 | 5.950 | 480 | 47, 79, 143, 175 |
| 139 | 5.950 | 480 | 111, 207 |

In some examples, for example, in UHR, four 640 MHz channelizations may be defined. As shown in Table 5, a reserved entry, such as the reserved entry 138, may be used to define four 640 MHz channelizations, where 640 MHz-1 includes two channels and 640 MHz-2, 640 MHz-3, and 640 MHz-4 each include one channel. In examples where 5 640 MHz channels are defined, the channel bandwidth of a PPDU may be signaled using a bandwidth field and a bandwidth extension field, as described herein. In some examples, as shown in Table 6, two non-overlapping 640 MHz channels may be defined. For example, channels with channel center frequency index #63 and channel center frequency index #191 may be defined within a 640 MHz-1 channelization. In such examples, the channel bandwidth may be indicated via the bandwidth field (for example, without use of a bandwidth extension field as one 640 MHz channelization is defined which can be indicated via one of the reserved bits of the bandwidth field).

TABLE 5

| | Channel Starting | Channel | |
|---|---|---|---|
| Operating | Frequency | spacing | Channel Center |
| Class | (GHz) | (MHz) | Frequency Index |
| 138 | 5.950 | 640 | 63, 95, 127, 159, 191 |

TABLE 6

| | Channel Starting | Channel | |
|---|---|---|---|
| Operating | Frequency | spacing | Channel Center |
| Class | (GHz) | (MHz) | Frequency Index |
| 138 | 5.950 | 640 | 63, 191 |

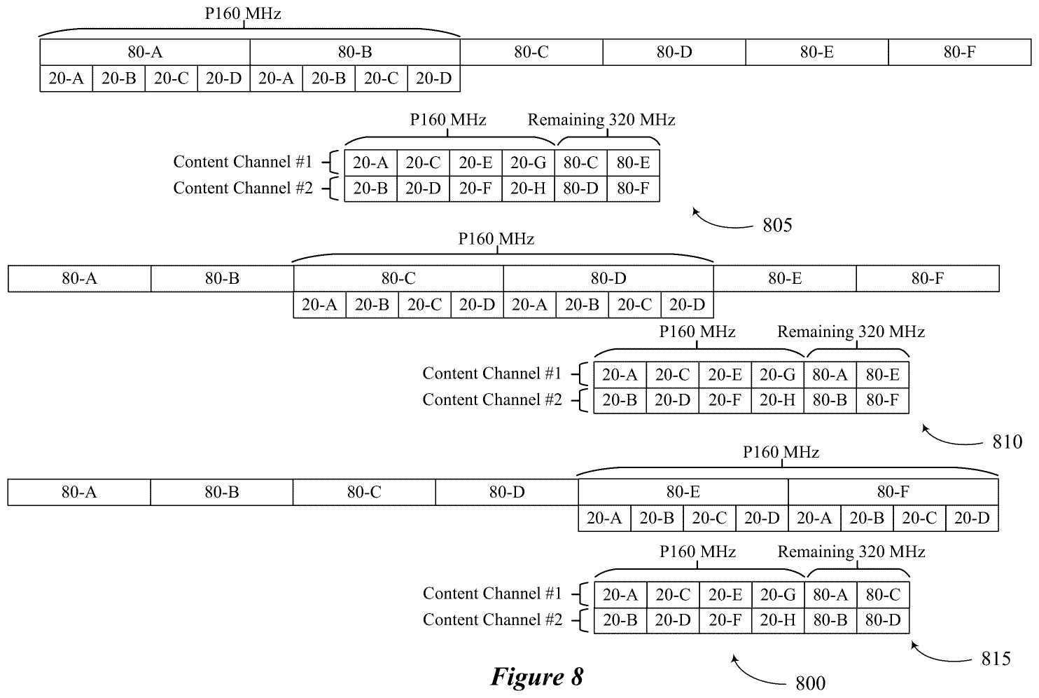

FIG. 6 shows an example of a signaling diagram 600 that supports techniques for 480 and 640 MHz channel bandwidth transmission in Wi-Fi. The signaling diagram 600 may implement or may be implemented by aspects of the wireless communication network 100. For example, the signaling diagram includes a wireless communications device 602-a and a wireless communications device 602-b, which may be examples of APs 102 or a STAs 104 as described herein. The wireless communications device 602-a may communicate with the wireless communications device 602-b via a wireless link 604, which may be an example of a communication link 106 described herein.

For example, the wireless communications device 602-a may transmit a PPDU 606 to the wireless communications device 602-b. The PPDU 606 may be an example of a PPDU 350 as described with reference to FIG. 3a or a PPDU 400 as described with reference to FIG. 4. For example, the PPDU 606 may include a preamble 608 and a payload 610. The preamble 608 may be an example of a PHY preamble 402 and the payload may be an example of a PSDU 404 as described with reference to FIG. 4. For example, the preamble 608 may include legacy portion 352 and a non-legacy portion 354 and the payload 610 may be a payload 356 as described with reference to FIG. 3a.

The PPDU 606 may be a 480 MHz PPDU or a 640 MHz PPDU. The U-SIG field (for example, the U-SIG 366 of FIG. 3a) in the preamble 608 may include a bandwidth field and a bandwidth extension field which jointly (for example, in combination together) indicate the channel bandwidth. Based on the frequency at which the wireless communications device 602-b receives the preamble 608 and the channel bandwidth indicated by the bandwidth field and bandwidth extension field, the wireless communications device 602-b may identify the channelization (for example, the center frequency and the channel bandwidth) for the PPDU 606.

The bandwidth field in U-SIG may be a 3-bit version independent field. The bandwidth field in U-SIG may use 6 values to indicate whether the channelization is 20 MHz, 40 MHz, 80 MHz, 160 MHz, 320 MH2-1, or 320 MHz-2. Thus, the bandwidth field may include two reserved values (values 6 and 7) to indicate a channel bandwidth other than 20 MHz, 40 MHz, 80 MHz, 160 MH2, 320 MHz. The two reserved values may be insufficient to indicate two possible 480 MHz channelizations or two possible 640 MHz channelizations, in addition to at least one reserved value for future generation. The two reserved values may be insufficient to indicate three possible 480 MHz channelizations or four possible 640 MHz channelizations. The bandwidth extension field may be used in U-SIG to jointly indicate a 480 MHz channel bandwidth or a 640 MHz channel bandwidth. In some aspects, the bandwidth extension field may be a version dependent field, which may mean that the existence, location, size, and interpretation of the bandwidth extension field depend on the value in the PHY version identifier field in the preamble 608. In some aspects, the bandwidth extension field may be version independent from UHR, which may mean that the existence, location, size, and interpretation of the bandwidth extension field is consistent across PHY version from UHR and future generations, i.e., the PHY version identifier field in the preamble 608 not indicating EHT. Both the bandwidth field and the bandwidth extension field may carry different information in different subbands (for example, in each 160 MHz subband of the 480 MHz or 640 MHz channel bandwidth). EHT STAs 104 may understand the bandwidth field and may disregard the bandwidth extension field, and UHR STAs (for example, the wireless communications device 602-b) may understand both the bandwidth field and the bandwidth extension field. In some aspects, the preamble 608 may not include a bandwidth extension field, and the two reserved values (6 and 7) may be used to indicate two 480 MHz channelizations (for example, 480 MH2-1 and 480 MHz-2 channelization) or two 640 MHz channelizations (for example, 640 MHz-1 and 640 MHz-2 channelizations). Such a design without a bandwidth extension field may be simple to implement, but may not be understood by In-BSS and overlapping BSS (OBSS) EHT STAs 104, and thus may break inter-operability with such EHT STAs 104. Additionally, in such examples without a bandwidth extension field, the 3 bit bandwidth field may not include any reserved values for future generations.

For a 480 MHz channel bandwidth, the combination of the bandwidth field and bandwidth extension field may indicate the channel bandwidth to be used for the PPDU transmission/reception. In a first aspect relating to the 480 MHz channel bandwidth, the bandwidth extension field may be a 2 bit field in U-SIG. In the first aspect relating to the 480 MHz channel bandwidth, if the bandwidth field value is 0-5 or 7, the bandwidth extension field may be treated as Disregard, as explained in subclause 36.3.12.7 of 802.11be draft D3.2. For example, a receiving device may continue processing the PPDU regardless of the content of this field. In the first aspect relating to the 480 MHz channel bandwidth, if the value in the bandwidth field is 6 (or 7 in some aspects), the value in the 2-bit bandwidth extension field may indicate a 480 MHz-1 channelization, a 480 MHz-2 channelization, or a 480 MHz-3 channelization, leaving remaining value(s) reserved (for example, set as a validate value). In a second aspect relating to the 480 MHz channel bandwidth, the bandwidth extension field may be a 1 bit field in U-SIG. In the second aspect, if the bandwidth field value is 0-3 or 7, the bandwidth extension field may be disregarded. In the second aspect relating to the 480 MHz channel bandwidth, if the bandwidth field value is 4-6, the bandwidth extension field may be set to 0 to indicate a 320 MHz-1 channelization, a 320 MHz-2 channelization, or a reserved value (for example, set as a validate value), respectively. In the second aspect relating to the 480 MHz channel bandwidth, if the bandwidth field value is 4-6, the bandwidth extension field may be set to 1 to indicate a 480 MHz-1 channelization, a 480 MHz-2 channelization, or a 480 MHz-3 channelization. In a third aspect relating to the 480 MHz channel bandwidth, the bandwidth extension field may be a 1 bit field in U-SIG. In the third aspect relating to the 480 MHz channel bandwidth, if the bandwidth field value is 0-5 or 7, the bandwidth extension field may be treated as Disregard, as explained in subclause 36.3.12.7 of 802.11be draft D3.2. For example, a receiving device may continue processing the PPDU regardless of the content of this field. In the third aspect relating to the 480 MHz channel bandwidth, if the value in the bandwidth field is 6 (or 7 in some aspects), the value in the 1-bit bandwidth extension field may indicate a 480 MHz-1 channelization or a 480 MHz-2 channelization.

Similarly, for a 640 MHz channel bandwidth, the combination of the bandwidth field and bandwidth extension field may indicate the channel bandwidth used for the PPDU transmission./reception. In a first aspect relating to the 640 MHz channel bandwidth, the bandwidth extension field may be a 2 bit field in U-SIG. In the first aspect relating to the 640 MHz channel bandwidth, if the bandwidth field value is 0-5 or 7, the bandwidth extension field may be treated as Disregard, as explained in subclause 36.3.12.7 of 802.11be draft D3.2. For example, a receiving device may continue processing the PPDU regardless of the content of this field. In the first aspect relating to the 640 MHz channel bandwidth, if the value in the bandwidth field is 6 (or 7 in some aspects), the value in the 2-bit bandwidth extension field may indicate a 640 MHz-1 channelization, a 640 MHz-2 channelization, a 640 MHz-3 channelization, or a 640 MH2-4 channelization. In a second aspect relating to the 640 MHz channel bandwidth, the bandwidth extension field may be a 1 bit field in U-SIG. In the second aspect, if the bandwidth field value is 0-3, the bandwidth extension field may be disregarded. In the second aspect relating to the 640 MHz channel bandwidth, if the bandwidth field value is 4-7, the bandwidth extension field may be set to 0 to indicate a 320 MH2-1 channelization, a 320 MHz-2 channelization, or two reserved values (for example, set as validate values), respectively. In the second aspect relating to the 640 MHz channel bandwidth, if the bandwidth field value is 4-7, the bandwidth extension field may be set to 1 to indicate a 640 MHz-1 channelization, a 640 MHz-2 channelization, a 640 MHz-3 channelization, or a 640 MH2-4 channelization. In a third aspect relating to the 640 MHz channel bandwidth, the bandwidth extension field may be a 1 bit field in U-SIG. In the third aspect relating to the 640 MHz channel bandwidth, if the bandwidth field value is 0-5 or 7, the bandwidth extension field may be treated as Disregard, as explained in subclause 36.3.12.7 of 802.11be draft D3.2. For example, a receiving device may continue processing the PPDU regardless of the content of this field. In the third aspect relating to the 640 MHz channel bandwidth, if the value in the bandwidth field is 6 (or 7 in some aspects), the value in the 1-bit bandwidth extension field may indicate a 640 MHz-1 channelization or a 640 MHz-4 channelization.

If the PPDU 606 is a 480 MHz PPDU, a tone plan may be defined for the 480 MHz PPDU. The 480 MHz tone plan may be a duplicate of six EHT 80 MHz tone plans, one in each 80 MHz frequency portion of the 480 MHz channel bandwidth. In some aspects, in addition to the RUs and MRUs defined in 802.11be, a 6×996-tone RU may be defined. In such aspects, the RU may span the entire 480 MHz without puncturing, and may include six 996-tone RUs, one in each 80 MHz portion of the 480 MHz channel bandwidth. In some aspects, in addition to the RUs and MRUs defined in 802.11be, MRUs in non-OFDMA or OFDMA may be defined. Such MRUs may include a 4×996-tone MRU (15 MRUs if arbitrarily formed, or 3 MRUs if only formed by two 2×996-tone RUs), a 4×996+484-tone MRU (60 MRUs if arbitrarily formed, or 12 MRUs if only formed by two 2×996-tone RUs and one 484-tone RU), a 4×996+484+242-tone MRU (120 MRUs if arbitrarily formed or 24 MRUs if only formed by two 2×996-tone RUs and one 484+242-tone MRU), a 5×996-tone MRU (6 MRUs), 5×996+484-tone MRU (12 MRUs), or a 5×996+484+242-tone MRU (24 MRUs).

If the PPDU 606 is a 640 MHz PPDU, a tone plan may be defined for the 640 MHz PPDU. The 640 MHz tone plan may be a duplicate of eight EHT 80 MHz tone plans, one in each 80 MHz frequency portion of the 640 MHz channel bandwidth. In some aspects, in addition to the RUs and MRUs defined in 802.11be, an 8×996-tone RU may be defined. In such aspects, the RU may span the entire 640 MHz without puncturing, and may include eight 996-tone RUs, one in each 80 MHz portion of the 640 MHz bandwidth. In some aspects, in addition to the RUs and MRUs defined in 802.11be, MRUs in non-OFDMA or OFDMA may be defined. Such MRUs may include a 4×996-tone RU (2 RUs if formed by lower and upper 320 MHz subbands), a 4×996+484-tone MRU, a 5×996-tone MRU (8 MRUs if formed by one 4×996-tone RU and one 996-tone RU), a 5×996+484-tone MRU, a 6×996-tone MRU (4 MRUs if formed by three 2×996-tone RUs), a 6×996+484-tone MRU, a 7×996-tone RU (8 MRUs), or a 7×996+484-tone RU (16 MRUs).

If the PPDU 606 is a 480 MHz PPDU, different allowed puncturing patterns may be defined. For non-OFDMA 480 MHz PPDUs, puncturing patterns with 40 MHz granularity may be defined, with ‘1’ indicating no puncturing for the 40 MHz portion and ‘x’ indicating puncturing the 40 MHz portion. A first defined puncturing pattern includes no puncturing ([1111 1111 1111]). 40 MHz puncturing patterns (12 patterns) may be defined-corresponding to puncturing any of the 40 MHz portions (for example, [x111 1111 1111], [1×11 1111 1111], etc.), resulting in 5×996+484-tone MRUs. 80 MHz puncturing patterns (6 patterns) may be defined-corresponding to puncturing any 80 MHz portions (for example, [xx11 1111 111; xx 1111 1111], etc.), resulting in 5×996 MRUs. Concurrent two 80 MHz puncturing patterns may be defined (up to 13 patterns): [xx11 xx11 1111], [xx11 11xx 1111], [xx11 1111 xx11], [xx11 1111 11xx], [11xx xx1 1111], [11xx 11xx 1111], [11xx 1111 xx11], [11xx 1111 11xx], [1111 xxxx 1111], [1111 xx11 xx11], [1111 xx11 11xx], [1111 11xx xx11], [1111xx 11xx], resulting in 4×996-tone MRUs. Concurrent 80 MHz and 40 MHz puncturing patterns may be defined (60 patterns). For concurrent 80 MHz and 40 MHz puncturing patterns, in each of the 6 patterns where one 80 MHz is punctured, an additional 40 MHz is punctured (for example, [xxx1 1111 1111]) resulting in 4×996+484-tone MRUs. For OFDMA PPDUs, puncturing patterns may be defined as in EHT. Accordingly, for 480 MHz OFDMA PPDUs, within each 80 MHz portion of the 480 MHz channel bandwidth, the allowed punctured patterns are: 1111 (no puncturing), x111, 1x11, 11x1, 111x, xx11, 11xx, and 1xx1, where each digit stands for one 20 MHz, “1” means no puncturing and “x” means puncturing.

If the PPDU 606 is a 640 MHz PPDU, different allowed puncturing patterns may be defined. Similarly to a 480 MHz PPDU, for non-OFDMA 640 MHz PPDUs, puncturing patterns may be defined with 40 MHz granularity, with ‘l’ indicating no puncturing for the 40 MHz portion and ‘x’ indicating puncturing the 40 MHz portion. A first defined puncturing pattern includes no puncturing ([11 1111 1111 1111]). 40 MHz puncturing patterns (16 patterns) may be defined-corresponding to puncturing any of the 40 MHz portions (for example, [x111 1111 1111 111], [1×11 1111 1111 111], etc.), resulting in 7×996+484-tone MRUs. 80 MHz puncturing patterns (8 patterns) may be defined-corresponding to puncturing any 80 MHz portions (for example, [xx11 1111 1111 111], [11xx 1111 1111 1111], etc.), resulting in 7×996 MRUs. 160 MHz puncturing patterns (4 patterns) may be defined-corresponding to puncturing any 80 MHz portions (for example, [xxxx 1111 1111 111], [1111 xxxx 1111 1111], etc.), resulting in 6×996 MRUs. Concurrent two 80 MHz puncturing patterns may be defined (24 patterns including the four 160 MHz puncturing patterns)-corresponding to puncturing any two of the 80 MHz portions (for example, [xx11 xx11 1111 1111],) resulting in 6×996-tone MRUs. Concurrent 160 MHz and 80 MHz puncturing patterns may be defined (24 patterns if any combination, or 12 patterns if only the first or the fourth 160 MHz can be punctured) (for example, [xxxx xx11 1111 1111], [xxxx 11xx 1111 1111], [xxxx 1111 xx11 1111], [xxxx 1111 11xx 1111], [xxxx 1111 1111 xx11], [xxxx 1111 1111 11xx], [xx11 xxxx 1111 1111], [11xx xxxx 1111 1111], [1111 xxxx xx11 1111], [1111 xxxx 11xx 1111], [1111 xxxx 1111 xx11], [1111 xxxx 1111 11xx], [xx11 1111 xxxx 1111], [11xx 1111 xxxx 1111], [1111 xx11 xxxx 1111], [1111 11xx xxxx 1111], [1111 1111 xxxx xx11], [1111 1111 xxxx 11xx], [xx11 1111 1111 xxxx], [11xx 1111 1111 xxxx], [1111 xx11 1111 xxxx], [1111 11xx 1111 xxxx], [1111 1111 xx11 xxxx], [1111 1111 11xx xxxx]) resulting in 5×996-tone MRUs. For OFDMA PPDUs, puncturing patterns may be defined as in EHT. Accordingly, for 640 MHz OFDMA PPDUs, within each 80 MHz portion of the 640 MHz bandwidth, the allowed punctured patterns are: 1111 (no puncturing), x111, 1x11, 11x1, 111x, xx11, 11xx, and 1xx1, where each digit stands for one 20 MHz, “1” means no puncturing and “x” means puncturing.

If the PPDU 606 is a trigger-based (TB) PPDU, the preamble 608 may not indicate the punctured channel information. A 5-7 bit punctured channel information field may be included in the preamble 608 of the PPDUs 606 is a PPDU type other than a TB PPDUs (for example, a multi-user (MU) PPDU). For a non-OFDMA PPDU, the punctured channel information field indicates the punctured patterns and corresponding MRUs for the non-OFDMA transmissions. For example, for a 480 MHz PPDU, a 5-bit punctured channel information may be used to indicate no puncturing, 40 MHz puncturing (one of 12 patterns), 80 MHz puncturing (one of 6 patterns), or concurrent two 80 MHz puncturing (one of 13 patterns). As another example, for a 480 MHz PPDU, a 7-bit punctured channel information may be used to indicate no puncturing, 40 MHz puncturing (one of 12 patterns), 80 MHz puncturing (one of 6 patterns), concurrent two 80 MHz puncturing (one of 13 patterns), or concurrent 80 MHz and 40 MHz puncturing (one of 60 patterns). As another example, for a 640 MHz PPDU, a 5-bit punctured channel information may be used to indicate no puncturing, 80 MHz puncturing (one of 8 patterns), 160 MHz puncturing (one of 4 patterns), or concurrent 160 MHz and 80 MHz puncturing (one of 12 patterns if only first or fourth 160 MHz can be punctured). As another example, for a 640 MHz PPDU, a 7-bit punctured channel information may be used to indicate no puncturing, 40 MHz puncturing (one of 16 patterns), 80 MHz puncturing (one of 8 patterns), 160 MHz puncturing (one of 4 patterns), concurrent 160 MHz and 80 MHz puncturing (one of 24 patterns if any combination is allowed). For an OFDMA PPDU (the same as EHT), 4 bits in the punctured channel information field may be used to indicate the 4-bit bitmap of the punctured pattern of the current 80 MHz frequency subblock (referred to as “Allowed Punctured Patterns”), and the remaining bits in the punctured channel information field may be disregarded.

If the PPDU 606 is a 480 MHz TB PPDU, in some aspects two spatial reuse fields may be included in the U-SIG in the preamble 608. In such aspects, the Spatial reuse 1 field and the Spatial reuse 2 field may indicate the spatial reuse information for each 20 MHz portion of the lower and upper 240 MHz portion within the 480 MHz bandwidth, respectively. If the PPDU 606 is a 480 MHz TB PPDU, in some aspects, three spatial reuse fields may be included in the U-SIG in the preamble 608. In such aspects, the Spatial reuse 1 field, the Spatial reuse field 2, and the Spatial reuse 3 field may indicate the spatial reuse information for each 20 portion MHz of the lowest 160 MHz, second lowest 160 MHz, and highest 160 MHz portions within the 480 MHz bandwidth, respectively.

If the PPDU 606 is a 640 MHz TB PPDU, in some aspects two spatial reuse fields may be included in the U-SIG in the preamble 608. In such aspects, the Spatial reuse 1 field and the Spatial reuse 2 field may indicate the spatial reuse information for each 20 MHz portion of the lower and upper 320 MHz portion within the 640 MHz bandwidth, respectively. If the PPDU 606 is a 640 MHz TB PPDU, in some aspects, four spatial reuse fields may be included in the U-SIG in the preamble 608. In such aspects, the Spatial reuse 1 field, the Spatial reuse field 2, the Spatial reuse field 3, and the Spatial reuse 4 field may indicate the spatial reuse information for each 20 portion MHz of the lowest 160 MHz, second lowest 160 MHz, third lowest 160 MHz, and highest 160 MHz portions within the 640 MHz bandwidth, respectively.

As described herein, the preamble 608 may include an EHT-SIG (for example, the EHT-SIG 368 of FIG. 3a) that indicates RU allocation. In some aspects, the RU allocation in EHT-SIG for a 480 MHz PPDU may be backwards compatible to the EHT RU allocation subfield. In some such aspects, the EHT 9-bit RU allocation subfield design may be reused with added entries for new MRUs available based on the increased bandwidth of the 480 MHz PPDU. For example, the EHT RU allocation subfield has 1+8=9 values set to Validate and 26×8 values set to Disregard. These values set to Disregard may be repurposed for new MRUs (for example, 4×996-tone MRU (15 MRUs arbitrarily formed) and 5×996-tone MRU (6 MRUs), each with 1 to 8 user fields). In some aspects that are backwards compatible to the EHT RU allocation subfield, more RU allocation subfields may be added. For example, a 480 MHz bandwidth may use a total of 12 RU allocation subfields in each content channel, one for each 20 MHz. There are two 9-bit RU Allocation-A subfields, and six 9-bit RU Allocation-B subfields, and thus another four 9-bit RU Allocation-C subfields may be added followed by a 4-bit CRC and 6-bit tail fields to account for the additional RUs). In some aspects that are backwards compatible to the EHT RU allocation subfield, one more code block for the common field in EHT-SIG may be added. For example, three code blocks may be used for the RU allocation for a 480 MHz PPDU, one for other fields and RU Allocation-A subfields, one for RU Allocation-B subfields, and the last one for RU Allocation-C subfields. In some aspects, a new RU allocation design may be implemented in EHT-SIG. For example, the RU allocation subfield may be designed using more bits to accommodate more new MRUs in the 480 MHz bandwidth. As another example, the RU allocation subfield may be designed using different mapping for the larger bandwidth (for example, the 480 MHz bandwidth starts with minimum 242-tone RU size). As another example, more RU allocation subfields may be added, including a total of 12 RU allocation subfields, one for each 20 MHz. As another example, the code blocks may be restructured according to the size of the RU allocation subfield.

Similarly for a 640 MHz PPDU, in some aspects, the RU allocation in EHT-SIG for a 640 MHz PPDU may be backwards compatible to the EHT RU allocation subfield. In some such aspects, the EHT 9-bit RU allocation subfield design may be reused with added entries for new MRUs available based on the increased bandwidth of the 640 MHz PPDU. For example, the EHT RU allocation subfield has 1+8=9 values set to Validate and 26×8 values set to Disregard. These values set to Disregard may be repurposed for new MRUs (for example, 4×996-tone RU (2 RUs), 5×996-tone MRU (8 MRUs), 6×996-tone MRU (4 MRUs), or 7×996-tone RU (8 MRUs), each with 1 to 8 user fields). In some aspects that are backwards compatible to the EHT RU allocation subfield, more RU allocation subfields may be added. For example, a 640 MHz bandwidth may use a total of 16 RU allocation subfields in each content channel, one for each 20 MHz. There are two 9-bit RU Allocation-A subfields, and six 9-bit RU Allocation-B subfields, and thus another six 9-bit RU Allocation-C subfields may be added followed by a 4-bit CRC and 6-bit tail fields to account for the additional RUs, and another two 9-bit RU Allocation-D subfields followed by a 4-bit CRC and 6-bit tail fields). In some aspects that are backwards compatible to the EHT RU allocation subfield, one more code block for the common field in EHT-SIG may be added. For example, four code blocks may be used for the RU allocation for a 640 MHz PPDU, one for other fields and RU Allocation-A subfields, one for RU Allocation-B subfields, one for RU Allocation-C subfields, and the last one for RU Allocation-D subfields. In some aspects, a new RU allocation design may be implemented in EHT-SIG. For example, the RU allocation subfield may be designed using more bits to accommodate more new MRUs in the 640 MHz bandwidth. As another example, the RU allocation subfield may be designed using different mapping for the larger bandwidth (for example, the 640 MHz bandwidth starts with minimum 242-tone RU size). As another example, more RU allocation subfields may be added, including a total of 16 RU allocation subfields, one for each 20 MHz. As another example, the code blocks may be restructured according to the size of the RU allocation subfield.

The wireless communications device 602-a may transmit a UHR STF sequence in the preamble 608 which the wireless communications device 602-b may use for channel estimation for the PPDU 606. In some aspects, the UHR STF sequence for a 480 MHz or 640 MHz PPDU may be similar to the UHR STF sequency in 802.11be. In some aspects, a 1×UHR STF sequence may be transmitted, and in some aspects, a 2×UHR STF sequence may be transmitted. For example, a 1×UHR STF sequence may be used in UHR single user or multi-user PPDUs, and a 2×UHR STF sequence may be used in UHR trigger based PPDUs. In some aspects, an 802.11bn 480 MHz or 640 MHz PPDU may reuse the 1×EHT-STF and 2×EHT-STF defined for 20 MHz, 40 MHz, 80 MHz, 160 MHz, and 320 MHz PPDUs.

For a 480 MHz PPDU, in a first aspect, to generate the UHR STF sequence, the wireless communications device 602-a may repeat a 1× or 2×80 MHz high efficiency STF sequence (80 HES) on second, third, fourth, fifth, and sixth 80 MHz portions of the 480 MHz bandwidth, and the second, third, fourth, fifth, and sixth 80 MHz portions are multiplied by additional coefficients. For example, the UHR STF sequence may be given by [80 HES a*80 HES b*80 HES c*80 HES d*80 HES c*80 HES]. For a 1×UHR STF, 80 HES={M 1 −M 0 −M 1 −M}, and for a 2×UHR STF, 80 HES={M −1 M −1 −M −1 M 0 −M 1 M 1 −M 1 −M}, where M {−1, −1, −1, +1, +1, +1, −1, +1, +1, +1, −1, +1, +1, −1, +1}. Candidates of a, b, c, d and e are 1 and −1, as in 802.11ax or 802.11be, may be optimized by minimax approach considering all RUs and MRU combinations in all punctured and non-punctured cases. For example, for a 1×UHR STF for a 480 MHz PPDU, UHRS_{-3056:16:3056}={M 1 −M 0 −M 1 −M a*(0 M 1 −M 0 −M 1 −M) b*(0 M 1 −M 0 −M 1 −M) c*(0 M 1 −M 0 −M 1 −M) d*(0 M 1 −M 0 −M 1 −M) e*(0 M 1 −M 0 −M 1 −M)}*(1+j)/sqrt(2), where UHRS₋₃₀₆₄=UHRS₋₂₀₄₀=UHRS₋₁₀₃₂=UHRS₋₁₀₁₆=UHRS₋₈=UHRS₈=UHRS₁₀₁₆=UHRS₁₀₃₂=UHRS₂₀₄₀=UHRS₃₀₆₄=0. For a 2×UHR STF for a 480 MHz PPDU, UHRS_{-3064:8:3064}={M −1 M −1 −M −1 M 0 −M 1 M 1 −M 1 −M a*(0 M −1 M −1 −M −1 M 0 −M 1 M 1 −M 1 −M) b*(0 M −1 M −1 −M −1 M 0 −M 1 M 1 −M 1 −M) c*(0 M −1 M −1 −M −1 M 0 −M 1 M 1 −M 1 −M) d*(0 M −1 M −1 −M −1 M 0 −M 1 M 1 −M 1 −M) e*(0 M −1 M −1 −M −1 M 0 −M 1 M 1 −M 1 −M)}*(1+j)/sqrt(2).

For a 480 MHz PPDU, in a second aspect, to generate the UHR STF sequence, the wireless communications device 602-a may repeat a 1× or 2×160 MHz sequence (160 HES) on second and third 160 MHz portions of the 480 MHz bandwidth, and the second and third 160 MHz portions are multiplied by additional coefficients. For example, the UHR STF sequence may be given by [160 HES a*160 HES b*160 HES]. For a 1×UHR STF, 160 HES={M 1 −M 0 −M 1 −M 0 −M −1 M 0 −M 1 −M}, and for a 2×UHR STF, 160 HES={M −1 M −1 −M −1 M 0 −M 1 M 1 −M 1 −M 0 −M 1 −M 1 M 1 −M 0 −M 1 M 1 −M 1 −M}, where M={−1, −1, −1, +1, +1, +1, −1, +1, +1, +1, −1, +1, +1, −1, +1}. Candidates of a, b, c, d and e are 1 and −1, as in 802.11ax/be, may be optimized by minimax approach considering all RUs and MRU combinations in all punctured and non-punctured cases. For example, for a 1×UHR STF for a 480 MHz PPDU, UHRS_{-3056:16:3056}={M 1 −M 0 −M 1 −M 0 −M −1 M 0 −M 1 −M a*(0 M 1 −M 0 −M 1 −M 0 −M −1 M 0 −M 1 −M) b*(0 M 1 −M 0 −M 1 −M 0 −M −1 M 0 −M 1 −M)}*(1+j)/sqrt(2), where UHRS₋₃₀₆₄=UHRS₋₂₀₄₀=UHRS₋₁₀₃₂=UHRS₋₁₀₁₆=UHRS₋₈=UHRS₈=UHRS₁₀₁₆=UHRS₁₀₃₂=UHRS₂₀₄₀=UHRS₃₀₆₄=0. For a 2×UHR STF for a 480 MHz PPDU, UHRS_{-3064:8:3064}={M −1 M −1 −M −1 M 0 −M 1 M 1 −M 1 −M 0 −M 1 −M 1 M 1−M0 −M 1 M 1 −M 1 −M a*(0 M −1 M −1 −M −1 M 0 −M 1 M 1 −M 1 −M 0 −M 1 −M 1 M 1 −M 0 −M 1 M 1 −M 1 −M) b*(0 M −1 M −1 −M −1 M 0 −M 1 M 1 −M 1 −M 0 −M 1 −M 1 M 1 −M 0 −M 1 M 1 −M 1 −M)}*(1+j)/sqrt(2).

Similarly, for a 640 MHz PPDU, in a first aspect, to generate the UHR STF sequence, the wireless communications device 602-a may repeat 1× or 2×80 MHz high efficiency STF sequence (80 HES) on second, third, fourth, fifth, sixth, seventh, and eighth 80 MHz portions of the 640 MHz bandwidth, and the second, third, fourth, fifth, sixth, seventh, and eighth 80 MHz portions are multiplied by additional coefficients. For example, the UHR STF sequence may be given by [80 HES a*80 HES b*80 HES c*80 HES d*80 HES e*80 HES f*80 HES g*80 HES]. For a 1×UHR STF, 80 HES={M 1 −M 0 −M 1 −M}, and for a 2×UHR STF, 80 HES={M −1 M −1 −M −1 M 0 −M 1 M 1−M 1 −M}, where M {−1, −1, −1, +1, +1, +1, −1, +1, +1, +1, −1, +1, +1, −1, +1}.

Candidates of a, b, c, d and e are 1 and −1, as in 802.11ax or 802.11be, may be optimized by minimax approach considering all RUs and MRU combinations in all punctured and non-punctured cases. For example, for a 1×UHR STF for a 640 MHz PPDU, UHRS_{-4080:16:4080}={M 1 −M 0 −M 1 −M a*(0 M 1 −M 0 −M 1 −M) b*(0 M 1 −M 0 −M 1 −M) c*(0 M 1 −M 0 −M 1 −M) d*(0 M 1 −M 0 −M 1 −M) e*(0 M 1 −M 0 −M 1 −M) f*(0 M 1 −M 0 −M 1 −M) g*(0 M 1 −M 0 −M 1 −M)}*(1+j)/sqrt(2), where UHRS₋₄₀₈₈=UHRS₋₃₀₆₄=UHRS₋₂₀₄₀=UHRS₋₁₀₃₂=UHRS₋₁₀₁₆=UHRS₋₈=UHRS₈=UHRS₁₀₁₆=UHRS₁₀₃₂=UHRS₂₀₄₀=UHRS₃₀₆₄=UHRS₄₀₈₈=0. For a 2×UHR STF for a 480 MHz PPDU, UHRS_{-4088:8:4088}={M −1 M −1 −M −1 M 0 −M 1 M 1 −M 1 −M a*(0 M −1 M −1 −M −1 M 0 −M 1 M 1 −M 1 −M) b*(0 M −1 M −1 −M −1 M 0 −M 1 M 1 −M 1 −M) c*(0 M −1 M −1 −M −1 M 0 −M 1 M 1 −M 1 −M) d*(0 M −1 M −1 −M −1 M 0 −M 1 M 1 −M 1 −M) e*(0 M −1 M −1 −M −1 M 0 −M 1 M 1 −M 1 −M) f*(0 M −1 M −1 −M −1 M 0 −M 1 M 1 −M 1 −M) g*(0 M −1 M −1 −M −1 M 0 −M 1 M 1 −M 1 −M)}*(1+j)/sqrt(2).

For a 640 MHz PPDU, in a second aspect, to generate the UHR STF sequence, the wireless communications device 602-a may repeat a 1× or 2×160 MHz sequence (160 HES) on second, third, and fourth 160 MHz portions of the 640 MHz bandwidth, and the second, third, and fourth 160 MHz portions are multiplied by additional coefficients. For example, the UHR STF sequence may be given by [160 HES a*160 HES b*160 HES c*160 HES]. For a 1×UHR STF, 160 HES={M 1 −M 0 −M 1 −M 0 −M −1 M 0 −M 1 −M}, and for a 2×UHR STF, 160 HES={M −1 M −1 −M −1 M 0 −M 1 M 1 −M 1 −M 0 −M 1 −M 1 M 1 −M 0 −M 1 M 1 −M 1 −M}, where M={−1, −1, −1, +1, +1, +1, −1, +1, +1, +1, −1, +1, +1, −1, +1}. Candidates of a, b, c, d and e are 1 and −1, as in 802.11ax or 802.11be, may be optimized by minimax approach considering all RUs and MRU combinations in all punctured and non-punctured cases. For example, for a 1×UHR STF for a 640 MHz PPDU, UHRS_{-4080:16:4080} {M 1 −M 0 −M 1 −M 0 −M −1 M 0 −M 1 −M a*(0 M 1 −M 0 −M 1 −M 0 −M −1 M 0 −M 1 −M) b*(0 M 1 −M 0 −M 1 −M 0 −M −1 M 0 −M 1 −M) c*(0 M 1 −M 0 −M 1 −M 0 −M −1 M 0 −M 1 −M)}*(1+j)/sqrt(2), where UHRS−4088=UHRS−3064=UHRS−2040=UHRS−1032=UHRS−1016=UHRS−8=UHRS8=UHRS1016=UHRS1032=UHRS2040=UHRS3064=UHRS4088=0. For a 2×UHR STF for a 480 MHz PPDU, UHRS 4088:8:4088={M −1 M −1 −M −1 M 0 −M 1 M 1 −M 1 −M 0 −M 1 −M 1 M 1 −M 0 −M 1 M 1 −M 1 −M a*(0 M −1 M −1 −M −1 M 0 −M 1 M 1 −M 1 −M 0 −M 1 −M 1 M 1 −M 0 −M 1 M 1 −M 1 −M) b*(0 M −1 M −1 −M −1 M 0 −M 1 M 1 −M 1 −M 0 −M 1 −M 1 M 1 −M 0 −M 1 M 1 −M 1 −M) c*(0 M −1 M −1 −M −1 M 0 −M 1 M 1 −M 1 −M 0 −M 1 −M 1 M 1 −M 0 −M 1 M 1 −M 1 −M)}*(1+j)/sqrt(2).

The wireless communications device 602-a may transmit a UHR LTF sequence in the preamble 608 which the wireless communications device 602-b may use for channel estimation for the PPDU 606. 802.11bn may support 1×, 2×, and 4×UHR LTF sequences. 802.11bn may reuse x, 2×, and 4×EHT LTF sequences for 1×, 2×, and 4×UHR LTF sequences for 20 MHz, 40 MHz, 80 MHz, 160 MHz, 320 MHz PPDUs.

In some aspects, the wireless communications device 602-a may generate a 1×UHR LTF sequence for a 480 MHz PPDU or a 640 MHz PPDU by repeating the 802.11 ax 80 MHz LTF sequences and applying the coefficient value on the first through second part of the 80 MHz LTF. For example, the 1×UHR LTF sequence for a 480 MHz PPDU may be given by UHRLTF_{480 MHz_1x}={LTF_{80 MHz_lower1_1x}, 0₂₃, LTF_{80 MHz_upper1_1x}, 0₂₃ LTF_{80 MHz_lower2_1x}, 0₂₃, LTF_{80 MHz_upper2_1x}, 0₂₃, LTF_{80 MHz_lower3_1x}, 0₂₃, LTF_{80 MHz_upper3_1x}}, where: LTF_{80 MHz_lower1_1x}={s(1)*LTF_{80 MHz_left_1x}, 0, s(2)*LTF_{80 MHz_right_1x}}; LTF_{80 MHz_upper1_1x}={s(3)*LTF_{80 MHz_left_1x}, 0, s(4)*LTF_{80 MHz_right_1x}}; LTF_{80 MHz_upper2_1x}={s(5)*LTF_{80 MHz_left_1x}, 0, s(6)*LTF_{80 MHz_right_1x}}; LTF_{80 MHz_upper2_1x}={s(7)*LTF_{80 MHz_left_1x}, 0, s(8)*LTF_{80 MHz_right_1x}}; LTF_{80 MHz_upper3_1x}={s(9)*LTF_{80 MHz_left_1x}, 0, s(10)*LTF_{80 MHz_right_1x}}; and LTF_{80 MHz_upper3_1x}={s(11)*LTF_{80 MHz_left_1x}, 0, s(12)*LTF_{80 MHz_right_1x}}; LTF_{80 MHz_left_1x} and LTF_{80 MHz_right_1x} may be as defined in the 802.11ax specification. The values of s(1) through s(12) may be optimized by minimizing the worst PAPR evaluation for multi-stream considering all RUs and MRU combinations in all punctured and non-punctured cases. As another example, the 1× UHR LTF sequence for a 640 MHz PPDU may be given by UHRLTF_{640 MHz_1x}={LTF_{80 MHz_lower1_1x}, 0₂₃, LTF_{80 MHz_upper1_1x}, 0₂₃, LTF_{80 MHz_lower2_1x}, 0₂₃, LTF_{80 MHz_upper2_1x}, 0₂₃, LTF_{80 MHz_lower3_1x}, 0₂₃, LTF_{80 MHz_upper3_1x}, 0₂₃, LTF_{80 MHz_lower4_1x}, 0₂₃, LTF_{80 MHz_upper4_1x}} where: LTF_{80 MHz_lower1_1x}={s(1)*LTF_{80 MHz_left_1x}, 0, s(2)*LTF_{80 MHz_right_1x}}; LTF_{80 MHz_upper1_1x}={s(3)*LTF_{80 MHz_left_1x}, 0, s(4)*LTF_{80 MHz_right_1x}}; LTF_{80 MHz_lower2_1x}={s(5)*LTF_{80 MHz_left_1x}, 0, s(6)*LTF_{80 MHz_right_1x}}; LTF_{80 MHz_upper2_1x}={s(7)*LTF_{80 MHz_left_1x}, 0, s(8)*LTF_{80 MHz_right_1x}}; LTF_{80 MHz_lower3_1x}={s(9)*LTF_{80 MHz_left_1x}, 0, s(10)*LTF_{80 MHz_right_1x}}; LTF_{80 MHz_upper3_1x}={s(11)*LTF_{80 MHz_left_1x}, 0, s(12)*LTF_{80 MHz_right_1x}}; LTF_{80 MHz_lower4_1x}={s(13)*LTF_{80 MHz_left_1x}, 0, s(16)*LTF_{80 MHz_right_1x}}; and LTF_{80 MHz_upper4_1x}={s(15)*LTF_{80 MHz_left_1x}, 0, s(16)*LTF_{80 MHz_right_1x}}. The values of s(1) through s(16) may be optimized by minimizing the worst PAPR evaluation for multi-stream considering all RUs and MRU combinations in all punctured and non-punctured cases.

In some aspects, the wireless communications device 602-a may generate a 4×UHR LTF sequence for a 480 MHz PPDU or a 640 MHz PPDU by repeating the 802.11ax 80 MHz LTF sequences and applying the coefficient value on the first through second part of the 80 MHz LTF. For example, the 4×UHR LTF sequence for a 480 MHz PPDU may be given by UHRLTF_{480 MHz_4x}={LTF_{80 MHz_lower1_4x}, 0₂₃, LTF_{80 MHz_upper1_4x}, 0₂₃, LTF_{80 MHz_lower2_4x}, 0₂₃, LTF_{80 MHz_upper2_4x}, 0₂₃, LTF_{80 MHz_lower3_4x}, 0₂₃, LTF_{80 MHz_upper3_4x}}, where: LTF_{80 MHz_lower1_4x}={n(1)*LTF_{80 MHz_subblock_left_4x}, 0₅, n(2)*LTF_{80 MHz_subblock_right_4x}}; LTF_{80 MHz_upper1_4x}={n(3)*LTF_{80 MHz_subblock_left_4x}, 0₅, n(4)*LTF_{80 MHz_subblock_right_4x}}; LTF_{80 MHz_upper2_4x}={n(5)*LTF_{80 MHz_subblock_left_4x}, 0₅, n(6)*LTF_{80 MHz_subblock_right_4x}}; LTF_{80 MHz_upper2_4x}={n(7)*LTF_{80 MHz_subblock_left_4x}, 0₅, n(8)*LTF_{80 MHz_subblock_right_4x}}; LTF_{80 MHz_lower3_4x}={n(9)*LTF_{80 MHz_subblock_left_4x}, 0₅, n(10)*LTF_{80 MHz_subblock_right_4x}}; and LTF_{80 MHz_upper3_4x}={n(11)*LTF_{80 MHz_subblock_left_4x}, 0₅, n(12)*LTF_{80 MHz_subblock_right_4x}}. LTF_{80 MHz_subblock_left_4x} and LTF_{80 MHz_subblock_right_4x} may be as defined in the 802.11be specification. The values of n(1) through n(12) may be optimized by minimizing the worst PAPR evaluation for multi-stream considering all RUs and MRU combinations in all punctured and non-punctured cases. As another example, the 4×UHR LTF sequence for a 640 MHz PPDU may be given by UHRLTF_{640 MHz_4x}={LTF_{80 MHz_lower1_4x}, 0₂₃, LTF_{80 MHz_upper1_4x}, 0₂₃, LTF_{80 MHz_lower2_4x}, 0₂₃, LTF_{80 MHz_upper2_4x}, 0₂₃, LTF_{80 MHz_lower3_4x}, 0₂₃, LTF_{80 MHz_upper3_4x}, 0₂₃, LTF_{80 MHz_lower4_4x}, 0₂₃, LTF_{80 MHz_upper4_4x}}, where: LTF_{80 MHz_lower1_4x}={n(1)*LTF_{80 MHz_subblock_left_4x}, 0₅, n(2)*LTF_{80 MHz_subblock_right_4x}}; LTF_{80 MHz_upper1_4x}={n(3)*LTF_{80 MHz_subblock_left_4x}, 0₅, LTF; n(4)*LTF_{80 MHz_subblock_right_4x}}; LTF_{80 MHz_lower2_4x}={n(5)*LTF_{80 MHz_subblock_left_4x}, 0⁵, n(6)*LTF_{80 MHz_subblock_right_4x}}; LTF_{80 MHz_upper2_4x}={n(7)*LTF_{80 MHz_subblock_left_4x}, 0₅, n(8)*LTF_{80 MHz_subblock_right_4x}}; LTF_{80 MHz_lower3_4x}={n(9)*LTF_{80 MHz_subblock_left_4x}, 0₅, n(10)*LTF_{80 MHz_subblock_right_4x}}; LTF_{80 MHz_upper3_4x}={n(11)*LTF_{80 MHz_subblock_left_4x}, 0₅, n(12)*LTF_{80 MHz_subblock_right_4x}}; LTF_{80 MHz_lower4_4x}={n(13)*LTF_{80 MHz_subblock_left_4x}, 0₅, n(14)*LTF_{80 MHz_subblock_right_4x}}; and LTF_{80 MHz_upper4_4x}={n(15)*LTF_{80 MHz_subblock_left_4x}, 0₅, n(16)*LTF_{80 MHz_subblock_right_4x}}. LTF_{80 MHz_subblock_left_4x} and LTF_{80 MHz_subblock_right_4x} may be as defined in the 802.11be specification. The values of n(1) through n(16) may be optimized by minimizing the worst PAPR evaluation for multi-stream considering all RUs and MRU combinations in all punctured and non-punctured cases.

In some aspects, the wireless communications device 602-a may generate a 2×UHR LTF sequence for a 480 MHz PPDU or a 640 MHz PPDU by repeating the 802.11ax 80 MHz LTF sequences and applying the coefficient value on the first through fourth part of the 80 MHz LTF. For example, the 2×UHR LTF sequence for a 480 MHz PPDU may be given by UHRLTF_{480 MHz_2x}={LTF_{80 MHz_lower1_2x}, 0₂₃, LTF_{80 MHz_upper1_2x}, 0₂₃, LTF_{80 MHz_lower2_2x}, 0₂₃, LTF_{80 MHz_upper2_2x}, 0₂₃, LTF_{80 MHz_lower3_2x}, 0₂₃, LTF_{80 MHz_upper3_2x}}, where: LTF_{80 MHz_lower1_2x}={c(1)*LTF_{80_2x} (1:245), c(2)*LTF_{80_2x} (246:500), 0, c(3)*LTF_{80_2x}(502:756), c(4)*LTF_{80_2x} (757:1001)}; LTF_{80 MHz_upper1_2x}={c(5)*LTF_{80_2x}(1:245), c(6)*LTF_{80_2x} (246:500), 0, c(7)*LTF_{80_2x} (502:756), c(8)*LTF_{80_2x}(757:1001)}; LTF_{80 MHz_lower2_2x}={c(9)*LTF_{80_2x}(1:245), c(10)*LTF_{80_2x}(246:500), 0, c(11)*LTF_{80_2x}(502:756), c(12)*LTF_{80_2x}(757:1001)}; LTF_{80 MHz_upper2_2x}={c(13)*LTF_{80_2x}(1:245), c(14)*LTF_{80_2x}(246:500), 0, c(15)*LTF_{80_2x}(502:756), c(16)*LTF_{80_2x}(757:1001)}; LTF_{80 MHz_lower3_2x}={c(17)*LTF_{80_2x}(1:245), c(18)*LTF_{80_2x}(246:500), 0, c(19)*LTF_{80_2x} (502:756), c(20)*LTF_{80_2x}(757:1001)}; and LTF_{80 MHz_upper3_2x}={c(21)*LTF_{80_2x}(1:245), c(22)*LTF_{80_2x} (246:500), 0, c(23)*LTF_{80_2x}(502:756), c(24)*LTF_{80_2x}(757:1001)}. LTF_{80 MHz_2x} may be as defined in the 802.11be specification. The values of c(1) through c(24) may be optimized by minimizing the worst PAPR evaluation for multi-stream considering all RUs and MRU combinations in all punctured and non-punctured cases. As another example, the 2×UHR LTF sequence for a 640 MHz PPDU may be given by UHRLTF_{480 MHz_2x}={LTF_{80 MHz_lower1_2x}, 0₂₃, LTF_{80 MHz_upper1_2x}, 0₂₃, LTF_{80 MHz_lower2_2x}, 0₂₃, LTF_{80 MHz_upper2_2x}, 0₂₃, LTF_{80 MHz_lower3_2x}, 0₂₃, LTF_{80 MHz_upper3_2x}, 0₂₃, LTF_{80 MHz_lower4_2x}, 0₂₃, LTF_{80 MHz_upper4_2x}}, where: LTF_{80 MHz_lower1_2x}={c(1)*LTF_{80_2x}(1:245), c(2)*LTF_{80_2x}(246:500), 0, c(3)*LTF_{80_2x}(502:756), c(4)*LTF_{80_2x}(757:1001)}; LTF_{80 MHz_upper1_2x}={c(5)*LTF_{80_2x} (1:245), c(6)*LTF_{80_2x}(246:500), 0, c(7)*LTF_{80_2x}(502:756), c(8)*LTF_{80_2x}(757:1001)}; LTF_{80 MHz_lower2_2x}={c(9)*LTF_{80_2x}(1:245), c(10)*LTF_{80_2x}(246:500), 0, c(11)*LTF_{80_2x}(502:756), c(12)*LTF_{80_2x}(757:1001)}; LTF_{80 MHz_upper2_2x}={c(13)*LTF_{80_2x}(1:245), c(14)*LTF_{80_2x}(246:500), 0, c(15)*LTF_{80_2x} (502:756), c(16)*LTF_{80_2x}(757:1001)}; LTF_{80 MHz_lower3_2x}={c(17)*LTF_{80_2x} (1:245), c(18)*LTF_{80_2x}(246:500), 0, c(19)*LTF_{80_2x}(502:756), c(20)*LTF_{80_2x} (757:1001)}; LTF_{80 MHz_upper3_2x}={c(21)*LTF_{80_2x}(1:245), c(22)*LTF_{80_2x} (246:500), 0, c(23)*LTF_{80_2x}(502:756), c(24)*LTF_{80_2x}(757:1001)}; LTF_{80 MHz_lower4_2x}={c(25)*LTF_{80_2x}(1:245), c(26)*LTF_{80_2x}(246:500), 0, c(27)*LTF_{80_2x}(502:756), c(28)*LTF_{80_2x}(757:1001)}; and LTF_{80 MHz_upper4_2x}={c(29)*LTF_{80_2x}(1:245), c(30)*LTF_{80_2x}(246:500), 0, c(31)*LTF_{80_2x}(502:756), c(32)*LTF_{80_2x} (757:1001)}. LTF may be as defined in the 802.11be specification. The values of c(1) through c(32) may be optimized by minimizing the worst-PAPR evaluation for multi-stream considering all RUs and MRU combinations in all punctured and non-punctured cases.

The wireless communications device 602-a may transmit a pilot sequence in the preamble 608 which the wireless communications device 602-b may use for phase tracking. In some aspects, the pilot indices for 26-, 52-, 106-, 242-, or 484-tone RUs in an OFDMA or non-OFDMA 480 MHz UHR PPDU may be in each 160 MHz portion of the 480 MHz bandwidth. For example, the pilot indices in a 480 MHz PPDU may be: [The pilot indices in 160 MHz PPDU]-2048, [The pilot indices in 160 MHz PPDU], [The pilot indices in 160 MHz PPDU]+2048. For example, −468 may be one of the pilot indices in 26-, 52-, 106-, 242-, or 484-tone RUs for a 160 MHz PPDU, and accordingly the corresponding pilot indices in a 480 MHz PPDU are −468−2048=2516 in the lowest 160 MHz, −468 in the middle 160 MHz, and −468+2048=1580 in the highest 160 MHz. In some aspects, the pilot indices for 26-, 52-, 106-, 242-, or 484-tone RUs in an OFDMA or non-OFDMA 640 MHz UHR PPDU may be in each 320 MHz portion of the 640 MHz bandwidth. For example, the pilot indices in a 640 MHz PPDU may be: [The pilot indices in a 320 MHz PPDU]-2048, [The pilot indices in a 320 MHz PPDU]+2048. For example, −468 may be one of the pilot indices in 26-, 52-, 106-, 242-, or 484-tone RUs for a 320 MHz PPDU, and accordingly the corresponding pilot indices in a 640 MHz PPDU are −468−2048=−2516 in the lowest 320 MHz and 468+2048=1580 in the highest 320 MHz.

Assuming in an OFDM or non-OFDMA 80 MHz EHT PPDU the pilot indices of a 996-tone RU: P996={−468, −400, −334, −266, −220, −152, −86, −18, 18, 86, 152, 220, 266, 334, 400, 468}, for a tone plan with nx996 RUs (n≥1), a 480 MHz PPDU may have the following pilot indices: Pilot indices of 996-tone RU: {P996−2560}, {P996−1536}, {P996−512}, {P996+512}, {P996+1536}, {P996+2560}; Pilot indices of 2×996-tone RU: {P996−2560, P996−1536}, {P996−512, P996+512}, {P996+1536, P996+2560}; Pilot indices of 3×996-tone RU: {P996−2560, P996−1536, P996−512}, {P996+512, P996+1536, P996+2560}; or Pilot indices of 6×996-tone RU: {P996−2560, P996−1536, P996−512, P996+512, P996+1536, P996+2560}. And for a tone plan with nx996 RUs (n≥1), a 640 MHz PPDU may have the following pilot indices: Pilot indices of 996-tone RU: {P996−3584}, {P996−2560}, {P996−1536}, {P996−512}, {P996+512}, {P996+1536}, {P996+2560}, {P996+3584}; Pilot indices of 2×996-tone RU: {P996−3584, P996−2560}, {P996−1536, P996-512}, {P996+512, P996+1536}, {P996+2560, P996+3584}; Pilot indices of 4×996-tone RU: {P996−3584, P996−2560, P996−1536, P996-512}, {P996+512, P996+1536, P996+2560, P996+3584}; or Pilot indices of 8×996-tone RU: {P996−3584, P996−2560, P996−1536, P996−512, P996+512, P996+1536, P996+2560, P996+3584}.

The pilot subcarrier for each new MRU (due to the additional bandwidth in the 480 MHz or 640 MHz PPDU) may include the pilot subcarriers of each component RU. In some aspects, pilot values may be shifted on pilot tones in the data section from symbol to symbol for each RU or MRU, as in 802.11be.

In some aspects, for a 480 MHz PPDU or a 640 MHz PPDU, for all size of RUs or MRUs under 4×996-tone RU, the pilot mapping and values of 802.11be may be used. In some aspects, for a 480 MHz PPDU or a 640 MHz PPDU, for a 5×996-tone RU, the pilot mapping and values for a 996-tone RU may be quintuplicated (duplicated by 5 times, one in each component 996-tone RU within the 5×996-tone RU). In some aspects, for a 480 MHz PPDU or a 640 MHz PPDU, for a 6×996-tone RU, the pilot mapping and values for a 3×996-tone RU may be duplicated. In some aspects, for a 640 MHz PPDU, for a 7×996-tone RU, the pilot mapping and values for a 996-tone RU may be septuplicated (duplicated by 7 times, one in each component 996-tone RU within the 7×996-tone RU). In some aspects, for a 640 MHz PPDU, for an 8×996-tone RU, the pilot mapping and values for a 4×996-tone RU may be duplicated. For a 480 MHz PPDU or a 640 MHz PPDU, the pilot mapping and values of the new MRU may follow the pilot mapping and values of each component RU.

The wireless communications device 602-a may generate the PPDU 606 using a segment parser, and the wireless communications device 602-b may deparse the PPDU using a segment deparser. A segment parser maps transmissions into frequency segments prior to interleaving. For a 480 MHz PPDU, the 802.11be segment parser may be extended to cover the new RUs or MRUs with the parameters shown in Table 7 for the proportional round robin scheme, where s=max (1, N_{BPSCS}/2). Similarly, for a 640 MHz PPDU, the 802.11be segment parser may be extended to cover the new RUs or MRUs with the parameters shown in Table 8 for the proportional round robin scheme, where s=max (1, N_{BPSCS}/2)

TABLE 7

| | | Proportional | |
|---|---|---|---|
| RU | Nsd_ | Ratio | Leftover bits |
| Aggregation | total | (m1:m2:m3:m4) | (per symbol) |
| 484 + 996 | 1448 | 1s:2s | 44*Nbpscs on |
| | | | ru996 |
| 484 + 2*996 | 2428 | 1s:2s:2s | 44*Nbpscs on |
| | | | ru996 |
| 484 + 3*996 | 3408 | 1s:2s:2s:2s | 44*Nbpscs on |
| | | | ru996 |
| 2*996 | 1960 | 1s:1s | 0 |
| 3*996 | 2940 | 1s:1s:1s | 0 |
| 4*996 | 3920 | 1s:1s:1s:1s | 0 |
| 484 + 4*996 | 4388 | 1s:2s:2s:2s:2s | 44*Nbpscs on |
| | | | ru996 |
| 484 + 5*996 | 5360 | 1s:2s:2s:2s:2s:2s | 44*Nbpscs on |
| | | | ru996 |
| 6*996 | 5880 | 1s:1s:1s:1s:1s:1s | 0 |

TABLE 8

| RU | Nsd_ | Proportional Ratio | Leftover bits |
|---|---|---|---|
| Aggregation | total | (m1:m2:m3:m4) | (per symbol) |
| 484 + 996 | 1448 | 1s:2s | 44*Nbpscs on |
| | | | ru996 |
| 484 + 2*996 | 2428 | 1s:2s:2s | 44*Nbpscs on |
| | | | ru996 |
| 484 + 3*996 | 3408 | 1s:2s:2s:2s | 44*Nbpscs on |
| | | | ru996 |
| 2*996 | 1960 | 1s:1s | 0 |
| 3*996 | 2940 | 1s:1s:1s | 0 |
| 4*996 | 3920 | 1s:1s:1s:1s | 0 |
| 484 + 4*996 | 4388 | 1s:2s:2s:2s:2s | 44*Nbpscs on |
| | | | ru996 |
| 484 + 5*996 | 5360 | 1s:2s:2s:2s:2s:2s | 44*Nbpscs on |
| | | | ru996 |
| 6*996 | 5880 | ls:1s:1s:1s:1s:1s | 0 |
| 484 + 6*996 | 6348 | 1s:2s:2s:2s:2s:2s:2s | 44*Nbpscs on |
| | | | ru996 |
| 7*996 | 6860 | ls:1s:1s:1s:1s:1s:1s | 0 |
| 484 + 7*996 | 7328 | 1s:2s:2s:2s:2s:2s:2s:2s | 44*Nbpscs on |
| | | | ru996 |
| 8*996 | 7840 | ls:1s:1s:1s:1s:1s:1s:1s | 0 |

The wireless communications device 602-a may apply a phase rotation to transmission of the legacy portion of the preamble 608 of the PPDU 606 (for example, the legacy portion of the preamble may include the pre-UHR modulated portion of the preamble 608, which may include L-STF, L-LTF, L-SIG, RL-SIG, U-SIGN, and UHR-SIG). For example, the legacy portion of the preamble may be any portion of the preamble prior to UHR-STF. For a 480 MHz PPDU, similarly to 320 MHz PPDUs, the phase rotation pattern for 480 MHz is shown in equation 1, where 41 to 45 are implementation dependent per 80 MHz frequency subblock rotation coefficient with a value of +1 and −1. Similarly, for a 640 MHz PPDU, the phase rotation pattern for 640 MHz is shown in equation 1, where (1 to 45 are implementation dependent per 80 MHz frequency subblock rotation coefficient with a value of +1 and −1.

$${γ}_{k , 480} = \{ \begin{matrix}1 , & k < - 704 \\ - 1 , & - 704 \leq k < - 512 \\ {φ}_{1} , & - 512 \leq k < - 448 \\ - {φ}_{1} , & - 448 \leq k < - 256 \\ {φ}_{2} , & - 256 \leq k < - 192 \\ - {φ}_{2} , & - 192 \leq k < 0 \\ {φ}_{3} , & 0 \leq k < 64 \\ - {φ}_{3} , & 64 \leq k < 256 \\ {φ}_{4} , & 256 \leq k < 320 \\ - {φ}_{4} , & 320 \leq k < 512 \\ {φ}_{5} , & 512 \leq k < 576 \\ - {φ}_{5} , & 576 \leq k\end{matrix} \qquad ( 1 )$$

$${γ}_{k , 480} = \{ \begin{matrix}1 , & k < - 960 \\ - 1 , & - 960 \leq k < - 768 \\ {φ}_{1} , & - 768 \leq k < - 704 \\ - {φ}_{1} , & - 704 \leq k < - 512 \\ {φ}_{2} , & - 512 \leq k < - 448 \\ - {φ}_{2} , & - 448 \leq k < - 256 \\ {φ}_{3} , & - 256 \leq k < - 192 \\ - {φ}_{3} , & - 192 \leq k < 0 \\ {φ}_{4} , & 0 \leq k < 64 \\ - {φ}_{4} , & 64 \leq k < 256 \\ {φ}_{5} , & 256 \leq k < 320 \\ - {φ}_{5} , & 320 \leq k < 512 \\ {φ}_{6} , & 512 \leq k < 576 \\ - {φ}_{6} , & 576 \leq k < 768 \\ {φ}_{7} , & 768 \leq k < 832 \\ - {φ}_{7} , & 832 \leq k\end{matrix} \qquad ( 2 )$$

In EHT, 80 MHz, 160 MHz, and 320 MHz PPDUs support EHT duplication (DUP) mode. EHT DUP mode is applicable in conjunction with binary phase shift keying (BPSK) dual carrier modulation (DCM), rate 1/2 low density parity check coding and Nss=1. For a 480 MHz MU PPDU transmitted in the DUP mode, the lower frequency 3×996-tone RU may be encoded and modulated, and the lower 3×996-tone RU may be duplicated to the higher 3×996-tone RU along with a phase rotation (for example, a partial sign change) to reduce PAPR. The DCM operation for the 3×996 tone RU may be the same as the DCM operation for the 3×996 tone RU described in EHT. The phase rotation may be one phase rotation for each 40 MHz (half of the 996-tone RU) (for example, [e^{jθ}^{₁}, e^{jθ}^{₂}, e^{jθ}^{₃}, e^{jθ}^{₄}, e^{jθ}^{₅}, e^{jθ}^{₆}, e^{jθ}^{₇}, e^{jθ}^{₈}, e^{jθ}^{₉}, e^{jθ}^{₁₀}, e^{jθ}^{₁₁}, e^{jθ}^{₁₂}] which corresponds to [1 1 1 1 1 1 −1 −1 −1 1 1 1]). As another example, the phase rotation may be one phase rotation for each 80 MHz (996-tone RU) (for example, [e^{jθ}^{₁}, e^{jθ}^{₂}, e^{jθ}^{₃}, e^{jθ}^{₄}, e^{jθ}^{₅}, e^{jθ}^{₆}] which corresponds to [1 1 1 −1 −1 1] or [1 1 1 −1 1 1]) for six 80 MHz frequency subblocks in the 480 MHz bandwidth. For a 640 MHz MU PPDU transmitted in the DUP mode, the lower frequency 4×996-tone RU may be encoded and modulated, and the lower 4×996-tone RU may be duplicated to the higher 4×996-tone RU along with a phase rotation (for example, a partial sign change) to reduce PAPR. The DCM operation for the 4×996 tone RU may be the same as the DCM operation for the 4×996 tone RU described in EHT. The phase rotation may be one phase rotation for each 80 MHz (or 996-tone RU) (for example, [e^{jθ}^{₁}), e^{jθ}^{₂}, e^{jθ}^{₃}, e^{jθ}^{₄}, e^{jθ}^{₅}, e^{jθ}^{₆}, e^{jθ}^{₇}, e^{jθ}^{₈}] which corresponds to [1 1 1 1 −1 −1 1 1]).

The wireless communications device 602-a may apply a transmission mask (also referred to as a spectral mask) to transmission of the PPDU 606. For a 480 MHz transmission mask, Table 9 shows transmission masks that may be applied to the transmission of a PPDU 606. For a 640 MHz transmission mask, Table 10 shows transmission masks that may be applied to the transmission of a PPDU 606.

TABLE 9

| | | | 480 MHz non-HT | | | |
|---|---|---|---|---|---|---|
| BW | 480 MHz PPDU | | Duplicate PPDU | | | |
| (MHz) | 0 dBr | −20 dBr | 0 dBr | −20 dBr | −28 dBr | −40 dBr |
| 480 | ±239.5 | ±240.5 | ±239 | ±241 | ±480 | ±720 |

TABLE 10

| | | | 640 MHz non-HT | | | |
|---|---|---|---|---|---|---|
| BW | 640 MHz PPDU | | Duplicate PPDU | | | −40dBr |
| (MHz) | 0 dBr | −20 dBr | 0 dBr | −20 dBr | −28 dBr | 0 dBr |
| 640 | ±319.5 | ±320.5 | ±319 | ±320 | ±640 | ±960 |

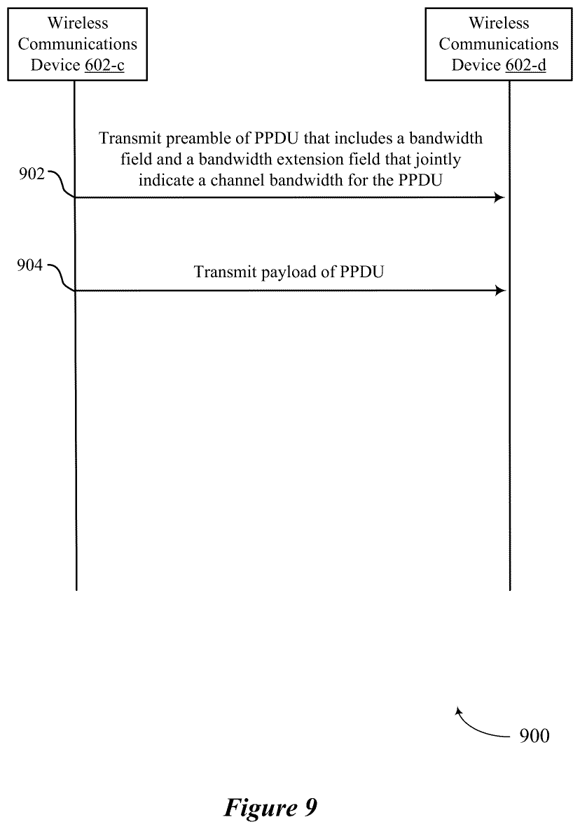

FIG. 7 shows an example of a channelization diagram 700 that supports techniques for 480 and 640 MHz channel bandwidth transmissions in Wi-Fi. The channelization diagram 700 may implement or may be implemented by aspects of the wireless communication network 100 or the signaling diagram 600.

In UHR wireless communications systems, some STAs 104 may be limited to 160 MHz operation, some STAs 104 may be limited to 320 MHz operation, and some STAs 104 may be capable of 480 MHz and/or 640 MHz operation. Channel utility may depend on channel operation. UHR may depend on STAs 104 capable of using 480 MHz operation to use the 480 MHz channel bandwidth. A 320 MHz channel bandwidth may be declared to 320 MHz EHT STAs 104, which be considered by EHT STAs 104 as the EHT 320 MHz channel (E320). As shown in the first example channelization diagram 705 and the second example channelization diagram 710, E320 may include a primary 160 MHz subband (P160) and a secondary 160 MHz subband (S160). As shown in the first example channelization diagram 705 and the second example channelization diagram 710, a 480 MHz contiguous channel bandwidth may be a 320 MHz channel bandwidth (E320) with an additional secondary or tertiary 160 MHz subband (for example, T160).

As shown in the first example channelization diagram 705, in some examples, the primary 160 MHz subband may be any one of the 160 MHz subbands of a 480 MHz channel. In such examples, a STA 104 that is not capable of 480 MHz operation may perform up to 320 MHz channel bandwidth transmission or reception in E320 (for example, 320-X). If some channel in S160 within E320 (for example, 160-b) is not available, the STA 104 may fall back to 160 MHz channel bandwidth transmission or reception in P160.

As shown in the second example channelization diagram 710, in some examples, the primary 160 MHz subband may always be the center 160 subband of the 480 MHz channel. In such examples, two different 320 MHz channels could be formed within the 480 MHz channel, 320-X and 320-Y as shown in the second example channelization diagram 710. 320 MHz limited STAs 104 may be divided into two groups, where some transmit or receive in 320-X and some transmit or receive in 320-Y. In the scenario shown in the second example channelization diagram 710, there may be more opportunities for 480 MHz channel bandwidth OFDMA transmission or reception than in the scenario shown in the first example channelization diagram 705.

In the scenario where the primary 160 MHz subband is always the center 160 subband, there may be multiple options for the determination of which 320 MHz channel (for example, 320-X or 320-Y) to use for 320 MHz limited STAs 104. In a first option, the AP 102 may assign, at association, each 320 MHz limited non-AP STA 104 to one of the 320 MHz channels (for example, 320-X or 320-Y). The assignment may be static, or the assignment may be semi-static if the AP 102 reassigns the 320 MHz channel after a period of time. In a second option, a non-AP STA 104 may inform the AP 102 of the operating 320 MHz channel of the non-AP STA 104 semi-statically, and the AP 102 may provide suggested 320 MHz channels to the non-AP STA 104. In downlink and uplink transmissions, the AP 102 may assign RUs or MRUs to the 320 MHz limited non-AP STAs 104 within the assigned 320 MHz channels.

In P2P communications, where both In-BSS non-AP STAs 104 are 320 MHz limited and the P2P handshaking goes through the AP 102 in 802.11 TDLS, there may be multiple options for the determination of which 320 MHz channel (for example, 320-X or 320-Y) to use for 320 MHz limited STAs 104 when the primary 160 MHz subband is always the center 160 subband. In a first option (for example, a static or semi-static blind option), each 320 MHz limited non-AP STA 104 does not know the 320 MHz channel assigned to the other STAs 104. In the first option, the P2P transmission may utilize P160. The first option may be simple to implement but may limit peak throughput as channel bandwidth is limited to 160 MHz for P2P transmission. In a second option (for example, a static or semi-static non-blind option), in the initial transmission which utilizes P160, a first 320 MHz limited non-AP STA 104 may inform a second STA 104 of the operating 320 MHz channel of the first 320 MHz limited non-AP STA 104. If the second non-AP STA 104 is operating in the same indicated 320 MHz channel as the first 320 MHz limited non-AP STA 104, the second 320 MHz limited non-AP STA 104 may utilize the indicated 320 MHz channel for the next transmission with the first 320 MHz limited non-AP STA 104, otherwise the second 320 MHz limited non-AP STA 104 may utilize P160 for the next transmission with the first 320 MHz limited non-AP STA 104. A PPDU with 160 MHz channel bandwidth may indicate the PPDU bandwidth (160 MHz) in U-SIG, and may also indicate the 320 MHz operating channel of the STA 104 (for example, via 1 bit in U-SIG). The second option may enable P2P communications to use 320 MHz, thereby increasing peak throughput as compared to the first option. In a third option (for example, a dynamic non-blind option), if first and second non-AP STAs 104 are operating in different 320 MHz channels, one may move to the other 320 MHz channel so that the P2P communications may use the 320 MHz channel bandwidth. In some examples, if the AP 102 determines the operating 320 MHz channels of the first and second non-AP STAs 104, the AP 102 may reassign the operating 320 MHz channel of one of the first and second non-AP STAs 104 so that the first and second non-AP STAs 104 operate in the same 320 MHz channel. In some examples, if a first non-AP STA 104 determines the operating 320 MHz channel of the second non-AP STA 104 after handshaking, the first non-AP STA 104 may determine to switch to the 320 MHz channel of the second non-AP STA 104 in order to use the same 320 MHz channel in order to enable 320 MHz P2P communications. The third option may enable P2P communications to use 320 MHz even when the non-AP STAs 104 are assigned to different 320 MHz channels, thereby increasing peak throughput.

As described with reference to FIG. 6, the preamble 608 of a PPDU 606 may include a bandwidth field and a bandwidth extension field in the U-SIG field which jointly (for example, in combination together) indicate a channel bandwidth for the PPDU 606. In some examples, the bandwidth field and the bandwidth extension field may indicate the 480 MHz channel as a 320 MHz channel with an additional 160 MHz subband (for example, referred to as a “320+160” option). In the “320+160” option, the bandwidth field and the bandwidth extension field may have relative and different indications in different 160 MHz subbands of the 480 MHz channel bandwidth. For example, as shown in the second example channelization diagram 710, two combinations of 320 MHz+160 MHz could uniquely determine one 480 MHz channel (for example, 320-X plus U160 or 320-Y plus L160). In each 160 MHz subband, the bandwidth field may indicate a nominal 320 MHz channelization (for example, 320 MHz-1 or 320 MHz-2) that overlaps with the 160 MHz subband, and the two bit bandwidth extension field may indicate the existence and location of the additional 160 MHz to form the 480 MHz PPDU channel bandwidth. For example, one bit of the two bit bandwidth extension field may indicate whether the channel bandwidth is 320 or 480 MHz (for example, a “320/480” indication bit, and one bit of the two bit bandwidth extension field may indicate, if the channel bandwidth is 480 MHz, whether the 160 MHz is the immediate 160 MHz of lower or higher frequency with respect to the nominal 320 MHz channel (for example, a “U160/L160” indication bit, where “U160” refers to a 160 MHz frequency block above the nominal 320 MHz channel and “L160” refers to a 160 MHz frequency block below the nominal 320 MHz channel). UHR STAs 104 may understand the 480 MHz signaling indicated by the bandwidth field and the bandwidth extension field, and EHT STAs 104 may interpret the signaling indicated by the bandwidth field as a 320 MHz channel bandwidth and treat the bandwidth extension field as disregard. As described herein and shown in Table 11, the signaling in the bandwidth field and the bandwidth extension field is different for the 160-A subband and the 160-C subband. The signaling in the bandwidth field and the bandwidth extension field for the 160-B subband may depend on what to show an EHT STA 104. The “320+160” option may leave at least one reserved value in the bandwidth field, and EHT STAs 104 may recognize the 320 MHz channel as indicated in the bandwidth field. The “320+160” option may be used for channel operation related signaling.

In some examples, the bandwidth field and the bandwidth extension field may indicate the 480 MHz channel bandwidth as a 160 MHz channel bandwidth with an additional 320 MHz channel bandwidth (for example, referred to as “which 160” option). In the “which 160” option, the value of bandwidth field may be the same (for example, unified) in each 160 MHz subband (for example, 160-A, 160-B, and 160-C), and the value of the two bit bandwidth extension field may be relative and different in each 160 MHz subband. For example, the bandwidth field may indicate a 160 MHz channel bandwidth, and the two bit bandwidth extension field may indicate “just 160 MHz” (which means the PPDU is a 160 MHz PPDU instead of a 480 MHz PPDU), “lowest 160 MHz in 480 MHz”, “middle 160 MHz in 480 MHz” or “highest 160 MHz in 480 MHz”. UHR STAs 104 may understand the 480 MHz signaling indicated by the bandwidth field and the bandwidth extension field, and EHT STAs 104 may interpret the signaling indicated by the bandwidth field as a 160 MHz channel bandwidth and treat the bandwidth extension field as disregard.

TABLE 11

| | | “320+160” Option | “Which 160” |
|---|---|---|---|
| Subband | Field | field value | Option field value |
| 160-A | Bandwidth field | 320-X | 160 |
| 160-A | Bandwidth | “320/480” bit = 480 | lowest 160 in 480 |
| | extension field | and “U160/L160” | |
| | | bit = U160 | |
| 160-B | Bandwidth field | 320-X | 160 |
| 160-B | Bandwidth | “320/480” bit = 480 | middle 160 in 480 |
| | extension field | and “U160/L160” | |
| | | bit = U160 | |
| 160-C | Bandwidth field | 320-Y | 160 |
| 160-C | Bandwidth | “320/480” bit = 480 | highest 160 in 480 |
| | extension field | and “U160/L160” | |
| | | bit = L160 | |

In some examples, in a 20, 40, 80, or 160 MHz PPDU, when the “uplink/downlink” bit is set to 0 (to indicate a transmission not addressed to an AP 102), and the PPDU indicates transmission to a single STA (for example, the PPDU Type And Compression Mode field is set to 1, the EHT-SIG MCS field and the Number Of EHT-SIG Symbols field are not both set to 0) the PPDU is a transmission addressed to a single non-AP STA 104. In such examples, the bandwidth field may indicate the PPDU channel bandwidth, and the bandwidth extension field may indicate the operating 320 MHz channel (for example, 320 MHz-1 and 320 MHz-2, leaving unused values set to Validate). If the transmitter device of the PPDU is a 480 MHz capable AP 102 or non-AP STA 104, the bandwidth extension field may be set to the operating 320 MHz channel of the receiver non-AP STA 104, if the receiver non-AP STA 104 is 320 MHz limited. If the transmitter device of the PPDU is a 320 MHz limited AP 102 or non-AP STA 104, the bandwidth extension field may be set to the operating 320 MHz channel of the transmitter non-AP STA 104.

In some examples, as described with reference to FIG. 6, U-SIG of the preamble 608 of a PPDU may include spatial reuse fields. As shown in Table 12 below, in some examples, the spatial reuse field design may be EHT like, and may include two spatial reuse fields. In some examples, spatial reuse field design may depend on the PPDU channel bandwidth signaling method (for example, indicating a 480 MHz channelization as described with reference to FIG. 6 (referred to as “480-X”), the “320+160” option, or the “which 160” option). In such examples, more spatial reuse fields (for example, more than 2 fields) may be used. As shown in Table 12, each spatial reuse field may indicate spatial reuse information of different bandwidth portions in the different design options. In the “which 160” option “remaining 320 MHz” refers to the remaining total bandwidth (320 MHz) in the 480 MHz but outsider of the bandwidth as indicated in the Bandwidth field (the indicated 160 MHz).

TABLE 12

| | Opt. 1 | | | |
|---|---|---|---|---|
| PPDU BW | (EHT | Opt. 2 (Increased Fields) | | |
| Signaling | Like) | “480-X” | “320 + 160” | “Which 160” |
| Type | Any | Option | Option | Option |
| Spatial Reuse | Lower | Lower | Lower 160 MHz | Lower 80 MHz |
| 1 (SR1) field | 240 | 160 | of the 320 MHz | of the 160 MHz |
| | MHz | MHz | channelization | channelization |
| | | | indicated in | indicated in |
| | | | Bandwidth field | Bandwidth field |
| Spatial Reuse | Upper | Middle | Upper 160 MHz | Upper 80 MHz |
| 2 (SR2) field | 240 | 160 | of the 320 MHz | of the 160 MHz |
| | MHz | MHz | channelization | channelization |
| | | | indicated in | indicated in |
| | | | Bandwidth field | Bandwidth field |
| Spatial Reuse | N/A | Upper | Remining | Lower 160 MHz |
| 3 (SR3) field | | 160 | 160 MHz | of the remaining |
| | | MHz | | 320 MHz |
| Spatial Reuse | N/A | N/A | N/A | Upper 160 MHz |
| 4 (SR4) field | | | | of the remaining |
| | | | | 320 MHz |
| Content | No | No | Yes | Yes |
| Variation in | | | | |
| signaling in | | | | |
| Different 160 | | | | |
| MHz | | | | |
| EHT STA | No | No | Yes for the | Yes for the 160 |
| understanding | | | 320 MHz | MHz |
| of SR1 and | | | channelization | channelization |
| SR2 | | | indicated in | indicated in |
| | | | Bandwidth field | Bandwidth field |

As described with reference to FIG. 6, the preamble 608 may include an EHT-SIG (for example, the EHT-SIG 368 of FIG. 3a) that indicates RU allocation. For UHR, the preamble 608 may include a UHR-SIG which includes an RU allocation subfield. In some examples, the RU allocation subfield in UHR-SIG may use the EHT design, which may include a 9 bit RU allocation subfield. In such examples, 1+8=9 values may be set to “Validate,” 26×8 values may be set to Disregard, and 50 values may be used to indicate RUs or MRUs whose sizes are smaller than a 242-tone RU. To add one new MRU, 8 values may be used to indicate from 1 to 8 user fields, and thus the values set to Disregard could be repurposed for up to 26 new MRUs, each with 1 to 8 user fields. The 480 MHz tone plan may be a duplicate of six 80 MHz EHT tone plans, one in each 80 MHz frequency subblock. In some examples, MRUs of size<2×996 may not cross 160 MHz channel boundaries (for example, as in EHT). In some examples, MRUs of size<4×996 may not cross 320 MHz channel boundaries (for example, as in EHT). MRUs with size greater than or equal to 4×996 (total 33 MRUs) may have potential sizes of a 4×996 MRU (3 MRUs if formed by 2×996 RUs), a 4×996+484-tone MRU (12 MRUs if formed by two 2×996-tone RUs and one 484-tone RU), a 5×996-tone MRU (6 MRUs), or a 5×996+484-tone MRU (12 MRUs).

In examples where the RU allocation subfield in UHR-SIG may use the EHT design, UHR-SIG may reuse the EHT table and add the new MRUs. Reusing the EHT table with the addition of the new MRUs may enable EHT STAs 104 to understand how many user fields to skip for existing channel bandwidth signaling. Reusing the EHT table with the addition of the new MRUs may result in high bit overhead (for example, in each content channel, 9×12=108 bits may be used). In a channel bandwidth independent RU allocation subfield suboption, the values set to Disregard may be repurposed to add up to 26 new MRUs (for example, 4×996-tone MRU (3 MRUs), 5×996-tone MRU (6 MRUs), 5×996+484-tone MRU (12 MRUs)). The bandwidth independent RU allocation subfield suboption may not support all new MRUs sizes (for example, a 4×996+484-tone MRUs or MRUs of other new sizes). In a channel bandwidth dependent RU allocation subfield suboption, the EHT table may be used for existing channel bandwidths, and the 9 bit table may be redesigned for 480 MHz. Assuming a minimum RU size in 480 MHz OFDMA is a 242-tone RU, the 50 values for smaller RUs or MRUs of size<242, and Disregard and/or Validate values may be repurposed for the total of 33 new MRUs described herein. The first option that reuses the EHT table may be used for multiplexing EHT STAs 104 (for example, 320 MHz limited EHT STAs 104) in 480 MHz transmission. Other RU allocation subfield option with less signaling overhead than the first option may be used. Whether to use the first option that reuses the EHT table may accordingly involve a trade-off between backwards compatibility with EHT devices and lower signaling overhead.

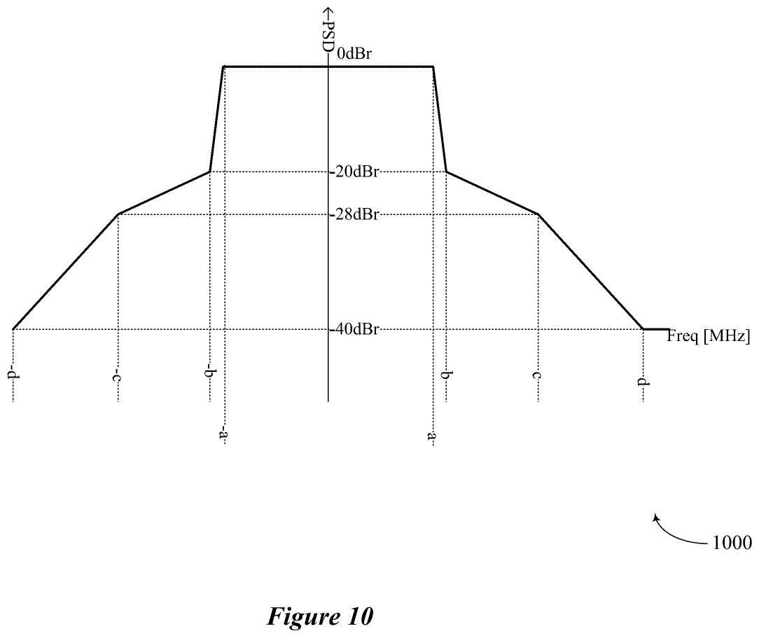

A second UHR-SIG RU allocation subfield design option may be referred to as a compression mode for 480 MHz. The compression mode for 480 MHz UHR-SIG RU allocation subfield design option is described herein with respect to FIG. 8.

A third UHR-SIG RU allocation subfield design option may be referred to as a per RU indication option. In some examples, there may be a small number of users in OFDMA. In such examples, the RU allocation table may not be used, and the RU assignment field in each user information field may be used. The user information field for both MU-MIMO and non-MU-MIMO may be unified. In the per RU indication option, 9 additional bits may be used. 4 bits may be used to indicate the number of spatial streams (Nss) and 4 bits may be used to indicate the start stream index of the user, with no explicit indication of the total Nss across different users if one RU or MRU is assigned for MU-MIMO transmission to multiple users. In some examples, up to 6 bits may be used to indicate up to 64 (M) RU assignments. Assuming a minimum RU size in 480 MHz OFDMA is a 242-tone RU, the 6 bits may be used to indicate 242-tone RU assignment (total 4×6=24 242-tone RUs in 480 MHz), a 484-tone RU assignment (total 2×6=12 484-tone RUs in 480 MHz), a 996-tone RU assignment (total 6 996-tone RUs in 480 MHz), a 2×996-tone RU assignment (total 3 2×996-tone RUs in 480 MHz), a 3×996-tone RU assignment (total 8 3×996-tone MRUs in 480 MHz), a 4×996-tone RU assignment (total 3 4×996-tone RUs in 480 MHz), or a 5×996-tone RU assignment (total 6 5×996-tone MRUs in 480 MHz). The additional 9 bits in the user information field accordingly is 4 (start stream index)+6 (RU assignment)-1 (reserved bit)=9 bits. If there are 24 users in OFDMA (for example, 12 user info fields in each content channel due to parallelization), the per RU indication option may have the same signaling overhead as the UHR-SIG RU allocation subfield design option that uses a 9-bit table for each 20 MHz. If there are less than 24 users in OFDMA, the per RU indication option may reduce signaling overhead as compared to the UHR-SIG RU allocation subfield design option that uses a 9-bit table for each 20 MHz.

As described herein, in UHR wireless communications systems, UHR 480 MHz capable STAs 104, UHR 320 MHz limited STAs 104, EHT 320 MHz capable STAs, and EHT smaller channel bandwidth limited STAs may coexist. UHR 320 MHz limited STAs may be multiplexed into 480 MHz OFDMA transmission. In some examples, EHT STAs also may be multiplexed into UHR 480 MHz OFDMA transmission.

When multiplexing EHT STAs into UHR 320 MHz OFDMA transmission, the PHY version identifier may be set to “EHT” and a disregard bit in U-SIG may be set to indicate “UHR” (which may be consistent (in the entire channel bandwidth) or subband variant (only in 80 MHz subbands where EHT STAs 104 are parked)). When multiplexing EHT STAs into UHR 320 MHz OFDMA transmission, the bandwidth field may be set to an existing channel bandwidth value (for example, 320 MHz-1), the UHR-SIG field structure and interpretation of Common field and User Specific field may be the same as EHT-SIG for the PPDU channel bandwidth as indicated in the bandwidth field, the RU allocation subfield may use the 9-bit EHT compatible design for existing channel bandwidth values, and the user information field may be the same size of 22 bits.

If EHT STAs 104 and UHR STAs 104 are capable of parking on different 160 MHz subbands through Subchannel Selective Transmission (SST), several potential methods may be used to serve both EHT and UHR STAs in different 160 MHz subbands. One method may involve the use of a multi-generation frequency domain aggregated PPDU (FD-A-PPDU), where EHTs STAs may be served in the P160 and the UHR STAs 104 may be served in the remaining 320 MHz. In some cases, EHT STAs 104 and UHR STAs 104 may park on primary channels. To multiplex EHT STAs 104 in UHR 480 MHz OFDMA transmission, the UHR 480 MHz PPDU may be disguised to EHT STAs 104 as an EHT 320 MHz PPDU. In such examples, the 320+160 PPDU channel bandwidth signaling option may be used, and in the subbands where the EHT STAs 104 are parked, the E320 may be indicated in the bandwidth field (the additional 160 MHz may be understood by UHR STAs 104 but not EHT STAs 104). In such examples, the UHR-SIG field may be changed to inherit the EHT-SIG structure of 320 MHz. In such examples, the RU allocation subfield in UHR-SIG may use the EHT compatible design described herein for the E320 for EHT STAs 104 to understand, and either the channel bandwidth independent or channel bandwidth dependent RU allocation subfield design may be used in the remaining 160 MHz for UHR STAs 104.

The UHR-SIG field may be designed accordingly to several options. In a first example (for example, option 1), the design of UHR-SIG may be EHT like. In the first example, the same structure of one common field followed by one user specific field may be used. The detailed UHR-SIG field structure and size may depend on the RU allocation subfield design option. For example, assuming the EHT compatible 9 bit RU allocation subfield for each 20 MHz, in each content channel the 480 MHz channel bandwidth uses 12 total RU allocation subfields, one for each 20 MHz. Accordingly 3 code blocks are used, one for U-SIG overflow fields and 2 RU allocation-A subfields, one for 6 RU allocation-B subfields, and one for 4 RU allocation-C subfields. EHT STAs 104 may not understand the 12 RU allocation subfields in the option 1 design.

In a second example (for example, option 2), the design of UHR-SIG may be EHT compatible. The signaling may be split into 320 MHz and 160 MHz, and two sets of common fields and user specific fields may be sequential. The first set of common field and user specific field correspond to the EHT 320 MHz (E320), and the second set of common field and user field correspond to the remaining 160 MHz subband. The channel bandwidth independent RU allocation suboption design may be used in E320, and either the channel bandwidth independent RU allocation suboption design or the channel bandwidth dependent RU allocation suboption design may be used in the remaining 160 MHz. The number of UHR-SIG symbols in U-SIG may be set to the length of the entire UHR-SIG so that both EHT STAs 104 and UHR STAs 104 may know the location of the UHR-STF correctly. The second option carries the same information as the first option (if using the same RU allocation subfield design option), but the fields are reordered, such that the EHT-SIG structure for the EHT 320 MHz is inherited, and may be understood by an EHT STA 104. For example, Table 13 shows an example structure of a 320 MHz EHT-SIG field, Table 14 shows an example structure of a 480 MHz UHR-SIG field in accordance with option 1, and Table 15 shows an example structure of a 480 MHz UHR-SIG field in accordance with option 2. As shown in Table 15, the structure of the common and user specific fields for the 320 MHz subband of the 480 MHz channel bandwidth is the same as the structure of the common and user specific fields for a 320 MHz EHT-SIG field as shown in Table 13. In Tables 13, 14, and 15 RUA refers to RU allocation subfields for the given subchannel, and UI refers to user info fields for the given subchannel.

TABLE 13

| Common Field | | | User Specific Field | |
|---|---|---|---|---|
| U-SIG | RUA (160-A) | RUA (160-B) | UI (160-A) | UI (160-B) |
| Overflow | | | | |

TABLE 14

| Common field | | | | User Specific field | | |
|---|---|---|---|---|---|---|
| U-SIG | RUA | RUA | RUA | UI | UI | UI |
| Overflow | (160-A) | (160-B) | (160-C) | (160-A) | (160-B) | (160-C) |

TABLE 15

| | | | | | | User |
|---|---|---|---|---|---|---|
| | | | User Specific | | Common | Specific |
| Common (320-X) | | | (320-X) | | (U160) | (U160) |
| U-SIG | RUA | RUA | UI | UI | RUA | UI |
| Overflow | (160-A) | (160-B) | (160-A) | (160-B) | (160-C) | (160-C) |

For example, the U-SIG may indicate the PHY version identifier field, which may indicate EHT, the bandwidth field, which may indicate 320-X, the bandwidth extension field, which may indicate U160, and the number of UHR-SIG symbols, which may indicate the quantity of UHR-SIG symbols. The Common 320-X field may indicate the RU allocation subfields for the 320-X channel, the user specific 320-X field may indicate UHR user information for the 320-X channel. The common U160 field may indicate the RU allocation subfields for the remaining 160 MHz channel, and the user specific field U160 may indicate the UHR user information for the remaining 160 MHz channel. An EHT STA 104 may process the common and user specific field for E320 of a 480 MHz UHR-SIG field. Specifically, an EHT STA 104 may process the PHY version identifier field, the bandwidth field, and the number of UHR-SIG symbols field in U-SIG, the RU allocation subfields in the common 320-X field, and the EHT user information in the user specific 320-X field. In some aspects, the designs described with reference to a 480 MHz PPDU with respect to FIG. 7 may be applied to a 640 MHz PPDU.

FIG. 8 shows an example of a RU allocation diagram 800 that supports techniques for 480 and 640 MHz transmission in Wi-Fi. The RU allocation diagram 800 may implement or may be implemented by aspects of the wireless communication network 100 or the signaling diagram 600.

As described herein, a second UHR-SIG RU allocation subfield design option may be referred to as a compression mode for 480 MHz. In UHR, most bandwidth limited STAs 104 (for example, 320 MHz limited STAs 104) may receive or transmit in primary channels, and therefore it may be efficient to keep current OFDMA (M) RU resolution for P160. Fewer STAs 104 may transmit or receive in the remaining 320 MHz, so a larger OFDMA (M) RU may be used in the remaining 320 MHz. Accordingly, in the compression mode for 480 MHz, RU allocation signaling may be reordered to start with P160 followed by the remaining 320 MHz. The 9 bit EHT table may be reused for each 20 MHz in the P160, and an 8 bit table may be used for each 80 MHz of the remaining 320 MHz, as shown in the first example RU allocation diagram 805, the second example RU allocation diagram 810, and the third example RU allocation diagram 815. In some examples, the OFDMA (M) RUs inside of and partially overlapping the remaining 320 MHz may be limited to sizes of N×996, N=1, . . . , 5 (for example, 996-tone RU (1 such RU in one 80 MHz frequency subblock), 2×996-tone RU (1 such RU overlapping one 80 MHz frequency subblock), 3×996-tone MRU (8 such MRUs overlapping one 80 MHz frequency subblock, with 4 in each contiguous 320 MHz), 4×996-tone RU (2 such RUs overlapping one 80 MHz frequency subblock or simply using 3 values to indicate total 3 4×996 RUs in 480 MHz), 5×996-tone MRU (4 such MRUs overlapping one 80 MHz frequency subblock or simply using 6 values to indicate total 6 5×996-tone MRUs in 480 MHz), 996-tone RU punctured, and 996-tone RU unassigned). In the compression mode option for 480 MHz UHR-SIG RU allocation subfield design, each content channel may include 9×4+8×2=52 bits, which is less than the 320 MHz RU allocation signaling overhead.

The first example RU allocation diagram 805 shows a scenario where P160 is the lowest 160 MHz subband of the 480 MHz channel bandwidth. The second example RU allocation diagram 810 shows a scenario where P160 is the middle 160 MHz subband of the 480 MHz channel bandwidth. The third example RU allocation diagram 815 shows a scenario where P160 is the highest 160 MHz subband of the 480 MHz channel bandwidth.

In some aspects, the designs described with reference to a 480 MHz PPDU with respect to FIG. 8 may be applied to a 640 MHz PPDU.

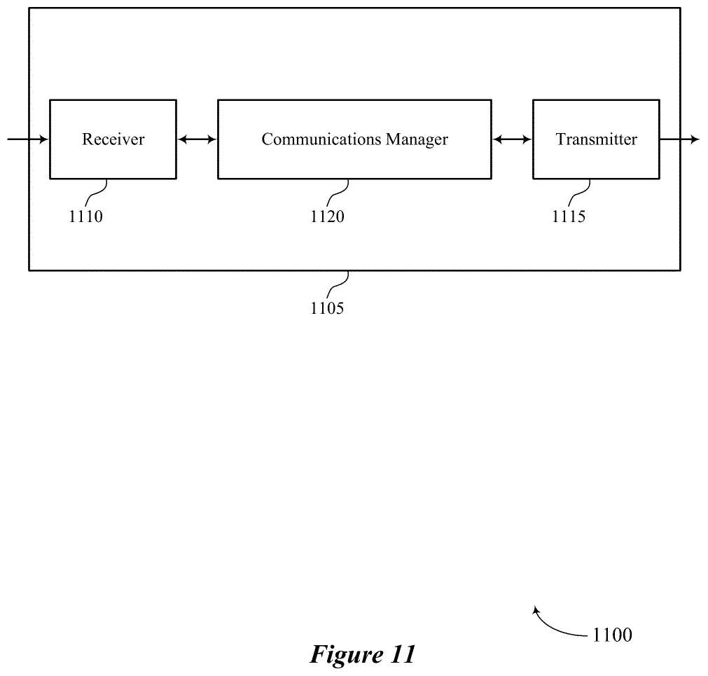

FIG. 9 shows an example of a process flow 900 that supports techniques for 480 and 640 MHz transmission in Wi-Fi. The process flow includes a first wireless communications device 602-c and a second wireless communications device 602-d, which may be examples of wireless communications devices 602 as described herein. For example, the first wireless communications device 602-c may be an AP 102 or a STA 104 as described herein, and the second wireless communications device 602-d may be an AP 102 or a STA 104 as described herein. In the following description of the process flow 900, the operations between the first wireless communications device 602-c and the second wireless communications device 602-d may be transmitted in a different order than the example order shown, or the operations performed by the first wireless communications device 602-c and the second wireless communications device 602-d may be performed in different orders or at different times. Some operations also may be omitted from the process flow 900, and other operations may be added to the process flow 900.

At 902, the first wireless communications device 602-c may transmit, to the second wireless communications device 602-d, a preamble of a PPDU. The preamble may include a U-SIG field, and the U-SIG field may include a bandwidth field and a bandwidth extension field that jointly (for example, in combination together) indicate a channel bandwidth for the PPDU. The indicated channel bandwidth may be one of a 480 MHz contiguous channel bandwidth or a 640 MHz contiguous channel bandwidth.

At 904, the first wireless communications device 602-c may transmit, to the second wireless communications device 602-d, a payload of the PPDU using the indicated channel bandwidth.

In some aspects, a first set of values of the bandwidth field indicate a corresponding set of channel bandwidths other than 480 MHz or 640 MHz, a second set of values of the bandwidth field indicates 480 MHz bandwidth operation or 640 MHz bandwidth operation, and the second set of values in combination with the bandwidth extension field indicates the 480 MHz contiguous channel bandwidth or the 640 MHz contiguous channel bandwidth.

In some aspects, within a first subband of the 480 MHz contiguous channel bandwidth or the 640 MHz contiguous channel bandwidth, the bandwidth field indicates a first value and the bandwidth extension field indicates a second value, within a second subband of the 480 MHz contiguous channel bandwidth or the 640 MHz contiguous channel bandwidth, the bandwidth field indicates a third value and the bandwidth extension field indicates a fourth value, where the first value is different from the third value and the second value is different from the fourth value. For example, the bandwidth field and extension fields may indicate different values within different 160 MHz portions of a 480 MHz or 640 MHz channel bandwidth.

In some aspects, the first wireless communications device 602-c may transmit the preamble and the payload in accordance with a tone plan. The tone plan may be one of: a set of multiple EHT 80 MHz tone plans across the 480 MHz contiguous channel bandwidth or the 640 MHz contiguous channel bandwidth; six 996 tone RUs for the 480 MHz contiguous channel bandwidth; a 6×996 tone RU for the 480 MHz contiguous channel bandwidth; 4×996 tone MRUs for the 480 MHz contiguous channel bandwidth; 4×996+484 tone MRUs for the 480 MHz contiguous channel bandwidth; 4×996+484+242 tone MRUs for the 480 MHz contiguous channel bandwidth; 5×996 tone MRUs for the 480 MHz contiguous channel bandwidth; 5×996+484 tone MRUs for the 480 MHz contiguous channel bandwidth; 5×996+484+242 tone MRUs for the 480 MHz contiguous channel bandwidth; a 8×996 tone RU for the 640 MHz contiguous channel bandwidth; 4×996 tone RUs for the 640 MHz contiguous channel bandwidth; 4×996+484 tone MRUs for the 640 MHz contiguous channel bandwidth; 5×996 tone MRUs for the 640 MHz contiguous channel bandwidth; 5×996+484 tone MRUs for the 640 MHz contiguous channel bandwidth; 6×996 tone MRUs for the 640 MHz contiguous channel bandwidth; a6×996+484 tone MRUs for the 640 MHz contiguous channel bandwidth; 7×996 tone MRUs for the 640 MHz contiguous channel bandwidth; or 7×996+484 tone MRUs for the 640 MHz contiguous channel bandwidth. In some aspects, the first wireless communications device 602-c may transmit a set of multiple pilot signals based on the tone plan. In some aspects, the first wireless communications device 602-c may generate the PPDU in accordance with a segment parser, and the segment parser may be based on the tone plan. The second wireless communications device 602-d may deparse the PPDU in accordance with a segment deparser based on the tone plan.

In some aspects, the first wireless communications device 602-c may transmit an indication of a puncturing pattern for the PPDU in the preamble. In some aspects, the PPDU is a non-OFDMA PPDU and the indication of the puncturing pattern indicates one or more of no puncturing, a punctured 40 MHz bandwidth within the 480 MHz contiguous channel bandwidth or the 640 MHz contiguous channel bandwidth, a punctured 80 MHz bandwidth within the 480 MHz contiguous channel bandwidth or the 640 MHz contiguous channel bandwidth, two concurrent punctured 80 MHz bandwidths within the 480 MHz contiguous channel bandwidth or the 640 MHz contiguous channel bandwidth, or a concurrent 40 MHz bandwidth and 80 MHz bandwidth within the 480 MHz contiguous channel bandwidth or the 640 MHz contiguous channel bandwidth. In some aspects, the PPDU is an OFDMA PPDU, and the indication of the puncturing pattern indicates zero or one or two punctured 20 MHz bandwidths for each 80 MHz bandwidth within the 480 MHz contiguous channel bandwidth or the 640 MHz contiguous channel bandwidth.

In some aspects, the U-SIG field in the TB PPDU includes a set of multiple spatial reuse fields indicating spatial reuse information for each of a set of multiple 20 MHz portions of the 480 MHz contiguous channel bandwidth or the 640 MHz contiguous channel bandwidth.

In some aspects, the preamble includes an EHT-SIG field that includes a RU allocation subfield, and a quantity of entries in the RU allocation subfield is based on the indicated channel bandwidth being one of the 480 MHz contiguous channel bandwidth or the 640 MHz contiguous channel bandwidth.

In some aspects, the preamble includes a UHR STF, the UHR STF includes a set of multiple sequences within 80 MHz segments or 160 MHz segments of the 480 MHz contiguous channel bandwidth or the 640 MHz contiguous channel bandwidth, and each of the set of multiple sequences is multiplied by a different coefficient.

In some aspects, the preamble includes a UHR LTF, the UHR LTF includes a set of multiple sequences within 80 MHz segments of the 480 MHz contiguous channel bandwidth or the 640 MHz contiguous channel bandwidth, each sequence of the set of multiple sequences includes multiple parts, and each part of the multiple parts is multiplied by a different coefficient.

In some aspects, the first wireless communications device 602-c may apply a phase rotation pattern on a 80 MHz subblock basis within the 480 MHz contiguous channel bandwidth or the 640 MHz contiguous channel bandwidth.

In some aspects, the first wireless communications device 602-c may generate the PPDU in accordance with a duplication mode. For example, the first wireless communications device 602-c may generate the PPDU via encoding a lower frequency tone 3×996 MRU of the 480 MHz contiguous channel bandwidth or 4×996 RU of the 640 MHz contiguous channel bandwidth using BPSK DCM, duplicate the lower frequency tone 3×996 MRU of the 480 MHz contiguous channel bandwidth or 4×996 RU of the 640 MHz contiguous channel bandwidth onto a higher frequency tone 3×996 MRU of the 480 MHz contiguous channel bandwidth or 4×996 RU of the 640 MHz contiguous channel bandwidth, and apply a phase shift to the higher frequency tone RU.

In some aspects, the first wireless communications device 602-c may apply a spectral mask to transmission of the preamble and the payload, and if the preamble puncturing is not applied, the interim transmit spectral mask may have one of: a 0 dBr (dB relative to the maximum spectral density of the signal) bandwidth of 479 MHz, −20 dBr at 240.5 MHz frequency offset, −28 dBr at 480 MHz frequency offset, and −40 dBr at 720 MHz frequency offset for a 480 MHz PPDU, where the interim transmit spectral mask for frequency offsets in between 239.5 MHz and 240.5 MHz, 240.5 MHz and 480 MHz, and 480 MHz and 720 MHz may be linearly interpolated in decibels domain from requirements for 239.5 MHz, 240.5 MHz, 480 MHz, and 720 MHz frequency offsets; a 0 dBr bandwidth of 478 MHz, −20 dBr at 241 MHz frequency offset, −28 dBr at 480 MHz frequency offset, and −40 dBr at 720 MHz frequency offset for a 480 MHz non-high throughput duplicate PPDU, where the interim transmit spectral mask for frequency offsets in between 239 MHz and 241 MHz, 241 MHz and 480 MHz, and 480 MHz and 720 MHz may be linearly interpolated in decibels domain from requirements for 239 MHz, 241 MHz, 480 MHz, and 720 MHz frequency offsets; a 0 dBr bandwidth of 639 MHz, −20 dBr at 320.5 MHz frequency offset, −28 dBr at 640 MHz frequency offset, and −40 dBr at 960 MHz frequency offset for a 640 MHz PPDU, where the interim transmit spectral mask for frequency offsets in between 319.5 MHz and 320.5 MHz, 320.5 MHz and 640 MHz, and 640 MHz and 760 MHz may be linearly interpolated in decibels domain from the requirements for 319.5 MHz, 320.5 MHz, 640 MHz, and 960 MHz frequency offsets; a 0 dBr bandwidth of 638 MHz, −20 dBr at 320 MHz frequency offset, −28 dBr at 640 MHz frequency offset, and −40 dBr at 960 MHz frequency offset for a 640 MHz non-high throughput duplicate PPDU, where the interim transmit spectral mask for frequency offsets in between 319 MHz and 320 MHz, 320 MHz and 640 MHz, and 640 MHz and 760 MHz may be linearly interpolated in decibels domain from the requirements for 319 MHz, 320 MHz, 640 MHz, and 960 MHz frequency offsets, and where a transmit spectrum may not exceed a maximum of the interim transmit spectrum mask and −39 dBm/MHz at any frequency offset.

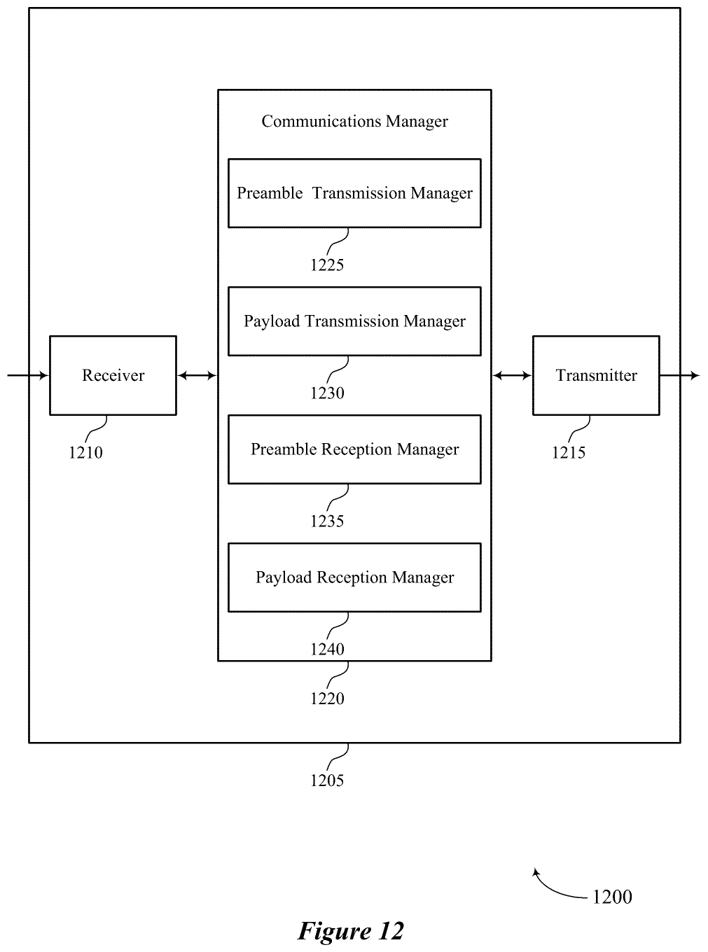

FIG. 10 shows an example of a transmit spectrum mask 1000 that may be applied to a PPDU that supports techniques for 480 and 640 MHz transmission in Wi-Fi in accordance with one or more aspects of the present disclosure.

As described herein, the first wireless communications device 602-c may apply a spectral mask to transmission of the preamble and the payload. As shown in FIG. 10, from a center frequency, if no puncturing is applied, a 0 dBr bandwidth (dB relative to the maximum spectral density of the signal) of 2a MHz, −20 dBr at b MHz frequency offset, −28 dBr at c MHz frequency offset, and −40 dBr at d MHz frequency offset.

For a 480 MHz PPDU, a=239.5 MHz (for example, a 0 dBr bandwidth of 479 MHz), b=240.5, c=480 MHz, and d=720 MHz. The interim transmit spectral mask for frequency offsets in between 239.5 MHz and 240.5 MHz, 240.5 MHz and 480 MHz, and 480 MHz and 720 MHz may be linearly interpolated in decibels domain from the requirements for 239.5 MHz, 240.5 MHz, 480 MHz, and 720 MHz frequency offsets. The transmit spectrum may not exceed the maximum of the interim transmit spectrum mask and −39 dBm/MHz at any frequency offset.

For a 480 MHz non-high throughput duplicate PPDU, a=239 MHz (for example, a 0 dBr bandwidth of 478 MHz), b=241, c=480 MHz, and d=720 MHz. The interim transmit spectral mask for frequency offsets in between 239 MHz and 241 MHz, 241 MHz and 480 MHz, and 480 MHz and 720 MHz may be linearly interpolated in decibels domain from the requirements for 239 MHz, 241 MHz, 480 MHz, and 720 MHz frequency offsets. The transmit spectrum may not exceed the maximum of the interim transmit spectrum mask and −39 dBm/MHz at any frequency offset.

For a 640 MHz PPDU, a=319.5 MHz (for example, a 0 dBr bandwidth of 639 MHz), b=320.5, c=640 MHz, and d=960 MHz. The interim transmit spectral mask for frequency offsets in between 319.5 MHz and 320.5 MHz, 320.5 MHz and 640 MHz, and 640 MHz and 760 MHz may be linearly interpolated in decibels domain from the requirements for 319.5 MHz, 320.5 MHz, 640 MHz, and 960 MHz frequency offsets. The transmit spectrum may not exceed the maximum of the interim transmit spectrum mask and −39 dBm/MHz at any frequency offset.

For a 640 MHz non-high throughput duplicate PPDU, a=319 MHz (for example, a 0 dBr bandwidth of 638 MHz), b=320, c=640 MHz, and d=960 MHz. The interim transmit spectral mask for frequency offsets in between 319 MHz and 320 MHz, 320 MHz and 640 MHz, and 640 MHz and 760 MHz may be linearly interpolated in decibels domain from the requirements for 319 MHz, 320 MHz, 640 MHz, and 960 MHz frequency offsets. The transmit spectrum may not exceed the maximum of the interim transmit spectrum mask and −39 dBm/MHz at any frequency offset.

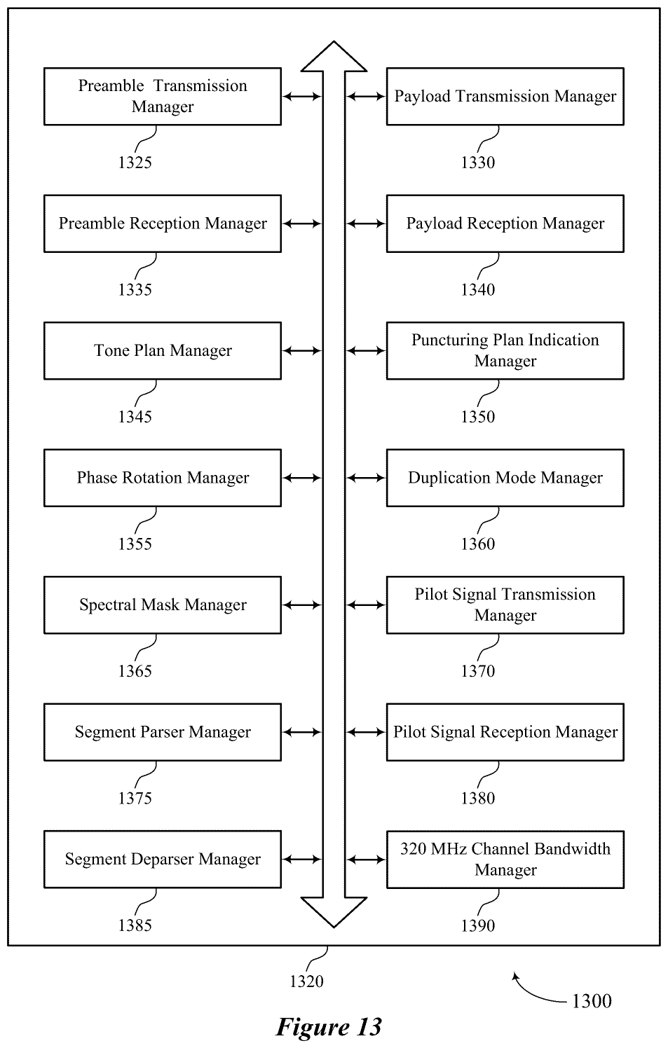

FIG. 11 shows a block diagram 1100 of a device 1105 that supports techniques for 480 and 640 MHz transmission in Wi-Fi in accordance with one or more aspects of the present disclosure. The device 1105 may be an example of aspects of an AP or a STA as described herein. The device 1105 may include a receiver 1110, a transmitter 1115, and a communications manager 1120. The device 1105, or one or more components of the device 1105 (for example, the receiver 1110, the transmitter 1115, and the communications manager 1120), may include at least one processor, which may be coupled with at least one memory, to, individually or collectively, support or enable the described techniques. Each of these components may be in communication with one another (for example, via one or more buses).

The receiver 1110 may provide a means for receiving information such as packets, user data, control information, or any combination thereof associated with various information channels (for example, control channels, data channels, information channels related to techniques for 480 and 640 MHz transmission in Wi-Fi). Information may be passed on to other components of the device 1105. The receiver 1110 may utilize a single antenna or a set of multiple antennas.

The transmitter 1115 may provide a means for transmitting signals generated by other components of the device 1105. The transmitter 1115 may utilize a single antenna or a set of multiple antennas.

The communications manager 1120, the receiver 1110, the transmitter 1115, or various combinations thereof or various components thereof may be examples of means for performing various aspects of techniques for 480 and 640 MHz transmission in Wi-Fi as described herein. For example, the communications manager 1120, the receiver 1110, the transmitter 1115, or various combinations or components thereof may be capable of performing one or more of the functions described herein.

In some aspects, the communications manager 1120, the receiver 1110, the transmitter 1115, or various combinations or components thereof may be implemented in hardware (for example, in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (for example, by one or more processors, individually or collectively, executing instructions stored in the at least one memory).

Additionally, or alternatively, the communications manager 1120, the receiver 1110, the transmitter 1115, or various combinations or components thereof may be implemented in code (for example, as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some aspects, the communications manager 1120 may be configured to perform various operations (for example, receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a wireless communications device in accordance with examples as disclosed herein. For example, the communications manager 1120 is capable of, configured to, or operable to support a means for transmitting a preamble of a PPDU, where the preamble includes a U-SIG, where the U-SIG includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth. The communications manager 1120 is capable of, configured to, or operable to support a means for transmitting a payload of the PPDU using the indicated channel bandwidth.

Additionally, or alternatively, the communications manager 1120 may support wireless communications at a wireless communications device in accordance with examples as disclosed herein. For example, the communications manager 1120 is capable of, configured to, or operable to support a means for receiving a preamble of a PPDU, where the preamble includes a U-SIG, where the U-SIG includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth. The communications manager 1120 is capable of, configured to, or operable to support a means for receiving a payload of the PPDU using the indicated channel bandwidth.

By including or configuring the communications manager 1120 in accordance with examples as described herein, the device 1105 (for example, at least one processor controlling or otherwise coupled with the receiver 1110, the transmitter 1115, the communications manager 1120, or a combination thereof) may support techniques for more efficient utilization of communication resources.

FIG. 12 shows a block diagram 1200 of a device 1205 that supports techniques for 480 and 640 MHz transmission in Wi-Fi in accordance with one or more aspects of the present disclosure. The device 1205 may be an example of aspects of a device 1105, an AP 102, or a STA 104 as described herein. The device 1205 may include a receiver 1210, a transmitter 1215, and a communications manager 1220. The device 1205, or one or more components of the device 1205 (for example, the receiver 1210, the transmitter 1215, and the communications manager 1220), may include at least one processor, which may be coupled with at least one memory, to support the described techniques. Each of these components may be in communication with one another (for example, via one or more buses).

The receiver 1210 may provide a means for receiving information such as packets, user data, control information, or any combination thereof associated with various information channels (for example, control channels, data channels, information channels related to techniques for 480 and 640 MHz transmission in Wi-Fi). Information may be passed on to other components of the device 1205. The receiver 1210 may utilize a single antenna or a set of multiple antennas.

The transmitter 1215 may provide a means for transmitting signals generated by other components of the device 1205. The transmitter 1215 may utilize a single antenna or a set of multiple antennas.

The device 1205, or various components thereof, may be an example of means for performing various aspects of techniques for 480 and 640 MHz transmission in Wi-Fi as described herein. For example, the communications manager 1220 may include a preamble transmission manager 1225, a payload transmission manager 1230, a preamble reception manager 1235, a payload reception manager 1240, or any combination thereof. The communications manager 1220 may be an example of aspects of a communications manager 1120 as described herein. In some aspects, the communications manager 1220, or various components thereof, may be configured to perform various operations (for example, receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a wireless communications device in accordance with examples as disclosed herein. The preamble transmission manager 1225 is capable of, configured to, or operable to support a means for transmitting a preamble of a PPDU, where the preamble includes a U-SIG, where the U-SIG includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth. The payload transmission manager 1230 is capable of, configured to, or operable to support a means for transmitting a payload of the PPDU using the indicated channel bandwidth.

Additionally, or alternatively, the communications manager 1220 may support wireless communications at a wireless communications device in accordance with examples as disclosed herein. The preamble reception manager 1235 is capable of, configured to, or operable to support a means for receiving a preamble of a PPDU, where the preamble includes a U-SIG, where the U-SIG includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth. The payload reception manager 1240 is capable of, configured to, or operable to support a means for receiving a payload of the PPDU using the indicated channel bandwidth.

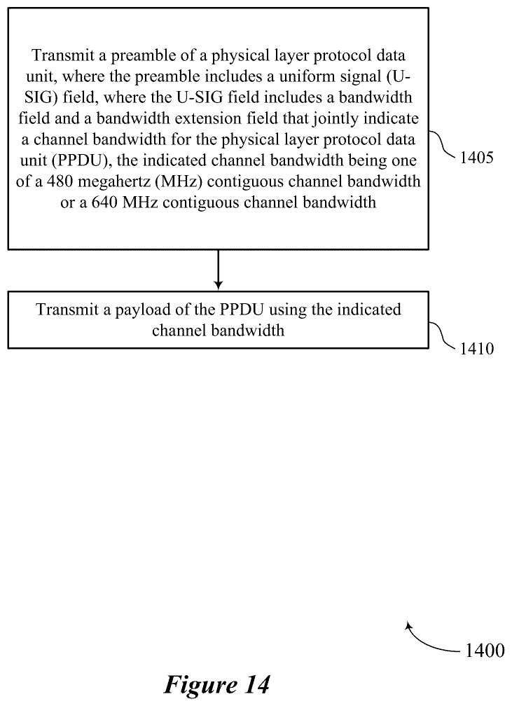

FIG. 13 shows a block diagram of an example wireless communication device 1300 that supports techniques for 480 and 640 MHz transmission in Wi-Fi. In various examples, the wireless communication device 1300 can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “at least one processor”); one or more radios (collectively “at least one radio”); and one or more memories or memory blocks (collectively “at least one memory”). In some aspects, the at least one processor may include multiple processors, and the at least one memory may include multiple memories. One or more of the multiple processors may be coupled with one or more of the multiple memories which may, individually or collectively, be configured to perform various functions described herein (as part of a processing system).

In some aspects, the wireless communication device 1300 can be a device for use in a communications manager, such as communications manager 1120 described with reference to FIG. 11. In some other examples, the wireless communication device 1300 can be a communications manager that includes such a chip, SoC, chipset, package or device as well as multiple antennas. The wireless communication device 1300 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some aspects, the wireless communication device 1300 also includes or can be coupled with at least one application processor which may be further coupled with at least one memory. In some aspects, the wireless communication device 1300 further includes at least one external network interface that enables communication with a core network or backhaul network to gain access to external networks including the Internet.

The wireless communication device 1300 includes a preamble transmission manager 1325, a payload transmission manager 1330, a preamble reception manager 1335, a payload reception manager 1340, a tone plan manager 1345, a puncturing plan indication manager 1350, a phase rotation manager 1355, a duplication mode manager 1360, a spectral mask manager 1365, a pilot signal transmission manager 1370, a segment parser manager 1375, a pilot signal reception manager 1380, a segment deparser manager 1385, and a 320 MHz channel bandwidth manager 1390. Portions of one or more of the preamble transmission manager 1325, the payload transmission manager 1330, the preamble reception manager 1335, the payload reception manager 1340, the tone plan manager 1345, the puncturing plan indication manager 1350, the phase rotation manager 1355, the duplication mode manager 1360, the spectral mask manager 1365, the pilot signal transmission manager 1370, the segment parser manager 1375, the pilot signal reception manager 1380, the segment deparser manager 1385, and the 320 MHz channel bandwidth manager 1390 may be implemented at least in part in hardware or firmware. For example, one or more of the preamble transmission manager 1325, the payload transmission manager 1330, the preamble reception manager 1335, the payload reception manager 1340, the tone plan manager 1345, the puncturing plan indication manager 1350, the phase rotation manager 1355, the duplication mode manager 1360, the spectral mask manager 1365, the pilot signal transmission manager 1370, the segment parser manager 1375, the pilot signal reception manager 1380, the segment deparser manager 1385, and the 320 MHz channel bandwidth manager 1390 may be implemented at least in part by at least one modem. In some aspects, at least some of the preamble transmission manager 1325, the payload transmission manager 1330, the preamble reception manager 1335, the payload reception manager 1340, the tone plan manager 1345, the puncturing plan indication manager 1350, the phase rotation manager 1355, the duplication mode manager 1360, the spectral mask manager 1365, the pilot signal transmission manager 1370, the segment parser manager 1375, the pilot signal reception manager 1380, the segment deparser manager 1385, and the 320 MHz channel bandwidth manager 1390 are implemented at least in part by at least one processor and as software stored in at least one memory. For example, portions of one or more of the preamble transmission manager 1325, the payload transmission manager 1330, the preamble reception manager 1335, the payload reception manager 1340, the tone plan manager 1345, the puncturing plan indication manager 1350, the phase rotation manager 1355, the duplication mode manager 1360, the spectral mask manager 1365, the pilot signal transmission manager 1370, the segment parser manager 1375, the pilot signal reception manager 1380, the segment deparser manager 1385, and the 320 MHz channel bandwidth manager 1390 can be implemented as non-transitory instructions (or “code”) executable by the at least one processor to perform the functions or operations of the respective module.

In some aspects, the at least one processor may be a component of a processing system. A processing system may generally refer to a system or series of machines or components that receives inputs and processes the inputs to produce a set of outputs (which may be passed to other systems or components of, for example, the wireless communication device 1300). For example, a processing system of the wireless communication device 1300 may refer to a system including the various other components or subcomponents of the wireless communication device 1300, such as the at least one processor, or at least one transceiver, or at least one communications manager, or other components or combinations of components of the wireless communication device 1300. The processing system of the wireless communication device 1300 may interface with other components of the wireless communication device 1300, and may process information received from other components (such as inputs or signals) or output information to other components. For example, a chip or modem of the wireless communication device 1300 may include a processing system, a first interface to output information and a second interface to obtain information. In some aspects, the first interface may refer to an interface between the processing system of the chip or modem and a transmitter, such that the wireless communication device 1300 may transmit information output from the chip or modem. In some aspects, the second interface may refer to an interface between the processing system of the chip or modem and a receiver, such that the wireless communication device 1300 may obtain information or signal inputs, and the information may be passed to the processing system. A person having ordinary skill in the art will readily recognize that the first interface also may obtain information or signal inputs, and the second interface also may output information or signal outputs.

The communications manager 1320 may support wireless communications at a wireless communications device in accordance with examples as disclosed herein. The preamble transmission manager 1325 is capable of, configured to, or operable to support a means for transmitting a preamble of a PPDU, where the preamble includes a U-SIG, where the U-SIG includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth. The payload transmission manager 1330 is capable of, configured to, or operable to support a means for transmitting a payload of the PPDU using the indicated channel bandwidth.

In some aspects, a first set of values of the bandwidth field indicate a corresponding set of channel bandwidths other than 480 MHz or 640 MHz. In some aspects, a second set of values of the bandwidth field indicates 480 MHz bandwidth operation or 640 MHz bandwidth operation. In some aspects, the second set of values in combination with the bandwidth extension field indicates the 480 MHz contiguous channel bandwidth or the 640 MHz contiguous channel bandwidth.

In some aspects, the corresponding set of channel bandwidths include a 160 MHz bandwidth extending to 7225 MHz, and a 320 MHz bandwidth extending to 7225 MHz, and the indicated channel bandwidth is one of a 480 MHz bandwidth extending to 7225 MHz or a 640 MHz bandwidth extending to 7225 MHz.

In some aspects, for the preamble that is transmitted within a first subband of the 480 MHz contiguous channel bandwidth or the 640 MHz contiguous channel bandwidth, the bandwidth field indicates a first value and the bandwidth extension field indicates a second value. In some aspects, for the preamble that is transmitted within a second subband of the 480 MHz contiguous channel bandwidth or the 640 MHz contiguous channel bandwidth, the bandwidth field indicates a third value and the bandwidth extension field indicates a fourth value. In some aspects, the first value is different from the third value and the second value is different from the fourth value.

In some aspects, to support transmitting the preamble and the payload, the tone plan manager 1345 is capable of, configured to, or operable to support a means for transmitting the preamble and the payload according to a tone plan, the tone plan including one or more of: a set of multiple EHT 80 MHz tone plans across the 480 MHz contiguous channel bandwidth or the 640 MHz contiguous channel bandwidth; a 6×996 tone RU for the 480 MHz contiguous channel bandwidth; 4×996 tone MRUs for the 480 MHz contiguous channel bandwidth; 4×996+484 tone MRUs for the 480 MHz contiguous channel bandwidth; 4×996+484+242 tone MRUs for the 480 MHz contiguous channel bandwidth; 5×996 tone MRUs for the 480 MHz contiguous channel bandwidth; 5×996+484 tone MRUs for the 480 MHz contiguous channel bandwidth; 5×996+484+242 tone MRUs for the 480 MHz contiguous channel bandwidth; a 8×996 tone RU for the 640 MHz contiguous channel bandwidth; 4×996 tone RUs for the 640 MHz contiguous channel bandwidth; 4×996+484 tone MRUs for the 640 MHz contiguous channel bandwidth; 5×996 tone MRUs for the 640 MHz contiguous channel bandwidth; 5×996+484 tone MRUs for the 640 MHz contiguous channel bandwidth; 6×996 tone MRUs for the 640 MHz contiguous channel bandwidth; a6×996+484 tone MRUs for the 640 MHz contiguous channel bandwidth; 7×996 tone MRUs for the 640 MHz contiguous channel bandwidth; or 7×996+484 tone MRUs for the 640 MHz contiguous channel bandwidth.

In some aspects, the pilot signal transmission manager 1370 is capable of, configured to, or operable to support a means for transmitting a set of multiple pilot signals, where resources used to transmit the set of multiple pilot signals are based on the tone plan.

In some aspects, the segment parser manager 1375 is capable of, configured to, or operable to support a means for generating the PPDU in accordance with a segment parser, where the segment parser is based on the tone plan.

In some aspects, the puncturing plan indication manager 1350 is capable of, configured to, or operable to support a means for transmitting, in the preamble, an indication of a puncturing pattern for the PPDU.

In some aspects the PPDU is a non-OFDMA PPDU, and the indication of the puncturing pattern indicates one or more of: no puncturing, a punctured 40 MHz bandwidth within the 480 MHz contiguous channel bandwidth or the 640 MHz contiguous channel bandwidth, a punctured 80 MHz bandwidth within the 480 MHz contiguous channel bandwidth or the 640 MHz contiguous channel bandwidth, two concurrent punctured 80 MHz bandwidths within the 480 MHz contiguous channel bandwidth or the 640 MHz contiguous channel bandwidth, or a concurrent 40 MHz bandwidth and 80 MHz bandwidth within the 480 MHz contiguous channel bandwidth or the 640 MHz contiguous channel bandwidth.

In some aspects, the PPDU includes an OFDMA PPDU. In some aspects, the indication of the puncturing pattern indicates zero or one or two punctured 20 MHz bandwidths for each 80 MHz bandwidth within the 480 MHz contiguous channel bandwidth or the 640 MHz contiguous channel bandwidth.

In some aspects, the U-SIG of a TB PPDU includes a set of multiple spatial reuse fields indicating spatial reuse information for each of a set of multiple 20 MHz portions of the 480 MHz contiguous channel bandwidth or the 640 MHz contiguous channel bandwidth.

In some aspects, the preamble includes an EHT-SIG field including a RU allocation subfield. In some aspects, a quantity of entries in the RU allocation subfield is based on the indicated channel bandwidth being one of the 480 MHz contiguous channel bandwidth or the 640 MHz contiguous channel bandwidth.

In some aspects, the preamble includes a UHR STF. In some aspects, the UHR STF includes a set of multiple sequences within 80 MHz segments or 160 MHz segments of the 480 MHz contiguous channel bandwidth or the 640 MHz contiguous channel bandwidth. In some aspects, each of the set of multiple sequences is multiplied by a different coefficient.

In some aspects, the preamble includes a UHR LTF. In some aspects, the UHR LTF includes a set of multiple sequences within 80 MHz segments of the 480 MHz contiguous channel bandwidth or the 640 MHz contiguous channel bandwidth. In some aspects, each sequence of the set of multiple sequences includes multiple parts. In some aspects, each part of the multiple parts is multiplied by a different coefficient.

In some aspects, to support transmitting the preamble and the payload, the phase rotation manager 1355 is capable of, configured to, or operable to support a means for applying a phase rotation pattern on a 80 MHz subblock basis within the 480 MHz contiguous channel bandwidth or the 640 MHz contiguous channel bandwidth.

In some aspects, the duplication mode manager 1360 is capable of, configured to, or operable to support a means for generating the PPDU via encoding a lower frequency tone 3×996 RU of the 480 MHz contiguous channel bandwidth or 4×996 RU of the 640 MHz contiguous channel bandwidth using BPSK-DCM. In some aspects, the duplication mode manager 1360 is capable of, configured to, or operable to support a means for duplicating the lower frequency tone 3×996 RU of the 480 MHz contiguous channel bandwidth or 4×996 RU of the 640 MHz contiguous channel bandwidth onto a higher frequency tone 3×996 RU of the 480 MHz contiguous channel bandwidth or 4×996 U of the 640 MHz contiguous channel bandwidth. In some aspects, the duplication mode manager 1360 is capable of, configured to, or operable to support a means for applying a phase shift to the higher frequency tone 3×996 RU of the 480 MHz contiguous channel bandwidth or the 4×996 RU of the 640 MHz contiguous channel bandwidth.

In some aspects, to support transmitting the preamble and the payload, the spectral mask manager 1365 is capable of, configured to, or operable to support a means for applying a spectral mask to transmission of the preamble and the payload, where the spectral mask has one of: a 0 dBr bandwidth of 479 MHz, −20 dBr at 240.5 MHz offset, −28 dBr at 480 MHz offset, and −40 dBr at 720 MHz offset for a 480 MHz physical layer protocol data unit; a 0 dBr bandwidth of 478 MHz, −20 dBr at 241 MHz offset, −28 dBr at 480 MHz offset, and −40 dBr at 720 MHz offset for a 480 MHz non-high throughput duplicate physical layer protocol data unit; a 0 dBr bandwidth of 639 MHz, −20 dBr at 320.5 MHz offset, −28 dBr at 640 MHz offset, and −40 dBr at 960 MHz offset for a 640 MHz physical layer protocol data unit; a 0 dBr bandwidth of 638 MHz, −20 dBr at 320 MHz offset, −28 dBr at 640 MHz offset, and −40 dBr at 960 MHz offset for a 640 MHz non-high throughput duplicate physical layer protocol data unit.

In some aspects, the indicated channel bandwidth is the 480 MHz contiguous channel bandwidth; within a lowest 160 MHz subband of the 480 MHz contiguous channel bandwidth the bandwidth field indicates a first 320 MHz channelization and the bandwidth extension field indicates an additional upper 160 MHz subband; within a middle 160 MHz subband of the 480 MHz contiguous channel bandwidth the bandwidth field indicates one of the first 320 MHz channelization and the additional upper 160 MHz subband or a second 320 MHz channelization and an additional lower 160 MHz subband; and within a highest 160 MHz subband of the 480 MHz contiguous channel bandwidth the bandwidth field indicates the second 320 MHz channelization and the bandwidth extension field indicates the additional lower 160 MHz subband.

In some aspects, within the lowest 160 MHz subband, a first spatial reuse field of the U-SIG field is associated with the lowest 160 MHz subband, a second spatial reuse field of the U-SIG field is associated with the middle 160 MHz subband, and a third spatial reuse field is associated with the additional upper 160 MHz subband; and within the highest 160 MHz subband, the first spatial reuse field is associated with the middle 160 MHz subband, the second spatial reuse field is associated with the highest 160 MHz subband, and the third spatial reuse field is associated with the lowest 160 MHz subband.

In some aspects, the indicated channel bandwidth is the 480 MHz contiguous channel bandwidth; within a first 160 MHz subband of the 480 MHz contiguous channel bandwidth the bandwidth field indicates a first 160 MHz channelization and the bandwidth extension field indicates the first 160 MHz subband is a lowest 160 MHz subband of the 480 MHz contiguous channel bandwidth; within a second 160 MHz subband of the 480 MHz contiguous channel bandwidth the bandwidth field indicates a second 160 MHz channelization and the bandwidth extension field indicates the second 160 MHz subband is a middle 160 MHz subband of the 480 MHz contiguous channel bandwidth; and within a third 160 MHz subband of the 480 MHz contiguous channel bandwidth the bandwidth field indicates a third 160 MHz channelization and the bandwidth extension field indicates the third 160 MHz subband is a highest 160 MHz subband of the 480 MHz contiguous channel bandwidth.

In some aspects, within the first 160 MHz subband, a first spatial reuse field of the U-SIG field is associated with a lowest 80 MHz of the first 160 MHz subband, a second spatial reuse field of the U-SIG field is associated with a highest 80 MHz of the first 160 MHz subband, a third spatial reuse field of the U-SIG field is associated with the second 160 MHz subband, and a fourth spatial reuse field of the U-SIG is associated with the third 160 MHz subband; within the second 160 MHz subband, the first spatial reuse field is associated with a lowest 80 MHz of the second 160 MHz subband, the second spatial reuse field is associated with a highest 80 MHz of the second 160 MHz subband, the third spatial reuse field is associated with the first 160 MHz subband, and the fourth spatial reuse field is associated with the third 160 MHz subband; and within the third 160 MHz subband, the first spatial reuse field is associated with a lowest 80 MHz of the third 160 MHz subband, the second spatial reuse field is associated with a highest 80 MHz of the third 160 MHz subband, the third spatial reuse field is associated with the first 160 MHz subband, and the fourth spatial reuse field is associated with the second 160 MHz subband.

In some aspects, the indicated channel bandwidth is the 480 MHz contiguous channel bandwidth; the 480 MHz contiguous channel bandwidth includes a 160 MHz primary channel portion and a remaining 320 MHz portion; and the preamble includes an UHR signal field including a RU allocation subfield, where the RU allocation subfield includes a respective 9 bit RU allocation table for each 20 MHz portion of the 160 MHz primary channel portion, and where the RU allocation subfield includes a respective 8 bit RU allocation table for each 80 MHz portion of the remaining 320 MHz portion.

In some aspects, the indicated channel bandwidth is the 480 MHz contiguous channel bandwidth; and the preamble includes a UHR signal field including a first common field and a first user specific field associated with a 320 MHz subband of the 480 MHz contiguous channel bandwidth and a second common field and a second user specific field associated with a 160 MHz subband of the 480 MHz contiguous channel bandwidth.

In some aspects, the indicated channel bandwidth is the 480 MHz contiguous channel bandwidth, where the 480 MHz contiguous channel bandwidth includes a primary 160 MHz subchannel, a first secondary 160 MHz subchannel, and one of a second secondary 160 MHz subchannel or a tertiary 160 MHz subband.

In some aspects, where the primary 160 MHz subchannel is a middle 160 MHz subchannel of the 480 MHz channel bandwidth the 320 MHz channel bandwidth manager is capable of, configured to, or operable to support a means for: communicating with a second wireless communications device via a first 320 MHz subchannel of the 480 MHz channel bandwidth, where the first 320 MHz subchannel includes the primary 160 MHz subchannel and a lower 160 MHz subchannel of the 480 MHz channel bandwidth; and communicating with a third wireless communications device via a second 320 MHz subchannel of the 480 MHz channel bandwidth, where the second 320 MHz subchannel includes the primary 160 MHz subchannel and an upper 160 MHz subchannel of the 480 MHz channel bandwidth, where the second wireless communications device and the third wireless communications device are 320 MHz limited devices. In some aspects, where the wireless communications device is an AP, the 320 MHz channel bandwidth manager is capable of, configured to, or operable to support a means for: transmitting an indication of a first 320 MHz operating channel for the second wireless communications device to the second wireless communications device and a second 320 MHz operating channel for the third wireless communications device to the third wireless communications device, where the first 320 MHz operating channel is the first 320 MHz subchannel and the second 320 MHz operating channel is the second 320 MHz subchannel; or receiving an indication of the first 320 MHz operating channel for the second wireless communications device from the second wireless communications device and the second 320 MHz operating channel for the third wireless communications device from the third wireless communications device.

Additionally, or alternatively, the communications manager 1320 may support wireless communications at a wireless communications device in accordance with examples as disclosed herein. The preamble reception manager 1335 is capable of, configured to, or operable to support a means for receiving a preamble of a PPDU, where the preamble includes a U-SIG, where the U-SIG includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth. The payload reception manager 1340 is capable of, configured to, or operable to support a means for receiving a payload of the PPDU using the indicated channel bandwidth.

In some aspects, a first set of values of the bandwidth field indicate a corresponding set of channel bandwidths other than 480 MHz or 640 MHz. In some aspects, a second set of values of the bandwidth field indicates 480 MHz bandwidth operation or 640 MHz bandwidth operation. In some aspects, the second set of values in combination with the bandwidth extension field indicates the 480 MHz contiguous channel bandwidth or the 640 MHz contiguous channel bandwidth.

In some aspects, for the preamble that is received within a first subband of the 480 MHz contiguous channel bandwidth or the 640 MHz contiguous channel bandwidth the bandwidth field indicates a first value and the bandwidth extension field indicates a second value. In some aspects, for the preamble that is received within a second subband of the 480 MHz contiguous channel bandwidth or the 640 MHz contiguous channel bandwidth the bandwidth field indicates a third value and the bandwidth extension field indicates a fourth value. In some aspects, the first value is different from the third value and the second value is different from the fourth value.

In some aspects, to support receiving the preamble, the tone plan manager 1345 is capable of, configured to, or operable to support a means for receiving the preamble and the payload according to a tone plan, the tone plan including one or more of: a set of multiple EHT 80 MHz tone plans across the 480 MHz contiguous channel bandwidth or the 640 MHz contiguous channel bandwidth; a 6×996 tone RU for the 480 MHz contiguous channel bandwidth; 4×996 tone MRUs for the 480 MHz contiguous channel bandwidth; 4×996+484 tone MRUs for the 480 MHz contiguous channel bandwidth; 4×996+484+242 tone MRUs for the 480 MHz contiguous channel bandwidth; 5×996 tone MRUs for the 480 MHz contiguous channel bandwidth; 5×996+484 tone MRUs for the 480 MHz contiguous channel bandwidth; 5×996+484+242 tone MRUs for the 480 MHz contiguous channel bandwidth; a 8×996 tone RU for the 640 MHz contiguous channel bandwidth; 4×996 tone RUs for the 640 MHz contiguous channel bandwidth; 4×996+484 tone MRUs for the 640 MHz contiguous channel bandwidth; 5×996 tone MRUs for the 640 MHz contiguous channel bandwidth; 5×996+484 tone MRUs for the 640 MHz contiguous channel bandwidth; 6×996 tone MRUs for the 640 MHz contiguous channel bandwidth; a6×996+484 tone MRUs for the 640 MHz contiguous channel bandwidth; 7×996 tone MRUs for the 640 MHz contiguous channel bandwidth; or 7×996+484 tone MRUs for the 640 MHz contiguous channel bandwidth.

In some aspects, the pilot signal reception manager 1380 is capable of, configured to, or operable to support a means for receiving a set of multiple pilot signals, where resources used to transmit the set of multiple pilot signals are based on the tone plan.

In some aspects, the segment deparser manager 1385 is capable of, configured to, or operable to support a means for deparsing the PPDU in accordance with a segment deparser, where the segment deparser is based on the tone plan.

In some aspects, the puncturing plan indication manager 1350 is capable of, configured to, or operable to support a means for receiving, in the preamble, an indication of a puncturing pattern for the PPDU.

In some aspects, the PPDU includes a non-OFDMA PPDU. In some aspects, the indication of the puncturing pattern indicates one or more of no puncturing, a punctured 40 MHz bandwidth within the 480 MHz contiguous channel bandwidth or the 640 MHz contiguous channel bandwidth, a punctured 80 MHz bandwidth within the 480 MHz contiguous channel bandwidth or the 640 MHz contiguous channel bandwidth, two concurrent punctured 80 MHz bandwidths within the 480 MHz contiguous channel bandwidth or the 640 MHz contiguous channel bandwidth, or a concurrent 40 MHz bandwidth and 80 MHz bandwidth within the 480 MHz contiguous channel bandwidth or the 640 MHz contiguous channel bandwidth.

In some aspects, the PPDU includes an OFDMA PPDU. In some aspects, the indication of the puncturing pattern indicates zero or one or two punctured 20 MHz bandwidths for each 80 MHz bandwidth within the 480 MHz contiguous channel bandwidth or the 640 MHz contiguous channel bandwidth.

In some aspects, the U-SIG of a TB PPDU includes a set of multiple spatial reuse fields indicating spatial reuse information for each of a set of multiple 20 MHz portions of the 480 MHz contiguous channel bandwidth or the 640 MHz contiguous channel bandwidth.

In some aspects, the preamble includes an EHT-SIG field including a RU allocation subfield. In some aspects, a quantity of entries in the RU allocation subfield is based on the indicated channel bandwidth being one of the 480 MHz contiguous channel bandwidth or the 640 MHz contiguous channel bandwidth.

In some aspects, the preamble includes a UHR STF. In some aspects, the UHR STF includes a set of multiple sequences within 80 MHz segments or 160 MHz segments of the 480 MHz contiguous channel bandwidth or the 640 MHz contiguous channel bandwidth. In some aspects, each of the set of multiple sequences is multiplied by a different coefficient.

In some aspects, the preamble includes a UHR LTF. In some aspects, the UHR LTF includes a set of multiple sequences within 80 MHz segments of the 480 MHz contiguous channel bandwidth or the 640 MHz contiguous channel bandwidth. In some aspects, each sequence of the set of multiple sequences includes multiple parts. In some aspects, each part of the multiple parts is multiplied by a different coefficient.

In some aspects, a phase rotation pattern on a 80 MHz subblock basis within the 480 MHz contiguous channel bandwidth or the 640 MHz contiguous channel bandwidth is applied to the PPDU.

In some aspects, a lower frequency tone 3×996 RU of the 480 MHz contiguous channel bandwidth or 4×996 RU of the 640 MHz contiguous channel bandwidth of the PPDU is encoded using BPSK-DCM, and the lower frequency tone 3×996 RU of the 480 MHz contiguous channel bandwidth or 4×996 RU the 640 MHz contiguous channel bandwidth is duplicated and phase shifted onto a higher frequency tone 3×996 RU of the 480 MHz contiguous channel bandwidth or 4×99×RU of the 640 MHz contiguous channel bandwidth of the PPDU.

In some aspects, a spectral mask is applied to the preamble and the payload. In some aspects, the spectral mask has one of: a 0 dBr bandwidth of 479 MHz, −20 dBr at 240.5 MHz offset, −28 dBr at 480 MHz offset, and −40 dBr at 720 MHz offset for a 480 MHz physical layer protocol data unit; a 0 dBr bandwidth of 478 MHz, −20 dBr at 241 MHz offset, −28 dBr at 480 MHz offset, and −40 dBr at 720 MHz offset for a 480 MHz non-high throughput duplicate physical layer protocol data unit; a 0 dBr bandwidth of 639 MHz, −20 dBr at 320.5 MHz offset, −28 dBr at 640 MHz offset, and −40 dBr at 960 MHz offset for a 640 MHz physical layer protocol data unit; a 0 dBr bandwidth of 638 MHz, −20 dBr at 320 MHz offset, −28 dBr at 640 MHz offset, and −40 dBr at 960 MHz offset for a 640 MHz non-high throughput duplicate physical layer protocol data unit.

In some aspects, the preamble may include one or more user fields that indicate one or more RU assignments within the indicated channel bandwidth for one or more respective users associated with the one or more user fields. In such examples where each user field includes an RU assignment, the UHR-SIG common field may not include RU allocation subfields.

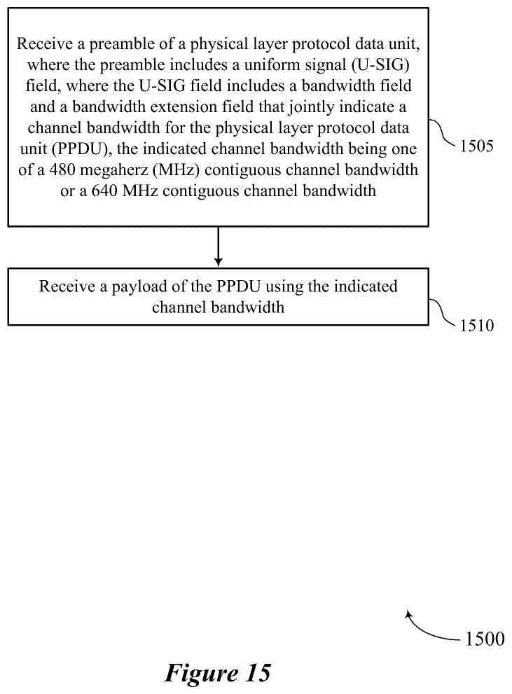

FIG. 14 shows a flowchart illustrating a method 1400 that supports techniques for 480 and 640 MHz transmission in Wi-Fi in accordance with one or more aspects of the present disclosure. The operations of the method 1400 may be implemented by an AP or a STA or its components as described herein. For example, the operations of the method 1400 may be performed by an AP or a STA as described with reference to FIGS. 2 through 13. In some aspects, an AP or a STA may execute a set of instructions to control the functional elements of the wireless AP or the wireless STA to perform the described functions. Additionally, or alternatively, the wireless AP or the wireless STA may perform aspects of the described functions using special-purpose hardware.

In some aspects, in block 1405, the wireless AP or the wireless STA may transmit a preamble of a PPDU, where the preamble includes a U-SIG, where the U-SIG includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth. The operations of block 1405 may be performed in accordance with examples as disclosed herein, such as the transmission of a PHY preamble including a legacy portion 352 and a non-legacy portion 354 of FIG. 3a, a PHY preamble 402 of FIG. 4, or a preamble 608 of FIG. 6. In some aspects, aspects of the operations of block 1405 may be performed by a preamble transmission manager 1325 as described with reference to FIG. 13.

In some aspects, in block 1410, the wireless AP or the wireless STA may transmit a payload of the PPDU using the indicated channel bandwidth. The operations of block 1410 may be performed in accordance with examples as disclosed herein, such as the transmission of a payload 356 of FIG. 3a, a PSDU 404 of FIG. 4, or a payload 610 of FIG. 6. In some aspects, aspects of the operations of block 1410 may be performed by a payload transmission manager 1330 as described with reference to FIG. 13.

FIG. 15 shows a flowchart illustrating a method 1500 that supports techniques for 480 and 640 MHz transmission in Wi-Fi in accordance with one or more aspects of the present disclosure. The operations of the method 1500 may be implemented by an AP or a STA or its components as described herein. For example, the operations of the method 1500 may be performed by an AP or a STA as described with reference to FIGS. 2 through 13. In some aspects, an AP or a STA may execute a set of instructions to control the functional elements of the wireless AP or the wireless STA to perform the described functions. Additionally, or alternatively, the wireless AP or the wireless STA may perform aspects of the described functions using special-purpose hardware.

In some aspects, in block 1505, the wireless AP or the wireless STA may receive a preamble of a PPDU, where the preamble includes a U-SIG, where the U-SIG includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth. The operations of block 1505 may be performed in accordance with examples as disclosed herein, such as the reception of a PHY preamble including a legacy portion 352 and a non-legacy portion 354 of FIG. 3a, a PHY preamble 402 of FIG. 4, or a preamble 608 of FIG. 6. In some aspects, aspects of the operations of block 1505 may be performed by a preamble reception manager 1335 as described with reference to FIG. 13.

In some aspects, in block 1510, the wireless AP or the wireless STA may receive a payload of the PPDU using the indicated channel bandwidth. The operations of block 1510 may be performed in accordance with examples as disclosed herein, such as the reception of a payload 356 of FIG. 3a, a PSDU 404 of FIG. 4, or a payload 610 of FIG. 6. In some aspects, aspects of the operations of block 1510 may be performed by a payload reception manager 1340 as described with reference to FIG. 13.

Implementation examples are described in the following numbered clauses:

Aspect 1: A method for wireless communications by a wireless communications device, including: transmitting a preamble of a PPDU, where the preamble includes a U-SIG field, where the U-SIG field includes a bandwidth field and a bandwidth extension field that jointly indicate a channel bandwidth for the PPDU, the indicated channel bandwidth being one of a 480 MHz contiguous channel bandwidth or a 640 MHz contiguous channel bandwidth; and transmitting a payload of the PPDU using the indicated channel bandwidth.

Aspect 2: The method of aspect 1, where a first set of values of the bandwidth field indicate a corresponding set of channel bandwidths other than 480 MHz or 640 MHz, a second set of values of the bandwidth field indicates 480 MHz bandwidth operation or 640 MHz bandwidth operation, and the second set of values in combination with the bandwidth extension field indicates the 480 MHz contiguous channel bandwidth or the 640 MHz contiguous channel bandwidth.

Aspect 3: The method of aspect 2, wherein the corresponding set of channel bandwidths include a 160 MHz bandwidth extending to 7225 MHz, and a 320 MHz bandwidth extending to 7225 MHz, and wherein the indicated channel bandwidth is one of a 480 MHz bandwidth extending to 7225 MHz or a 640 MHz bandwidth extending to 7225 MHz.

Aspect 4: The method of any of aspects 1-3, where for the preamble that is transmitted within a first subband of the 480 MHz contiguous channel bandwidth or the 640 MHz contiguous channel bandwidth, the bandwidth field indicates a first value and the bandwidth extension field indicates a second value, for the preamble that is transmitted within a second subband of the 480 MHz contiguous channel bandwidth or the 640 MHz contiguous channel bandwidth, the bandwidth field indicates a third value and the bandwidth extension field indicates a fourth value, and the first value is different from the third value and the second value is different from the fourth value.

Aspect 5: The method of any of aspects 1-4, where transmitting the preamble and the payload includes: transmitting the preamble and the payload according to a tone plan, the tone plan including one or more of: a plurality of EHT 80 MHz tone plans across the 480 MHz contiguous channel bandwidth or the 640 MHz contiguous channel bandwidth; a 6×996 tone RU for the 480 MHz contiguous channel bandwidth; 4×996 tone MRUs for the 480 MHz contiguous channel bandwidth; 4×996+484 tone MRUs for the 480 MHz contiguous channel bandwidth; 4×996+484+242 tone MRUs for the 480 MHz contiguous channel bandwidth; 5×996 tone MRUs for the 480 MHz contiguous channel bandwidth; 5×996+484 tone MRUs for the 480 MHz contiguous channel bandwidth; 5×996+484+242 tone MRUs for the 480 MHz contiguous channel bandwidth; a 8×996 tone RU for the 640 MHz contiguous channel bandwidth; 4×996 tone RUs for the 640 MHz contiguous channel bandwidth; 4×996+484 tone MRUs for the 640 MHz contiguous channel bandwidth; 5×996 tone MRUs for the 640 MHz contiguous channel bandwidth; 5×996+484 tone MRUs for the 640 MHz contiguous channel bandwidth; 6×996 tone MRUs for the 640 MHz contiguous channel bandwidth; a6×996+484 tone MRUs for the 640 MHz contiguous channel bandwidth; 7×996 tone MRUs for the 640 MHz contiguous channel bandwidth; or 7×996+484 tone MRUs for the 640 MHz contiguous channel bandwidth.

Aspect 6: The method of aspect 5, further including: transmitting a set of multiple pilot signals, where resources used to transmit the set of multiple pilot signals are based at least in part on the tone plan.

Aspect 7: The method of any of aspects 5-6, further including: generating the PPDU in accordance with a segment parser, where the segment parser is based at least in part on the tone plan.

Aspect 8: The method of any of aspects 1-7, further including: transmitting, in the preamble, an indication of a puncturing pattern for the PPDU.

Aspect 9: The method of aspect 8, where the PPDU includes a non-orthogonal frequency-division multiple access PPDU, and the indication of the puncturing pattern indicates one or more of no puncturing, a punctured 40 MHz bandwidth within the 480 MHz contiguous channel bandwidth or the 640 MHz contiguous channel bandwidth, a punctured 80 MHz bandwidth within the 480 MHz contiguous channel bandwidth or the 640 MHz contiguous channel bandwidth, two concurrent punctured 80 MHz bandwidths within the 480 MHz contiguous channel bandwidth or the 640 MHz contiguous channel bandwidth, or a concurrent 40 MHz bandwidth and 80 MHz bandwidth within the 480 MHz contiguous channel bandwidth or the 640 MHz contiguous channel bandwidth.

Aspect 10: The method of any of aspects 8-9, where the PPDU includes an orthogonal frequency-division multiple access PPDU, and the indication of the puncturing pattern indicates zero or one or two punctured 20 MHz bandwidths for each 80 MHz bandwidth within the 480 MHz contiguous channel bandwidth or the 640 MHz contiguous channel bandwidth.

Aspect 11: The method of any of aspects 1-10, where the U-SIG field of a TB PPDU includes a set of multiple spatial reuse fields indicating spatial reuse information for each of a set of multiple 20 MHz portions of the 480 MHz contiguous channel bandwidth or the 640 MHz contiguous channel bandwidth.

Aspect 12: The method of any of aspects 1-11, where the preamble includes an EHT signal field including a RU allocation subfield, and a quantity of entries in the RU allocation subfield is based at least in part on the indicated channel bandwidth being one of the 480 MHz contiguous channel bandwidth or the 640 MHz contiguous channel bandwidth.

Aspect 13: The method of any of aspects 1-12, where the preamble includes an UHR STF, the UHR STF includes a set of multiple sequences within 80 MHz segments or 160 MHz segments of the 480 MHz contiguous channel bandwidth or the 640 MHz contiguous channel bandwidth, and each of the set of multiple sequences is multiplied by a different coefficient.

Aspect 14: The method of any of aspects 1-13, where the preamble includes an UHR LTF, the UHR LTF includes a set of multiple sequences within 80 MHz segments of the 480 MHz contiguous channel bandwidth or the 640 MHz contiguous channel bandwidth, each sequence of the set of multiple sequences includes multiple parts, and each part of the multiple parts is multiplied by a different coefficient.

Aspect 15: The method of any of aspects 1-14, where transmitting a legacy portion of the preamble includes: applying a phase rotation pattern on a 80 MHz subblock basis within the 480 MHz contiguous channel bandwidth or the 640 MHz contiguous channel bandwidth.

Aspect 16: The method of any of aspects 1-15, further including: generating the PPDU via encoding a lower frequency tone 3×996 RU of the 480 MHz contiguous channel bandwidth or 4×996 RU of the 640 MHz contiguous channel bandwidth using binary phase shift keying dual subcarrier modulation; duplicating the lower frequency tone 3×996 RU of the 480 MHz contiguous channel bandwidth or 4×996 RU of the 640 MHz contiguous channel bandwidth onto a higher frequency tone 3×996 RU of the 480 MHz contiguous channel bandwidth or 4×996 RU of the 640 MHz contiguous channel bandwidth; and applying a phase shift to the higher frequency tone 3×966 RU of the 480 MHz contiguous channel bandwidth or 4×996 RU of the 640 MHz contiguous channel bandwidth.

Aspect 17: The method of any of aspects 1-16, where transmitting the preamble and the payload includes: applying a spectral mask to transmission of the preamble and the payload, where the spectral mask has one of: a 0 dBr bandwidth of 479 MHz, −20 dBr at 240.5 MHz frequency offset, −28 dBr at 480 MHz frequency offset, and −40 dBr at 720 MHz frequency offset for a 480 MHz PPDU, where the spectral mask for frequency offsets in between 239.5 MHz and 240.5 MHz, 240.5 MHz and 480 MHz, and 480 MHz and 720 MHz may be linearly interpolated in decibels domain from requirements for 239.5 MHz, 240.5 MHz, 480 MHz, and 720 MHz frequency offsets; a 0 dBr bandwidth of 478 MHz, −20 dBr at 241 MHz frequency offset, −28 dBr at 480 MHz frequency offset, and −40 dBr at 720 MHz frequency offset for a 480 MHz non-high throughput duplicate PPDU, where the spectral mask for frequency offsets in between 239 MHz and 241 MHz, 241 MHz and 480 MHz, and 480 MHz and 720 MHz may be linearly interpolated in decibels domain from requirements for 239 MHz, 241 MHz, 480 MHz, and 720 MHz frequency offsets; a 0 dBr bandwidth of 639 MHz, −20 dBr at 320.5 MHz frequency offset, −28 dBr at 640 MHz frequency offset, and −40 dBr at 960 MHz frequency offset for a 640 MHz PPDU, where the spectral mask for frequency offsets in between 319.5 MHz and 320.5 MHz, 320.5 MHz and 640 MHz, and 640 MHz and 760 MHz may be linearly interpolated in decibels domain from the requirements for 319.5 MHz, 320.5 MHz, 640 MHz, and 960 MHz frequency offsets; a 0 dBr bandwidth of 638 MHz, −20 dBr at 320 MHz frequency offset, −28 dBr at 640 MHz frequency offset, and −40 dBr at 960 MHz frequency offset for a 640 MHz non-high throughput duplicate PPDU, where the spectral mask for frequency offsets in between 319 MHz and 320 MHz, 320 MHz and 640 MHz, and 640 MHz and 760 MHz may be linearly interpolated in decibels domain from the requirements for 319 MHz, 320 MHz, 640 MHz, and 960 MHz frequency offsets, and where a transmit spectrum may not exceed a maximum of the spectral mask and −39 dBm/MHz at any frequency offset.

Aspect 18: The method of any of aspects 1-16, wherein: the indicated channel bandwidth is the 480 MHz contiguous channel bandwidth; within a lowest 160 MHz subband of the 480 MHz contiguous channel bandwidth the bandwidth field indicates a first 320 MHz channelization and the bandwidth extension field indicates an additional upper 160 MHz subband; within a middle 160 MHz subband of the 480 MHz contiguous channel bandwidth the bandwidth field indicates one of the first 320 MHz channelization and the additional upper 160 MHz subband or a second 320 MHz channelization and an additional lower 160 MHz subband; and within a highest 160 MHz subband of the 480 MHz contiguous channel bandwidth the bandwidth field indicates the second 320 MHz channelization and the bandwidth extension field indicates the additional lower 160 MHz subband.

Aspect 19: The method of aspect 18, wherein: within the lowest 160 MHz subband, a first spatial reuse field of the universal signal field is associated with the lowest 160 MHz subband, a second spatial reuse field of the universal signal field is associated with the middle 160 MHz subband, and a third spatial reuse field is associated with the additional upper 160 MHz subband; and within the highest 160 MHz subband, the first spatial reuse field is associated with the middle 160 MHz subband, the second spatial reuse field is associated with the highest 160 MHz subband, and the third spatial reuse field is associated with the lowest 160 MHz subband.

Aspect 20: The method of any of aspects 1-16, wherein: the indicated channel bandwidth is the 480 MHz contiguous channel bandwidth; within a first 160 MHz subband of the 480 MHz contiguous channel bandwidth the bandwidth field indicates a first 160 MHz channelization and the bandwidth extension field indicates the first 160 MHz subband is a lowest 160 MHz subband of the 480 MHz contiguous channel bandwidth; within a second 160 MHz subband of the 480 MHz contiguous channel bandwidth the bandwidth field indicates a second 160 MHz channelization and the bandwidth extension field indicates the second 160 MHz subband is a middle 160 MHz subband of the 480 MHz contiguous channel bandwidth; and within a third 160 MHz subband of the 480 MHz contiguous channel bandwidth the bandwidth field indicates a third 160 MHz channelization and the bandwidth extension field indicates the third 160 MHz subband is a highest 160 MHz subband of the 480 MHz contiguous channel bandwidth.

Aspect 21: The method of aspect 20, wherein: within the first 160 MHz subband, a first spatial reuse field of the universal signal field is associated with a lowest 80 MHz of the first 160 MHz subband, a second spatial reuse field of the universal signal field is associated with a highest 80 MHz of the first 160 MHz subband, a third spatial reuse field of the universal signal field is associated with the second 160 MHz subband, and a fourth spatial reuse field of the universal signal field is associated with the third 160 MHz subband; within the second 160 MHz subband, the first spatial reuse field is associated with a lowest 80 MHz of the second 160 MHz subband, the second spatial reuse field is associated with a highest 80 MHz of the second 160 MHz subband, the third spatial reuse field is associated with the first 160 MHz subband, and the fourth spatial reuse field is associated with the third 160 MHz subband; and within the third 160 MHz subband, the first spatial reuse field is associated with a lowest 80 MHz of the third 160 MHz subband, the second spatial reuse field is associated with a highest 80 MHz of the third 160 MHz subband, the third spatial reuse field is associated with the first 160 MHz subband, and the fourth spatial reuse field is associated with the second 160 MHz subband.

Aspect 22: The method of any of aspects 1-16, wherein the indicated channel bandwidth is the 480 MHz contiguous channel bandwidth; the 480 MHz contiguous channel bandwidth comprises a 160 MHz primary channel portion and a remaining 320 MHz portion; and the preamble comprises a UHR-SIG field comprising a RU allocation subfield, wherein the RU allocation subfield comprises a respective 9 bit RU allocation table for each 20 MHz portion of the 160 MHz primary channel portion, and wherein the RU allocation subfield comprises a respective 8 bit RU allocation table for each 80 MHz portion of the remaining 320 MHz portion.

Aspect 23: The method of any of aspects 1-16, wherein the indicated channel bandwidth is the 480 MHz contiguous channel bandwidth; and the preamble comprises a UHR-SIG field comprising a first common field and a first user specific field associated with a 320 MHz subband of the 480 MHz contiguous channel bandwidth and a second common field and a second user specific field associated with a 160 MHz subband of the 480 MHz contiguous channel bandwidth.

Aspect 24: The method of any of aspects 1-16, wherein the indicated channel bandwidth is the 480 MHz contiguous channel bandwidth, wherein the 480 MHz contiguous channel bandwidth comprises a primary 160 MHz subchannel, a first secondary 160 MHz subchannel, and one of a second secondary 160 MHz subchannel or a tertiary 160 MHz subband.

Aspect 25: The method of aspect 24, wherein the primary 160 MHz subchannel comprises a middle 160 MHz subchannel of the 480 MHz channel bandwidth, and the method further comprising: communicating with a second wireless communications device via a first 320 MHz subchannel of the 480 MHz channel bandwidth, wherein the first 320 MHz subchannel includes the primary 160 MHz subchannel and a lower 160 MHz subchannel of the 480 MHz channel bandwidth; and communicating with a third wireless communications device via a second 320 MHz subchannel of the 480 MHz channel bandwidth, wherein the second 320 MHz subchannel includes the primary 160 MHz subchannel and an upper 160 MHz subchannel of the 480 MHz channel bandwidth, wherein the second wireless communications device and the third wireless communications device are 320 MHz limited devices.

Aspect 26: The method of aspect 25, wherein the wireless communications device is an access point, the method further comprising: transmitting an indication of a first 320 MHz operating channel for the second wireless communications device to the second wireless communications device and a second 320 MHz operating channel for the third wireless communications device to the third wireless communications device, wherein the first 320 MHz operating channel is the first 320 MHz subchannel and the second 320 MHz operating channel is the second 320 MHz subchannel; or receiving an indication of the first 320 MHz operating channel for the second wireless communications device from the second wireless communications device and the second 320 MHz operating channel for the third wireless communications device from the third wireless communications device.

Aspect 27: A method for wireless communications by a wireless communications device, including: receiving a preamble of a PPDU, where the preamble includes a U-SIG field, where the U-SIG field includes a bandwidth field and a bandwidth extension field that jointly indicate a channel bandwidth for the PPDU, the indicated channel bandwidth being one of a 480 MHz contiguous channel bandwidth, a 640 MHz contiguous channel bandwidth, or a 480 MHz punctured bandwidth within the 640 MHz contiguous channel bandwidth; and receiving a payload of the PPDU using the indicated channel bandwidth.

Aspect 28: The method of aspect 27, where a first set of values of the bandwidth field indicate a corresponding set of channel bandwidths other than 480 MHz or 640 MHz, a second set of values of the bandwidth field indicates 480 MHz bandwidth operation or 640 MHz bandwidth operation, and the second set of values in combination with the bandwidth extension field indicates the 480 MHz contiguous channel bandwidth or the 640 MHz contiguous channel bandwidth.

Aspect 29: The method of aspect 28, wherein the corresponding set of channel bandwidths include a 160 MHz bandwidth extending to 7225 MHz, a 320 MHz bandwidth extending to 7225 MHz, a 480 MHz bandwidth extending to 7225 MHz, and a 640 MHz bandwidth extending to 7225 MHz.

Aspect 30: The method of any of aspects 27-29, where for the preamble that is received within a first subband of the 480 MHz contiguous channel bandwidth or the 640 MHz contiguous channel bandwidth the bandwidth field indicates a first value and the bandwidth extension field indicates a second value, for the preamble that is received within a second subband of the 480 MHz contiguous channel bandwidth or the 640 MHz contiguous channel bandwidth the bandwidth field indicates a third value and the bandwidth extension field indicates a fourth value, and the first value is different from the third value and the second value is different from the fourth value.

Aspect 31: The method of any of aspects 27-30, where receiving the preamble includes: receiving the preamble and the payload according to a tone plan, the tone plan including one or more of: a set of multiple EHT 80 MHz tone plans across the 480 MHz contiguous channel bandwidth or the 640 MHz contiguous channel bandwidth; a 6×996 tone RU for the 480 MHz contiguous channel bandwidth; 4×996 tone MRUs for the 480 MHz contiguous channel bandwidth; 4×996+484 tone MRUs for the 480 MHz contiguous channel bandwidth; 4×996+484+242 tone MRUs for the 480 MHz contiguous channel bandwidth; 5×996 tone MRUs for the 480 MHz contiguous channel bandwidth; 5×996+484 tone MRUs for the 480 MHz contiguous channel bandwidth; 5×996+484+242 tone MRUs for the 480 MHz contiguous channel bandwidth; a 8×996 tone RU for the 640 MHz contiguous channel bandwidth; 4×996 tone RUs for the 640 MHz contiguous channel bandwidth; 4×996+484 tone MRUs for the 640 MHz contiguous channel bandwidth; 5×996 tone MRUs for the 640 MHz contiguous channel bandwidth; 5×996+484 tone MRUs for the 640 MHz contiguous channel bandwidth; 6×996 tone MRUs for the 640 MHz contiguous channel bandwidth; a6×996+484 tone MRUs for the 640 MHz contiguous channel bandwidth; 7×996 tone MRUs for the 640 MHz contiguous channel bandwidth; or 7×996+484 tone MRUs for the 640 MHz contiguous channel bandwidth.

Aspect 32: The method of aspect 31, further including: receiving a set of multiple pilot signals, where resources used to transmit the set of multiple pilot signals are based at least in part on the tone plan.

Aspect 33: The method of any of aspects 31-32, further including: deparsing the PPDU in accordance with a segment deparser, where the segment deparser is based at least in part on the tone plan.

Aspect 34: The method of any of aspects 27-33, further including: receiving, in the preamble, an indication of a puncturing pattern for the PPDU.

Aspect 35: The method of aspect 34, where the PPDU includes a non-orthogonal frequency-division multiple access PPDU, and the indication of the puncturing pattern indicates one or more of no puncturing, a punctured 40 MHz bandwidth within the 480 MHz contiguous channel bandwidth or the 640 MHz contiguous channel bandwidth, a punctured 80 MHz bandwidth within the 480 MHz contiguous channel bandwidth or the 640 MHz contiguous channel bandwidth, two concurrent punctured 80 MHz bandwidths within the 480 MHz contiguous channel bandwidth or the 640 MHz contiguous channel bandwidth, or a concurrent 40 MHz bandwidth and 80 MHz bandwidth within the 480 MHz contiguous channel bandwidth or the 640 MHz contiguous channel bandwidth.

Aspect 36: The method of any of aspects 34-35, where the PPDU includes an orthogonal frequency-division multiple access PPDU, and the indication of the puncturing pattern indicates zero or one or two punctured 20 MHz bandwidths for each 80 MHz bandwidth within the 480 MHz contiguous channel bandwidth or the 640 MHz contiguous channel bandwidth.

Aspect 37: The method of any of aspects 27-36, where the U-SIG field of a TB PPDU includes a set of multiple spatial reuse fields indicating spatial reuse information for each of a set of multiple 20 MHz portions of the 480 MHz contiguous channel bandwidth or the 640 MHz contiguous channel bandwidth.

Aspect 38: The method of any of aspects 27-37, where the preamble includes an EHT signal field including a RU allocation subfield, and a quantity of entries in the RU allocation subfield is based at least in part on the indicated channel bandwidth being one of the 480 MHz contiguous channel bandwidth or the 640 MHz contiguous channel bandwidth.

Aspect 39: The method of any of aspects 27-38, where the preamble includes an UHR STF, the UHR STF includes a set of multiple sequences within 80 MHz segments or 160 MHz segments of the 480 MHz contiguous channel bandwidth or the 640 MHz contiguous channel bandwidth, and each of the set of multiple sequences is multiplied by a different coefficient.

Aspect 40: The method of any of aspects 27-39, where the preamble includes an UHR LTF, the UHR LTF includes a set of multiple sequences within 80 MHz segments of the 480 MHz contiguous channel bandwidth or the 640 MHz contiguous channel bandwidth, each sequence of the set of multiple sequences includes multiple parts, and each part of the multiple parts is multiplied by a different coefficient.

Aspect 41: The method of any of aspects 27-40, where a phase rotation pattern on a 80 MHz subblock basis within the 480 MHz contiguous channel bandwidth or the 640 MHz contiguous channel bandwidth is applied to a legacy portion of the preamble.

Aspect 42: The method of any of aspects 27-41, where a lower frequency tone 3×996 RU of the 480 MHz contiguous channel bandwidth or 4×996 RU of the 640 MHz contiguous channel bandwidth of the PPDU is encoded using binary phase shift keying dual subcarrier modulation, and the lower frequency tone 3×996 RU of the 480 MHz contiguous channel bandwidth or 4×996 RU of the 640 MHz contiguous channel bandwidth is duplicated and phase shifted onto a higher frequency tone 3×996 RU of the 480 MHz contiguous channel bandwidth or 4×996 RU of the 640 MHz contiguous channel bandwidth of the PPDU.

Aspect 43: The method of any of aspects 27-42, where a spectral mask is applied to the preamble and the payload, and the spectral mask has one of: a 0 dBr bandwidth of 479 MHz, −20 dBr at 240.5 MHz frequency offset, −28 dBr at 480 MHz frequency offset, and −40 dBr at 720 MHz frequency offset for a 480 MHz PPDU, where the spectral mask for frequency offsets in between 239.5 MHz and 240.5 MHz, 240.5 MHz and 480 MHz, and 480 MHz and 720 MHz may be linearly interpolated in decibels domain from requirements for 239.5 MHz, 240.5 MHz, 480 MHz, and 720 MHz frequency offsets; a 0 dBr bandwidth of 478 MHz, −20 dBr at 241 MHz frequency offset, −28 dBr at 480 MHz frequency offset, and −40 dBr at 720 MHz frequency offset for a 480 MHz non-high throughput duplicate PPDU, where the spectral mask for frequency offsets in between 239 MHz and 241 MHz, 241 MHz and 480 MHz, and 480 MHz and 720 MHz may be linearly interpolated in decibels domain from requirements for 239 MHz, 241 MHz, 480 MHz, and 720 MHz frequency offsets; a 0 dBr bandwidth of 639 MHz, −20 dBr at 320.5 MHz frequency offset, −28 dBr at 640 MHz frequency offset, and −40 dBr at 960 MHz frequency offset for a 640 MHz PPDU, where the spectral mask for frequency offsets in between 319.5 MHz and 320.5 MHz, 320.5 MHz and 640 MHz, and 640 MHz and 760 MHz may be linearly interpolated in decibels domain from the requirements for 319.5 MHz, 320.5 MHz, 640 MHz, and 960 MHz frequency offsets; a 0 dBr bandwidth of 638 MHz, −20 dBr at 320 MHz frequency offset, −28 dBr at 640 MHz frequency offset, and −40 dBr at 960 MHz frequency offset for a 640 MHz non-high throughput duplicate PPDU, where the spectral mask for frequency offsets in between 319 MHz and 320 MHz, 320 MHz and 640 MHz, and 640 MHz and 760 MHz may be linearly interpolated in decibels domain from the requirements for 319 MHz, 320 MHz, 640 MHz, and 960 MHz frequency offsets, and where a transmit spectrum may not exceed a maximum of the spectral mask and −39 dBm/MHz at any frequency offset.

Aspect 44: The method of any of aspects 27-42, wherein: the indicated channel bandwidth is the 480 MHz contiguous channel bandwidth; within a lowest 160 MHz subband of the 480 MHz contiguous channel bandwidth the bandwidth field indicates a first 320 MHz channelization and the bandwidth extension field indicates an additional upper 160 MHz subband; within a middle 160 MHz subband of the 480 MHz contiguous channel bandwidth the bandwidth field indicates one of the first 320 MHz channelization and the additional upper 160 MHz subband or a second 320 MHz channelization and an additional lower 160 MHz subband; and within a highest 160 MHz subband of the 480 MHz contiguous channel bandwidth the bandwidth field indicates the second 320 MHz channelization and the bandwidth extension field indicates the additional lower 160 MHz subband.

Aspect 45: The method of Aspect 44, wherein: within the lowest 160 MHz subband, a first spatial reuse field of the universal signal field is associated with the lowest 160 MHz subband, a second spatial reuse field of the universal signal field is associated with the middle 160 MHz subband, and a third spatial reuse field is associated with the additional upper 160 MHz subband; and within the highest 160 MHz subband, the first spatial reuse field is associated with the middle 160 MHz subband, the second spatial reuse field is associated with the highest 160 MHz subband, and the third spatial reuse field is associated with the lowest 160 MHz subband.

Aspect 46: The method of any of aspects 27-42, wherein: the indicated channel bandwidth is the 480 MHz contiguous channel bandwidth; within a first 160 MHz subband of the 480 MHz contiguous channel bandwidth the bandwidth field indicates a first 160 MHz channelization and the bandwidth extension field indicates the first 160 MHz subband is a lowest 160 MHz subband of the 480 MHz contiguous channel bandwidth; within a second 160 MHz subband of the 480 MHz contiguous channel bandwidth the bandwidth field indicates a second 160 MHz channelization and the bandwidth extension field indicates the second 160 MHz subband is a middle 160 MHz subband of the 480 MHz contiguous channel bandwidth; and within a third 160 MHz subband of the 480 MHz contiguous channel bandwidth the bandwidth field indicates a third 160 MHz channelization and the bandwidth extension field indicates the third 160 MHz subband is a highest 160 MHz subband of the 480 MHz contiguous channel bandwidth.

Aspect 47: The method of Aspect 46, wherein: within the first 160 MHz subband, a first spatial reuse field of the universal signal field is associated with a lowest 80 MHz of the first 160 MHz subband, a second spatial reuse field of the universal signal field is associated with a highest 80 MHz of the first 160 MHz subband, the third spatial reuse field of the universal signal field is associated with the second 160 MHz subband, and a fourth spatial reuse field of the universal signal field is associated with the third 160 MHz subband; within the second 160 MHz subband, the first spatial reuse field is associated with a lowest 80 MHz of the second 160 MHz subband, the second spatial reuse field is associated with a highest 80 MHz of the second 160 MHz subband, the third spatial reuse field is associated with the first 160 MHz subband, and the fourth spatial reuse field is associated with the third 160 MHz subband; and within the third 160 MHz subband, the first spatial reuse field is associated with a lowest 80 MHz of the third 160 MHz subband, the second spatial reuse field is associated with a highest 80 MHz of the third 160 MHz subband, the third spatial reuse field is associated with the first 160 MHz subband, and the fourth spatial reuse field is associated with the second 160 MHz subband.

Aspect 48: The method of any of aspects 27-42, wherein the indicated channel bandwidth is the 480 MHz contiguous channel bandwidth; the 480 MHz contiguous channel bandwidth comprises a 160 MHz primary channel portion and a remaining 320 MHz portion; and the preamble comprises a UHR-SIG field comprising a RU allocation subfield, wherein the RU allocation subfield comprises a respective 9 bit RU allocation table for each 20 MHz portion of the 160 MHz primary channel portion, and wherein the RU allocation subfield comprises a respective 8 bit RU allocation table for each 80 MHz portion of the remaining 320 MHz portion.

Aspect 49: The method of any of aspects 27-42, wherein the indicated channel bandwidth is the 480 MHz contiguous channel bandwidth; and the preamble comprises a UHR-SIG field comprising a first common field and a first user specific field associated with a 320 MHz subband of the 480 MHz contiguous channel bandwidth and a second common field and a second user specific field associated with a 160 MHz subband of the 480 MHz contiguous channel bandwidth.

Aspect 50: The method of any of aspects 27-42, wherein the indicated channel bandwidth is the 480 MHz contiguous channel bandwidth, wherein the 480 MHz contiguous channel bandwidth comprises a primary 160 MHz subchannel, a first secondary 160 MHz subchannel, and one of a second secondary 160 MHz subchannel or a tertiary 160 MHz subband.

Aspect 51: A wireless communications device, including: one or more memories storing processor-executable code; and one or more processors coupled with the one or more memories and individually or collectively configured to, in association with executing the code, cause the wireless communications device to perform a method of any of aspects 1-26.

Aspect 52: A wireless communications device for wireless communications, including at least one means for performing a method of any of aspects 1-26.

Aspect 53: A non-transitory computer-readable medium storing code for wireless communications, the code including instructions executable by a processor to perform a method of any of aspects 1-26.

Aspect 54: A wireless communications device, including: one or more memories storing processor-executable code; and one or more processors coupled with the one or more memories and individually or collectively configured to, in association with executing the code, cause the wireless communications device to perform a method of any of aspects 27-50.

Aspect 55: A wireless communications device for wireless communications, including at least one means for performing a method of any of aspects 27-50.

Aspect 56: A non-transitory computer-readable medium storing code for wireless communications, the code including instructions executable by a processor to perform a method of any of aspects 27-50.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function (s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some aspects be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communications device, comprising:
one or more memories storing processor-executable code; and
one or more processors coupled with the one or more memories and individually or collectively configured to, in association with executing the code, cause the wireless communications device to:
transmit a preamble of a physical layer protocol data unit, wherein the preamble comprises a universal signal field, wherein the universal signal field comprises a bandwidth field and a bandwidth extension field that jointly indicate a channel bandwidth for the physical layer protocol data unit, the indicated channel bandwidth being one of a 480 megahertz (MHz) contiguous channel bandwidth or a 640 MHz contiguous channel bandwidth; and
transmit a payload of the physical layer protocol data unit using the indicated channel bandwidth.

2. The wireless communications device of claim 1, wherein:
a first set of values of the bandwidth field indicate a corresponding set of channel bandwidths other than 480 MHz or 640 MHz,
a second set of values of the bandwidth field indicates 480 MHz bandwidth operation or 640 MHz bandwidth operation, and
the second set of values in combination with the bandwidth extension field indicates the 480 MHz contiguous channel bandwidth or the 640 MHz contiguous channel bandwidth.

3. The wireless communications device of claim 2, wherein the corresponding set of channel bandwidths include a 160 MHz bandwidth extending to 7225 MHz, and a 320 MHz bandwidth extending to 7225 MHz, and wherein the indicated channel bandwidth is one of a 480 MHz bandwidth extending to 7225 MHz or a 640 MHz bandwidth extending to 7225 MHz.

4. The wireless communications device of claim 1, wherein:
for the preamble that is transmitted within a first subband of the 480 MHz contiguous channel bandwidth or the 640 MHz contiguous channel bandwidth, the bandwidth field indicates a first value and the bandwidth extension field indicates a second value,
for the preamble that is transmitted within a second subband of the 480 MHz contiguous channel bandwidth or the 640 MHz contiguous channel bandwidth, the bandwidth field indicates a third value and the bandwidth extension field indicates a fourth value, and
the first value is different from the third value and the second value is different from the fourth value.

5. The wireless communications device of claim 1, wherein to transmit the preamble and the payload, the processor-executable code is configured to cause the wireless communications device to:
transmit the preamble and the payload according to a tone plan, the tone plan comprising one or more of: a plurality of Extremely High Throughput (EHT) 80 MHz tone plans across the 480 MHz contiguous channel bandwidth or the 640 MHz contiguous channel bandwidth; a 6×996 tone resource unit for the 480 MHz contiguous channel bandwidth; 4×996 tone multiple resource units for the 480 MHz contiguous channel bandwidth; 4×996+484 tone multiple resource units for the 480 MHz contiguous channel bandwidth; 4×996+484+242 tone multiple resource units for the 480 MHz contiguous channel bandwidth; 5×996 tone multiple resource units for the 480 MHz contiguous channel bandwidth; 5×996+484 tone multiple resource units for the 480 MHz contiguous channel bandwidth; 5×996+484+242 tone multiple resource units for the 480 MHz contiguous channel bandwidth; a 8×996 tone resource unit for the 640 MHz contiguous channel bandwidth; 4×996 tone resource units for the 640 MHz contiguous channel bandwidth; 4×996+484 tone multiple resource units for the 640 MHz contiguous channel bandwidth; 5×996 tone multiple resource units for the 640 MHz contiguous channel bandwidth; 5×996+484 tone multiple resource units for the 640 MHz contiguous channel bandwidth; 6×996 tone multiple resource units for the 640 MHz contiguous channel bandwidth; a6×996+484 tone multiple resource units for the 640 MHz contiguous channel bandwidth; 7×996 tone multiple resource units for the 640 MHz contiguous channel bandwidth; or 7×996+484 tone multiple resource units for the 640 MHz contiguous channel bandwidth.

6. The wireless communications device of claim 5, wherein the processor-executable code is configured to cause the wireless communications device to:
transmit a plurality of pilot signals, wherein resources used to transmit the plurality of pilot signals are based at least in part on the tone plan.

7. The wireless communications device of claim 5, wherein the processor-executable code is configured to cause the wireless communications device to:
generate the physical layer protocol data unit in accordance with a segment parser, wherein the segment parser is based at least in part on the tone plan.

8. The wireless communications device of claim 1, wherein the processor-executable code is configured to cause the wireless communications device to:
transmit, in the preamble, an indication of a puncturing pattern for the physical layer protocol data unit.

9. The wireless communications device of claim 8, wherein the physical layer protocol data unit comprises a non-orthogonal frequency-division multiple access physical layer protocol data unit, and wherein the indication of the puncturing pattern indicates one or more of no puncturing, a punctured 40 MHz bandwidth within the 480 MHz contiguous channel bandwidth or the 640 MHz contiguous channel bandwidth, a punctured 80 MHz bandwidth within the 480 MHz contiguous channel bandwidth or the 640 MHz contiguous channel bandwidth, two concurrent punctured 80 MHz bandwidths within the 480 MHz contiguous channel bandwidth or the 640 MHz contiguous channel bandwidth, or a concurrent 40 MHz bandwidth and 80 MHz bandwidth within the 480 MHz contiguous channel bandwidth or the 640 MHz contiguous channel bandwidth.

10. The wireless communications device of claim 8, wherein:
the physical layer protocol data unit comprises an orthogonal frequency-division multiple access physical layer protocol data unit, and
the indication of the puncturing pattern indicates zero or one or two punctured 20 MHz bandwidths for each 80 MHz bandwidth within the 480 MHz contiguous channel bandwidth or the 640 MHz contiguous channel bandwidth.

11. The wireless communications device of claim 1, wherein the universal signal field of a trigger based physical layer protocol data unit comprises a plurality of spatial reuse fields indicating spatial reuse information for each of a plurality of 20 MHz portions of the 480 MHz contiguous channel bandwidth or the 640 MHz contiguous channel bandwidth.

12. The wireless communications device of claim 1, wherein:
the preamble comprises an Extremely High Throughput signal field comprising a resource unit allocation subfield, and
a quantity of entries in the resource unit allocation subfield is based at least in part on the indicated channel bandwidth being one of the 480 MHz contiguous channel bandwidth or the 640 MHz contiguous channel bandwidth.

13. The wireless communications device of claim 1, wherein:
the preamble comprises an Ultra High Reliability short training field,
the Ultra High Reliability short training field comprises a plurality of sequences within 80 MHz segments or 160 MHz segments of the 480 MHz contiguous channel bandwidth or the 640 MHz contiguous channel bandwidth, and
each of the plurality of sequences is multiplied by a different coefficient.

14. The wireless communications device of claim 1, wherein:
the preamble comprises an Ultra High Reliability long training field,
the Ultra High Reliability long training field comprises a plurality of sequences within 80 MHz segments of the 480 MHz contiguous channel bandwidth or the 640 MHz contiguous channel bandwidth,
each sequence of the plurality of sequences comprises multiple parts, and
each part of the multiple parts is multiplied by a different coefficient.

15. The wireless communications device of claim 1, wherein to transmit a legacy portion of the preamble the processor-executable code is configured to cause the wireless communications device to:
apply a phase rotation pattern on a 80 MHz subblock basis within the 480 MHz contiguous channel bandwidth or the 640 MHz contiguous channel bandwidth.

16. The wireless communications device of claim 1, wherein the processor-executable code is configured to cause the wireless communications device to:
generate the physical layer protocol data unit via encoding a lower frequency tone 3×966 resource unit of the 480 MHz contiguous channel bandwidth or 4×996 resource unit of the 640 MHz contiguous channel bandwidth using binary phase shift keying dual subcarrier modulation;
duplicate the lower frequency tone 3×966 resource unit of the 480 MHz contiguous channel bandwidth or 4×996 resource unit of the 640 MHz contiguous channel bandwidth onto a higher frequency tone 3×996 resource unit of the 480 MHz contiguous channel bandwidth or 4×996 resource unit of the 640 MHz contiguous channel bandwidth; and
apply a phase shift to the higher frequency tone 3×966 resource unit of the 480 MHz contiguous channel bandwidth or 4×996 resource unit of the 640 MHz contiguous channel bandwidth.

17. The wireless communications device of claim 1, wherein to transmit the preamble and the payload, the processor-executable code is configured to cause the wireless communications device to:
apply a spectral mask to transmission of the preamble and the payload, wherein the spectral mask has one of: a 0 dBr bandwidth of 479 MHz, −20 dBr at 240.5 MHz frequency offset, −28 dBr at 480 MHz frequency offset, and −40 dBr at 720 MHz frequency offset for a 480 MHz physical layer protocol data unit, wherein the spectral mask for frequency offsets in between 239.5 MHz and 240.5 MHz, 240.5 MHz and 480 MHz, and 480 MHz and 720 MHz may be linearly interpolated in decibels domain from requirements for 239.5 MHz, 240.5 MHz, 480 MHz, and 720 MHz frequency offsets; a 0 dBr bandwidth of 478 MHz, −20 dBr at 241 MHz frequency offset, −28 dBr at 480 MHz frequency offset, and −40 dBr at 720 MHz frequency offset for a 480 MHz non-high throughput duplicate physical layer protocol data unit, wherein the spectral mask for frequency offsets in between 239 MHz and 241 MHz, 241 MHz and 480 MHz, and 480 MHz and 720 MHz may be linearly interpolated in decibels domain from requirements for 239 MHz, 241 MHz, 480 MHz, and 720 MHz frequency offsets; a 0 dBr bandwidth of 639 MHz, −20 dBr at 320.5 MHz frequency offset, −28 dBr at 640 MHz frequency offset, and −40 dBr at 960 MHz frequency offset for a 640 MHz physical layer protocol data unit, wherein the spectral mask for frequency offsets in between 319.5 MHz and 320.5 MHz, 320.5 MHz and 640 MHz, and 640 MHz and 760 MHz may be linearly interpolated in decibels domain from the requirements for 319.5 MHz, 320.5 MHz, 640 MHz, and 960 MHz frequency offsets; a 0 dBr bandwidth of 638 MHz, −20 dBr at 320 MHz frequency offset, −28 dBr at 640 MHz frequency offset, and −40 dBr at 960 MHz frequency offset for a 640 MHz non-high throughput duplicate physical layer protocol data unit, wherein the spectral mask for frequency offsets in between 319 MHz and 320 MHz, 320 MHz and 640 MHz, and 640 MHz and 760 MHz may be linearly interpolated in decibels domain from the requirements for 319 MHz, 320 MHz, 640 MHz, and 960 MHz frequency offsets, and wherein a transmit spectrum may not exceed a maximum of the spectral mask and −39 dBm/MHz at any frequency offset.

18. The wireless communications device of claim 1, wherein:
the indicated channel bandwidth is the 480 MHz contiguous channel bandwidth;
within a lowest 160 MHz subband of the 480 MHz contiguous channel bandwidth the bandwidth field indicates a first 320 MHz channelization and the bandwidth extension field indicates an additional upper 160 MHz subband;
within a middle 160 MHz subband of the 480 MHz contiguous channel bandwidth the bandwidth field indicates one of the first 320 MHz channelization and the additional upper 160 MHz subband or a second 320 MHz channelization and an additional lower 160 MHz subband; and
within a highest 160 MHz subband of the 480 MHz contiguous channel bandwidth the bandwidth field indicates the second 320 MHz channelization and the bandwidth extension field indicates the additional lower 160 MHz subband.

19. The wireless communications device of claim 18, wherein:
within the lowest 160 MHz subband, a first spatial reuse field of the universal signal field is associated with the lowest 160 MHz subband, a second spatial reuse field of the universal signal field is associated with the middle 160 MHz subband, and a third spatial reuse field is associated with the additional upper 160 MHz subband; and
within the highest 160 MHz subband, the first spatial reuse field is associated with the middle 160 MHz subband, the second spatial reuse field is associated with the highest 160 MHz subband, and the third spatial reuse field is associated with the lowest 160 MHz subband.

20. The wireless communications device of claim 1, wherein:
the indicated channel bandwidth is the 480 MHz contiguous channel bandwidth;
within a first 160 MHz subband of the 480 MHz contiguous channel bandwidth the bandwidth field indicates a first 160 MHz channelization and the bandwidth extension field indicates the first 160 MHz subband is a lowest 160 MHz subband of the 480 MHz contiguous channel bandwidth;
within a second 160 MHz subband of the 480 MHz contiguous channel bandwidth the bandwidth field indicates a second 160 MHz channelization and the bandwidth extension field indicates the second 160 MHz subband is a middle 160 MHz subband of the 480 MHz contiguous channel bandwidth; and
within a third 160 MHz subband of the 480 MHz contiguous channel bandwidth the bandwidth field indicates a third 160 MHz channelization and the bandwidth extension field indicates the third 160 MHz subband is a highest 160 MHz subband of the 480 MHz contiguous channel bandwidth.

21. The wireless communications device of claim 20, wherein:
within the first 160 MHz subband, a first spatial reuse field of the universal signal field is associated with a lowest 80 MHz of the first 160 MHz subband, a second spatial reuse field of the universal signal field is associated with a highest 80 MHz of the first 160 MHz subband, a third spatial reuse field of the universal signal field is associated with the second 160 MHz subband, and a fourth spatial reuse field of the universal signal field is associated with the third 160 MHz subband;
within the second 160 MHz subband, the first spatial reuse field is associated with a lowest 80 MHz of the second 160 MHz subband, the second spatial reuse field is associated with a highest 80 MHz of the second 160 MHz subband, the third spatial reuse field is associated with the first 160 MHz subband, and the fourth spatial reuse field is associated with the third 160 MHz subband; and
within the third 160 MHz subband, the first spatial reuse field is associated with a lowest 80 MHz of the third 160 MHz subband, the second spatial reuse field is associated with a highest 80 MHz of the third 160 MHz subband, the third spatial reuse field is associated with the first 160 MHz subband, and the fourth spatial reuse field is associated with the second 160 MHz subband.

22. The wireless communications device of claim 1, wherein:
the indicated channel bandwidth is the 480 MHz contiguous channel bandwidth;
the 480 MHz contiguous channel bandwidth comprises a 160 MHz primary channel portion and a remaining 320 MHz portion; and
the preamble comprises an ultra high reliability signal field comprising a resource unit allocation subfield, wherein the resource unit allocation subfield comprises a respective 9 bit resource unit allocation table for each 20 MHz portion of the 160 MHz primary channel portion, and wherein the resource unit allocation subfield comprises a respective 8 bit resource unit allocation table for each 80 MHz portion of the remaining 320 MHz portion.

23. The wireless communications device of claim 1, wherein:
the indicated channel bandwidth is the 480 MHz contiguous channel bandwidth; and
the preamble comprises an ultra high reliability signal field comprising a first common field and a first user specific field associated with a 320 MHz subband of the 480 MHz contiguous channel bandwidth and a second common field and a second user specific field associated with a 160 MHz subband of the 480 MHz contiguous channel bandwidth.

24. The wireless communications device of claim 1, wherein the indicated channel bandwidth is the 480 MHz contiguous channel bandwidth, wherein the 480 MHz contiguous channel bandwidth comprises a primary 160 MHz subchannel, a first secondary 160 MHz subchannel, and one of a second secondary 160 MHz subchannel or a tertiary 160 MHz subband.

25. The wireless communications device of claim 24, wherein the primary 160 MHz subchannel comprises a middle 160 MHz subchannel of the 480 MHz channel bandwidth, and wherein the processor-executable code is configured to cause the wireless communications device to:
communicate with a second wireless communications device via a first 320 MHz subchannel of the 480 MHz channel bandwidth, wherein the first 320 MHz subchannel includes the primary 160 MHz subchannel and a lower 160 MHz subchannel of the 480 MHz channel bandwidth; and
communicate with a third wireless communications device via a second 320 MHz subchannel of the 480 MHz channel bandwidth, wherein the second 320 MHz subchannel includes the primary 160 MHz subchannel and an upper 160 MHz subchannel of the 480 MHz channel bandwidth, wherein the second wireless communications device and the third wireless communications device are 320 MHz limited devices.

26. The wireless communications device of claim 25, wherein the wireless communications device is an access point, and wherein the processor-executable code is configured to cause the wireless communications device to:
transmit an indication of a first 320 MHz operating channel for the second wireless communications device to the second wireless communications device and a second 320 MHz operating channel for the third wireless communications device to the third wireless communications device, wherein the first 320 MHz operating channel is the first 320 MHz subchannel and the second 320 MHz operating channel is the second 320 MHz subchannel; or
receive an indication of the first 320 MHz operating channel for the second wireless communications device from the second wireless communications device and the second 320 MHz operating channel for the third wireless communications device from the third wireless communications device.

27. A wireless communications device, comprising:
one or more memories storing processor-executable code; and
one or more processors coupled with the one or more memories and individually or collectively configured to, in association with executing the code, cause the wireless communications device to:
receive a preamble of a physical layer protocol data unit, wherein the preamble comprises a universal signal field, wherein the universal signal field comprises a bandwidth field and a bandwidth extension field that jointly indicate a channel bandwidth for the physical layer protocol data unit, the indicated channel bandwidth being one of a 480 megahertz (MHz) contiguous channel bandwidth or a 640 MHz contiguous channel bandwidth; and
receive a payload of the physical layer protocol data unit using the indicated channel bandwidth.

28. The wireless communications device of claim 27, wherein:
a first set of values of the bandwidth field indicate a corresponding set of channel bandwidths other than 480 MHz or 640 MHz,
a second set of values of the bandwidth field indicates 480 MHz bandwidth operation or 640 MHz bandwidth operation, and
the second set of values in combination with the bandwidth extension field indicates the 480 MHz contiguous channel bandwidth or the 640 MHz contiguous channel bandwidth.

29. A method for wireless communications by a wireless communications device, comprising:
transmitting a preamble of a physical layer protocol data unit, wherein the preamble comprises a universal signal field, wherein the universal signal field comprises a bandwidth field and a bandwidth extension field that jointly indicate a channel bandwidth for the physical layer protocol data unit, the indicated channel bandwidth being one of a 480 megahertz (MHz) contiguous channel bandwidth or a 640 MHz contiguous channel bandwidth; and
transmitting a payload of the physical layer protocol data unit using the indicated channel bandwidth.

30. A method for wireless communications by a wireless communications device, comprising:
receiving a preamble of a physical layer protocol data unit, wherein the preamble comprises a universal signal field, wherein the universal signal field comprises a bandwidth field and a bandwidth extension field that jointly indicate a channel bandwidth for the physical layer protocol data unit, the indicated channel bandwidth being one of a 480 MHz contiguous channel bandwidth, a 640 MHz contiguous channel bandwidth, or a 480 megahertz (MHz) punctured bandwidth within the 640 MHz contiguous channel bandwidth; and
receiving a payload of the physical layer protocol data unit using the indicated channel bandwidth.
